(19) United States
(12) Patent Application Publication
(10) Pub. No.: US 2025/0229247 A1
(43) Pub. Date: Jul. 17, 2025

(54) Next-Generation Fluidics Technology For Efficient Autonomous Synthesis of Colloidal Nanoparticles

(71) Applicant: Brookhaven Science Associates, LLC, Upton, NY (US)

(72) Inventors: Yugang Zhang, Middle Island, NY (US); Fang Lu, Miller Place, NY (US); Oleg Gang, Setauket, NY (US)

(21) Appl. No.: 19/018,789

(22) Filed: Jan. 13, 2025

Related U.S. Application Data
(60) Provisional application No. 63/620,132, filed on Jan. 11, 2024.

(51) Int. Cl. B01J 19/00; B22F 9/18; B82Y 35/00; B82Y 40/00

(52) U.S. Cl. CPC B01J 19/004; B01J 19/0093; B22F 9/18; B01J 2219/00202; B01J 2219/00231; B01J 2219/00238; B01J 2219/00243; B01J 2219/00889; B01J 2219/00891; B01J 2219/00957; B01J 2219/00968; B01J 2219/00986; B22F 2301/255; B22F 2304/054; B82Y 35/00; B82Y 40/00

(57) ABSTRACT

Various examples are provided related to nanoparticle synthesis. In one example, a system includes a self-driven fluidics platform including a chemical handling module and a reactor module. A mixer can form an initial mixture and deliver it through the ejector port as part of a segmented flow. The reactor module can control environmental conditions during synthesis of a nanoparticle. A flow reactor includes a channel that allows the segmented flow to move through the flow reactor via the channel and at least one observation window to enable real-time characterization of nanoparticles in individual droplets in the segmented flow through the flow reactor. In another example, a method comprises forming and flowing a segmented flow of droplets into a reactor, measuring a target property of nanoparticles in droplets in the segmented flow, and adjusting formation of droplets added to the segmented flow based upon the measured target property.

### CROSS-REFERENCE TO RELATED APPLICATIONS

This application claims priority to and the benefit of U.S. Provisional Application No. 63/620,132, filed on Jan. 11, 2024, which is hereby incorporated herein by reference in its entirety.

### STATEMENT REGARDING FEDERALLY SPONSORED RESEARCH OR DEVELOPMENT

The present invention was made with government support under contract number DE-SC0012704 awarded by the U.S. Department of Energy. The United States government may have certain rights in this invention.

### BACKGROUND

Colloidal nanoparticles have garnered significant interest due to their potential applications in areas such as catalysis, photonics, optics, electrochemistry, and energy storage. nanoscale catalysts, with their high density of active sites like surface steps, kinks, and edges, play a role in enhancing catalytic performance. The dedicated design and fabrication of these catalysts can aid in fulfilling the increasing demand of renewable and sustainable energy technologies.

Despite extensive research, the discovery and refinement of advanced nanoparticles present formidable challenges, stemming mainly from the intricate, multi-step chemistry of their synthesis. This process demands a delicate balance of various precursors and reaction conditions, including temperature and time, across a vast synthetic space. For instance, examining ten different settings for each of six parameters (four chemicals, temperature, and time) results in one million potential combinations. Traditional trial-and-error methods for identifying optimal synthesis parameters are time-consuming, labor-intensive, and inefficient, given the vast of the parameter space. Thus, there is a need for methods and systems for producing colloidal nanoparticles that is relatively efficient and adaptable to different experimental settings. These needs and other needs are satisfied by the present disclosure.

### SUMMARY

In accordance with the purpose(s) of the disclosure, as embodied and broadly described herein, the disclosure, in one aspect, relates to a system for nanoparticle synthesis, comprising: a self-driven fluidics platform and a reactor module configured to control environmental conditions during synthesis of a nanoparticle. The self-driven fluidics platform comprises: a chemical handling module comprising: a plurality of chemical reservoirs, each chemical reservoir configured to hold a fluid; and a mixer, comprising a plurality of injector ports and at least one ejector port, each chemical reservoir in fluidic communication with at least one injector port of the mixer, the mixer configured to mix at least two fluids entering the mixer from the injector ports, thereby forming an initial mixture, and deliver the initial mixture through the ejector port as part of a segmented flow. The reactor module comprises: a flow reactor in fluidic communication with the mixer through the ejector port, the flow reactor comprising a channel configured to allow the segmented flow to move through the flow reactor via the channel, the flow reactor comprising at least one observation window configured to enable real-time characterization of nanoparticles in individual droplets in the segmented flow through the flow reactor.

Also disclosed herein is a method a method comprising: mixing together at least two fluids, thereby forming a segmented flow comprising a plurality of droplets; flowing the segmented flow into a reactor; controlling a temperature of the reactor; measuring at least one target property of nanoparticles in individual droplets in the segmented flow as the plurality of droplets pass through the reactor; and adjusting formation of droplets added to the segmented flow based upon the measured at least one target property of the nanoparticles.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram illustrating an example of workflow of an autonomous synthesis system, integrating automated fluidic synthesis (with solution filtration and back pressure control), in-situ SAXS/WAXS measurements, real-time analysis, and ML-guided exploration and optimization, in accordance with various embodiments of the present disclosure.

FIGS. 1B-1D are images showing an example of an implementation at the autonomous synthesis system of FIG. 1A, in accordance with various embodiments of the present disclosure.

FIG. 2A is a schematic diagram illustrating four processes of the autonomous synthesis system, in accordance with various embodiments of the present disclosure.

FIG. 2B shows an example of progression of autonomous exploration in 3D synthesis parameter space, in accordance with various embodiments of the present disclosure.

FIG. 2C shows an example of an evolution of GPML predictions through active learning, in accordance with various embodiments of the present disclosure.

FIG. 3A shows examples of predicted 1/s values from GPML models as a function of training dataset size, in accordance with various embodiments of the present disclosure.

FIG. 3B demonstrates an example learning curve analysis through relative opportunity cost, in accordance with various embodiments of the present disclosure.

FIG. 3C shows an evolution of GPML predictions at different experimental stages, in accordance with various embodiments of the present disclosure.

FIG. 3D demonstrates an example compressive analysis between grid scan and active learning approaches, in accordance with various embodiments of the present disclosure.

FIG. 4A shows an example objective function landscape combining particle size and particle distribution targets, in accordance with various embodiments of the present disclosure.

FIG. 4B shows an example mapping of objective function values across synthesis parameter space during Run 1 (left, 1/σ optimization) and Run 2 (right, combined size-distribution optimization), in accordance with various embodiments of the present disclosure.

FIG. 4C illustrates a systematic discovery of target synthesis conditions, in accordance with various embodiments of the present disclosure.

FIG. 4D shows an example 3D GPML prediction for 1/σ (left) and radius (right), in accordance with various embodiments of the present disclosure.

FIG. 5A shows an example 2D correlation map quantifying relationships between synthesis parameters (chemical reagents) and nanoparticle properties from SAXS/WAXS measurements, in accordance with various embodiments of the present disclosure.

FIG. 5B shows example crystallinity distribution mapped across reagent volumes, in accordance with various embodiments of the present disclosure.

FIGS. 5C-5E show GMPL predictions mapping reagent volume effects on maximum SAXS intensity (FIG. 5C), 1/s (FIG. 5D), and radius (FIG. 5E), in accordance with various embodiments of the present disclosure.

FIGS. 5F-5H show an example SHAP analysis quantifying individual and collective reagent contributions to maximum SAXS intensity (FIG. 5F), size distribution (FIG. 5G), and radius (FIG. 5H) of the as-synthesized nanoparticles, in accordance with various embodiments of the present disclosure.

FIG. 5I shows an example SHAP analysis of SAXS-WAXS relationships, in accordance with various embodiments of the present disclosure.

FIGS. 5J-5K show example size and distribution analysis against NCit:HAu molar ratios under systematic pH variations, in accordance with various embodiments of the present disclosure.

FIG. 6A shows SAXS intensity plots for various experimental indexes, in accordance with various embodiments of the present disclosure.

FIG. 6B shows SAXS intensity plots for various experimental indexes and their corresponding ex-situ TEM and UV-vis characterizations, in accordance with various embodiments of the present disclosure.

FIG. 7A shows SAXS intensity plots for real-time poor curve-fitting data of various experimental indexes, in accordance with various embodiments of the present disclosure.

FIG. 7B shows a comparison of GPML predictions for 1/σ values in the synthetic parameter space, in accordance with various embodiments of the present disclosure.

FIGS. 8A-8B show 3D maps of 1/σ values for 265 grid can experiments displayed in a confined synthetic space (FIG. 8A) or in the entire vase synthetic space (FIG. 8B), in accordance with various embodiments of the present disclosure.

FIG. 9A shows observed nanoparticle radius in the synthetic space from Run 1 and Run 2, in accordance with various embodiments of the present disclosure.

FIG. 9B shows GPML model predictions of nanoparticles radius in the synthetic space from Run 1 and Run, in accordance with various embodiments of the present disclosure.

FIG. 9C shows observed cost function values vs number of experiments performed, in accordance with various embodiments of the present disclosure.

FIG. 10A shows an example WAXS pattern of a gold nanoparticle exhibiting a crystalline structure, in accordance with various embodiments of the present disclosure.

FIGS. 10B-10C show examples of in-situ WAXS and SAXS data for gold nanoparticles of various experimental indexes that exhibit fcc crystallinity and a high polydispersity, in accordance with various embodiments of the present disclosure.

FIG. 10D shows an example distribution of crystalline and amorphous nanoparticles observed within the synthetic parameter space, in accordance with various embodiments of the present disclosure.

FIGS. 11A-11C show 2D maps for observations of maximum intensity of SAXS (FIG. 11A), 1/σ (FIG. 11B), and radius of nanoparticles (FIG. 11C) in the three reagents volume space, in accordance with various embodiments of the present disclosure.

FIG. 11D shows predictions of 1/σ value against the volume of HAuCl₄ at specific NCit and pH volumes, in accordance with various embodiments of the present disclosure.

FIGS. 12A-12B show 2D scatter plots (for nanoparticle size (FIG. 12A) and size distribution (FIG. 12B) as functions of the molar ratio of sodium citrate to gold chloride under different pH conditions, in accordance with various embodiments of the present disclosure.

FIGS. 12C-12H show box plots for nanoparticle size (FIGS. 12C-12E) and size distribution (FIGS. 12F-12H) as functions of the molar ratio of sodium citrate to gold chloride under different pH conditions, in accordance with various embodiments of the present disclosure.

FIGS. 13A-13B show a schematic diagram (FIG. 13A) and a picture (FIG. 13B) depicting an automatic injection system, in accordance with various embodiments of the present disclosure.

FIGS. 14A-14B show a close-up schematic diagram (FIG. 14A) and a close-up picture (FIG. 14) of the automatic injection system of FIGS. 13A-13B, in accordance with various embodiments of the present disclosure.

FIG. 15 shows a schematic diagram illustrating a workflow for mixing low viscosity solutions, in accordance with various embodiments of the present disclosure.

FIG. 16 shows a schematic diagram illustrating a workflow generally applicable to mixing high viscosity solutions, in accordance with various embodiments of the present disclosure.

FIG. 17 shows a picture depicting a setup for mixing high viscosity solutions, in accordance with various embodiments of the present disclosure.

FIGS. 18A-18B show two different states of the L-Switch, in accordance with various embodiments of the present disclosure.

FIGS. 19A-19F show scanning electron microscopy images of various nanoparticles produced using the disclosed systems and methods, in accordance with various embodiments of the present disclosure.

FIG. 20 provides a workflow outline for autonomous, closed-loop synthesis of nanoparticles, in accordance with various embodiments of the present disclosure.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a nanoparticle,” “a fluid,” or “a droplet,” includes, but is not limited to, two or more such nanoparticles, fluids, or droplets, and the like.

Reference to “a/an” chemical compound each refers to one or more molecules of the chemical compound rather than being limited to a single molecule of the chemical compound. Furthermore, the one or more molecules may or may not be identical, so long as they fall under the category of the chemical compound.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### B. Abbreviations

GPML Gaussian process machine learning
Hau gold chloride
NCit sodium citrate
PTFE polytetrafluoroethylene
ROC relative opportunity cost
SAXS small angle X-ray scattering
SHAP Shapley additive explanations
TEM transmission electron microscopy
WAXS wide angle X-ray scattering

### C. Discussion

A self-driven fluidics platform is disclosed herein that integrates automation, inline analytics, and, optionally, AI-driven active learning. This system is designed for the autonomous synthesis of target nanomaterials, efficiently navigating the complex parameter space to achieve the desired properties, significantly streamlining the nanoparticle production process. The advanced approach in material synthesis revolves around an automated, high-throughput, and mobile droplet fluidics platform engineered for diverse applications in wet chemistry synthesis. The system can comprise a combination of four hardware modules: the chemical handling module, the reactor module, the in-line characterization module, and/or a control module, each module optionally mounted on a compact rack for easy mobility and efficiency. The nanoparticles produced by any system or method disclosed herein can have a variety of sizes and shapes. Nanoparticle shapes include, but are not limited to, spheres, cubes, rods, wires, polygonal plates, amorphous, polyhedrons, stars, shells, and the like.

More specifically, in one aspect, disclosed herein is a system for nanoparticle synthesis, comprising a self-driven fluidics platform comprising a chemical handling module and a reactor module configured to control environmental conditions during synthesis of a nanoparticle. In a further aspect, the chemical handling module can comprise a plurality of chemical reservoirs, each chemical reservoir configured to hold a fluid; and a mixer, comprising a plurality of injector ports and at least one ejector port, each chemical reservoir in fluidic communication with at least one injector port of the mixer, the mixer configured to mix at least two fluids entering the mixer from the injector ports, thereby forming an initial mixture, and deliver the initial mixture through the ejector port as part of a segmented flow. In another further aspect, the reactor module can comprise a flow reactor in fluidic communication with the mixer through the ejector port, the flow reactor comprising a channel configured to allow the segmented flow to move through the flow reactor via the channel, the flow reactor comprising at least one observation window configured to enable real-time characterization of nanoparticles in individual droplets in the segmented flow through the flow reactor. In one aspect, the chemical reservoirs can each comprise a syringe pump. In another aspect, at least one of the chemical reservoirs can comprise an oil. The oil can be a carrier oil, such as a silicone oil. In another aspect, the mixer can be a static mixer, such as a helical static mixer. In another aspect, the flow reactor can be further configured to control environmental conditions of the channel, such as a temperature of the channel. The system can also further comprise a filtration device configured to prevent the formation of bubbles within the fluids of the system.

This chemical handling module can manage the flow of chemicals with the system. It can include at least one of an on demand chemical supply reservoirs, syringe pumps, a compressed gas generator, multi-channel gas pressure control pumps, flow sensors, a bubble-removing device, three-way liquid switches, or multi-channel rotary valves. The inclusion of a bubble-removing device can ensure a pure chemical flow by eliminating unwanted bubbles. The rotary valve device can facilitate sequential injection of reagents, effectively preventing cross-contamination and ensuring precise flow control at the sub-microliter level.

The reactor module module can include a custom-designed reactor (referred to as a Fluidics Synthesis Reactor (FSR)) comprising two aluminum plates enclosing six-turn zig-zag shaped glass tubing. The FSR can include heating rods and a resistance temperature detector (RTD), supporting temperatures exceeding 300° C. The FSR can be equipped with strategically placed holes (e.g., 54) for in-situ measurement probes, accommodating both optical and x-ray observations. Hydrophobic modification of the glass tubing's internal wall can allow for forming aqueous droplets, and positioning the reactor on a motorized X-Z stage can allow for computer-controlled alignment with optical or x-ray paths for in-situ observation.

The system can further comprise an in-line characterization module comprising an analytical instrument optionally configured to obtain characterization data of the nanoparticles in the individual droplets in the segmented flow while the segmented flow moves through the channel of the flow reactor. In one aspect, the analytical instrument can comprise a radiation emitter and a signal detector. In another aspect, the analytical instrument can be configured to deliver radiation through the at least one observation window and detect a radiation signal emitted from at least one individual droplet. Examples of radiation emitters include an X-ray light source (e.g., X-ray tubes, rotating anodes, or synchrotrons), UV-Vis-IR light source (e.g., deuterium arc lamp, tungsten-halogen lamp, or xenon flash lamp), laser source (e.g., low noise, visible wavelength with different power levels), and LED diodes. Examples of signal detectors include X-ray detectors, UV-Vis-IR detectors, avalanche photodiodes (APDs) and optical camera and microscopy. Various characterization methods can be integrated into the system for real-time analysis, including dynamic light scattering utilizing a laser source, avalanche photodiodes, and digital autocorrelators; optical imaging and microscopy, and solution property analyzers for measuring viscosity and electrical conductivity.

In one aspect, the in-line characterization module can include a UV-Vis light source and a spectrometer capable of collecting real-time spectral data from 350 to 800 nm. The mobile design of the system permits adaptability for high-throughput SAXS/WAXS measurements at various synchrotron beamlines, allowing detailed characterization needed for complex nanomaterial synthesis.

The system can further comprise a control module comprising processing circuitry configured to at least: receive an analyte measurement from the analytical instrument; and at least one of: adjust a rate of delivery of the fluid of at least one chemical reservoir; or adjust a volume of delivery of the fluid of at least one chemical reservoir. In a further aspect, the control module can dynamically adjust operation of the chemical handling module or the reactor module during synthesis of the nanoparticle. In a further aspect, the dynamic adjustment can be in response to machine learning analysis of the real-time characterization data. The system can allow for characterization of multiple analyte parameters, including: nanoparticle dimensional analysis, including particle size measurements and particle size distribution determinations; optical properties, including ultraviolet-visible absorption spectra and photoluminescence characteristics; colloidal stability parameters, including dispersity status; and bulk solution properties, including dynamic viscosity and electrical conductivity measurements.

The control module can comprise an eight-channel power switch device and a 48-channel network hub, connecting to a central computer for overarching control. This setup can ensure seamless integration and control of any electronic devices, cameras, and motor systems. In another aspect, the control module can be configured for remote access. A verified user can securely log into the system from remote locations, allowing a user to conduct experiments and monitor processes remotely. This can enhance the platform's flexibility and accessibility, making it a valuable tool for collaborative and distant research endeavors.

As an example, a typical process of high-throughput synthesis can begin with the delivery of each chemical reagent through PTFE tubing to the bubble-removing device. Subsequently, reagents can be sequentially injected via the rotary valve into the reactor, where they form droplets in a carrier phase and flow through a static mixer into the reactor's glass tubing. Here, chemical reactions take place and are subject to in-line characterization, with the products being collected at the outlet.

Continuing with the example, to achieve autonomous synthesis, the platform can employ innovative droplet recognition algorithms, including data correlation and neural network techniques, for accurate real-time identification of each droplet. These algorithms support effective data analysis and autonomous synthesis. Machine learning integration, especially active algorithms based on Gaussian processes, guides the synthesis and predicts chemical recipes and conditions. In a typical autonomous synthesis, the system can initially produce around 20 droplets with random recipes. Utilizing real-time characterization and data analysis, the Gaussian process algorithm develops a predictive model to suggest new recipes. This iterative process continues until the desired material properties are achieved. As explored in the Examples section below, a representative system can produce nanoparticles with narrow polydispersity across a comprehensive range of synthetic parameters, with high efficiency in self-driven autonomous synthesis capabilities at a synchrotron beamline. By employing active learning, the system can efficiently produced gold nanoparticles with minimized size distribution, selecting from a vast array of possible recipe combinations.

The disclosed system introduces a transformative approach to nanoparticle synthesis. The system can comprise can advanced, automated, mobile, and self-driven fluidics platform, specifically tailored for high-throughput autonomous nano-synthesis using wet-chemistry methods. This platform overcomes the inefficiencies typically associated with traditional trial-and-error methods in nanoparticle synthesis. The methodology can operate on several principles: precision and automation in Chemical Handling, a custom-designed droplet reactor, real-time in-line characterization tools and data analysis techniques, and machine-learning integration.

Precision and Automation in Chemical Handling: The system can employ syringe pumps, multi-channel pumps with gas control, flow sensors, and bubble-removing modules to ensure precise handling of chemical reagents. This accuracy facilitates exploration of the vast synthetic space of nanoparticle synthesis, where the correct combination of precursors, reductants, solvents, and other chemicals is needed for successful synthesis.

Custom-Designed Droplet Reactor. The reactor can be engineered to facilitate reactions under precisely controlled temperatures, creating isolated environments within each droplet for chemical reactions. The design can include hydrophobic, optical, and x-ray transparent glass tubing, along with strategically positioned holes for in-situ measurements. The motorized stage can enhance the reactor's functionality by enabling facile and precise monitoring over the reaction process.

Real-Time In-line Characterization Tools and Data Analysis Techniques: Integration of UV-Vis spectroscopy and optical microscopes permits immediate analysis of the ongoing synthesis process. This immediate feedback allows for rapid identification of successful synthesis conditions and the ability to make prompt parameter adjustments. The adaptability for high-throughput SAXS/WAXS measurements at various synchrotron beamlines further elevates the platform's material characterization capabilities, which is important for complex nanomaterial synthesis. The innovative droplet recognition algorithms enable real-time identification of each droplet, which is utilized for downstream data analysis and autonomous synthesis.

Machine Learning Integration: The optional incorporation of machine learning, such as Gaussian process algorithms, empowers the system to dynamically predict and optimize chemical recipes and reaction conditions. This capability can significantly streamline the process of identifying the most promising reaction conditions within a vast synthetic space.

In practical applications, the system demonstrates remarkable efficiency and high-throughput capabilities. For instance, in a laboratory setting focused on gold nanoparticle synthesis, the system conducted over 3000 experiments in about 100 hours, while using only approximately 120 ml of chemical solutions. To put this in perspective, a chemistry-trained Ph.D. student conducting 10 samples per day would need approximately 300 business days to achieve a similar output. This exemplifies the platform's efficiency in resource utilization and experimentation. By leveraging active learning and real-time analysis, the system significantly reduces the number of experimental iterations needed. As shown in the Examples, the system successfully minimized the size distribution of nanoparticles by autonomously selecting from about 19,730 possible recipe combinations, using only around 150 reactions in under 10 hours. The ability to analyze reactions in real-time and adjust parameters accordingly greatly enhances the responsiveness and efficiency of the synthesis process, key factors in rapidly achieving the desired nanoparticle properties.

Features of the system can include, but are not limited to, the following:
Automated, Mobile, and Self-Driven Platform: The system can be distinguished by its automated, mobile, and self-driven fluidics platform. This mobility facilitates its use in a variety of settings, including different laboratory environments and synchrotron facilities, enhancing its versatility and applicability.
Unique Fluidics Design: The design of the flow path utilizes rotary valves to prevent cross-contamination of different chemicals. Additionally, the incorporation of bubble-removing devices ensures a bubble-free flow path, useful for precision synthesis with well-controlled reaction times.
Custom-Designed Droplet Reactor. The custom-designed droplet reactor, featuring surface modified glass tubing, creates isolated reaction environments within each droplet, allowing for controlled synthesis. The capability to generate multiple droplets enables parallel synthesis. Furthermore, the reactor's design, including holes for in-situ measurements, motorized stages, and materials transparent to optical and x-ray observation, facilitates comprehensive in-situ studies.
Integrated Fluidics and Real-Time Analysis: The system uniquely combines high-throughput fluidics with real-time analytical capabilities. The integration of in-line characterization tools such as UV-Vis spectroscopy and optical microscopes, along with SAXS/WAXS measurement capabilities at synchrotron beamlines, provides unparalleled real-time insights into the synthesis process. The development of a droplet recognition algorithm enhances the reliability of droplet identification, useful for accurate data analysis.
Machine Learning Integration: The integration of machine learning for efficient active learning can enable dynamically prediction and optimization of chemical recipes and reaction conditions, marking a substantial advancement in the field of autonomous synthesis processes.
High Throughput with Minimal Resource Use: The platform's design enables the rapid generation of droplets, each providing unique synthetic conditions. This capability facilitates efficient exploration of a vast synthetic parameter space while minimizing chemical waste, aligning with green chemistry principles and promoting sustainable research practices.
Remote Access Synthesis: Verified users can securely log into the control computer from remote locations, enabling them to conduct and monitor experiments without being physically present at the lab. This remote access capability is particularly beneficial for collaborative projects and for conducting experiments under unique conditions or timeframes that might not align with standard laboratory hours.
Purification Module: A purification module can be included in the system to remove residual surfactants, unreacted chemicals, and other impurities from the nanoparticles. This ensures higher purity, useful for subsequent processing and advanced applications, such as electrochemical measurements. The integrated purification process can employ techniques like filtration and separation, enhancing the quality of the nanomaterials produced.
Surface Modification Capability: A module can be introduced for surface modification of nanoparticles. This module can enable alterations with diverse ligands, like amphiphilic molecules, tailoring nanoparticles for specific uses such as targeted drug delivery or catalysis. This addition can expand the system's utility in customizing nanoparticles for varied applications.
Advanced Droplet Manipulation: Techniques for sophisticated droplet manipulations, including merging, splitting, and sorting, can be integrated into the system. This enhancement can bolster the system's ability to create complex reaction environments and execute processes like multi-step nanoparticle growth with precision.
Multi-Step/Sequential Growth: The system can be upgraded to facilitate multi-step or sequential growth within the platform. This can enable the creation of complex nanostructures, such as layered, core-shell, or heterogeneously composed materials, broadening the spectrum of nanomaterials that can be synthesized.
Reactor with Heating and Cooling Functions: The reactor can be modified to include both heating and cooling functions. This dual capability can facilitate a wider array of chemical reactions, essential for versatile material synthesis requiring precise thermal control.
Post-Synthesis Thermal Treatment: A module for post-synthesis thermal treatment can be incorporated in the system. This can enable thermal shock or controlled gas environment exposure, facilitating the synthesis of advanced materials like oxidized nanoparticles, nitrides, and high-entropy alloys that are challenging to produce via wet chemistry methods.
Integration with Microfluidics for Additive Manufacturing: The system can be combined with microfluidic techniques to enable additive manufacturing applications, for example 3D printing capabilities. This integration can enable precise deposition of in-line produced nanomaterials, opening avenues for fabricating intricate structures and devices.
Electrode Integration for Conductivity Measurements: Electrodes can be integrated into the droplets for in-situ electrical property measurements, such as conductivity. This feature is particularly relevant for materials like electrolytes and can be invaluable in evaluating electronic properties for electronics and energy storage applications.
Dynamic Light Scattering (DLS) for Particle Analysis: Laser speckle techniques, including DLS, can be integrated to enable real-time particle size analysis. This addition can improve control over particle size and distribution, enhancing the precision of nanoparticle synthesis.

The proposed system offers many technical and economic advantages including, but not limited to:
Precision and Control: The system offers high precision in handling and mixing chemicals, essential for the synthesis of complex nanoparticles. This precision ensures consistently high-quality outcomes.
Real-Time Analysis and Adaptability: Featuring in-line characterization tools like UV-Vis spectroscopy and optical microscopes, and adaptable for synchrotron beamline analysis, the system allows real-time monitoring and immediate adjustments during synthesis. This capability is useful for achieving desired material properties efficiently.
Autonomous Synthesis with Machine Learning: Advanced machine learning algorithms enable autonomous, self-optimizing synthesis processes, reducing the need for constant human oversight and minimizing errors.
High Throughput and Efficiency: The design facilitates the rapid generation of multiple droplets for parallel synthesis, significantly increasing throughput and efficiency, useful for industries requiring quick production cycles.
Environmentally Friendly: Aligning with green chemistry principles, the system minimizes waste and maximizes resource efficiency, reducing environmental impact and associated costs.
Integrated Control Software: All hardware components can be controlled by integrated software. This integration can simplify operation and ensures seamless control over the entire synthesis process.
Modular Design for Easy Extension: The platform's modular design allows for easy upgrading and extension. This flexibility means it can be adapted for new functionalities, such as property evaluation and thin film fabrication, catering to evolving research and industrial needs.
Remote Access Synthesis: The platform can support secure remote access, allowing legitimate users to conduct and monitor experiments remotely. This feature is beneficial for collaborative projects and enhances its flexibility and accessibility.
Reduced Time-to-Market: For industries like pharmaceuticals and materials science, the system's efficiency can significantly reduce the time-to-market for new products. Rapid synthesis and testing mean faster development cycles, providing a competitive advantage.
Cost Savings: The efficiency and precision of the system can reduce the need for extensive trial-and-error experimentation, leading to substantial cost savings in materials and labor. Moreover, the reduction in waste and efficient use of resources contribute to further economic benefits.
Scalability and Versatility. The platform's scalable and versatile nature makes it suitable for various industries, allowing companies to use it for multiple applications. This versatility means a single investment can serve multiple purposes, enhancing the return on investment.
Increased Productivity: By automating and optimizing the synthesis process, the system can allow researchers and technicians to focus on other tasks, thereby increasing overall productivity.
Potential for New Market Opportunities: The advanced capabilities of this technology can lead to the discovery of new materials and compounds, opening new market opportunities and revenue streams for businesses.

The proposed system can be utilized in a wide range of research and industrial applications including, e.g.:
Pharmaceutical and Biotech Industries: Given the precision and control required in drug discovery and development, pharmaceutical companies could find immense value in this technology for synthesizing new compounds and rapidly testing their efficacy.
Material Science and Nanotechnology Firms: Companies specializing in the development of new materials, particularly at the nanoscale, would benefit from the precision synthesis capabilities of the platform.
Chemical Manufacturing Companies: Firms engaged in producing specialized chemicals could use this technology for efficient, high-throughput production processes.
Environmental Research and Consulting Firms: Organizations focusing on environmental studies and pollution control could utilize the technology for environmental testing and analysis.
Academic and Research Institutions: Universities and research labs could use the platform for educational purposes and to advance research in chemistry and materials science.
Electronics and Semiconductor Industries: Companies in the semiconductor industry may find the technology beneficial for developing new materials with specific electronic properties.

### D. Aspects

The following listing of exemplary aspects supports and is supported by the disclosure provided herein.

Aspect 1. A system for nanoparticle synthesis, comprising: a self-driven fluidics platform comprising: a chemical handling module comprising: a plurality of chemical reservoirs, each chemical reservoir configured to hold a fluid; and a mixer, comprising a plurality of injector ports and at least one ejector port, each chemical reservoir in fluidic communication with at least one injector port of the mixer, the mixer configured to mix at least two fluids entering the mixer from the injector ports, thereby forming an initial mixture, and deliver the initial mixture through the ejector port as part of a segmented flow; and a reactor module configured to control environmental conditions during synthesis of a nanoparticle, comprising: a flow reactor in fluidic communication with the mixer through the ejector port, the flow reactor comprising a channel configured to allow the segmented flow to move through the flow reactor via the channel, the flow reactor comprising at least one observation window configured to enable real-time characterization of nanoparticles in individual droplets in the segmented flow through the flow reactor.

Aspect 2. The system of aspect 1, further comprising an in-line characterization module comprising an analytical instrument configured to obtain characterization data of the nanoparticles in the individual droplets in the segmented flow while the segmented flow moves through the channel of the flow reactor.

Aspect 3. The system of aspect 2, wherein the analytical instrument comprises a radiation emitter and a signal detector.

Aspect 4. The system of aspect 2 or aspect 3, wherein the analytical instrument is configured to deliver radiation through the at least one observation window and detect a radiation signal emitted from at least one individual droplet.

Aspect 5. The system of any one of aspects 2-4, further comprising a control module comprising processing circuitry configured to at least: receive an analyte measurement from the analytical instrument; and at least one of: adjust a rate of delivery of the fluid of at least one chemical reservoir; or adjust a volume of delivery of the fluid of at least one chemical reservoir.

Aspect 6. The system of aspect 5, wherein the control module dynamically adjusts operation of the chemical handling module or the reactor module during synthesis of the nanoparticle.

Aspect 7. The system of aspect 6, wherein the dynamic adjustment is in response to machine learning analysis of the real-time characterization data.

Aspect 8. The system of any one of aspects 1-7, wherein each of the plurality of chemical reservoirs comprises a syringe pump.

Aspect 9. The system of any one of aspects 1-8, wherein at least one of the plurality of chemical reservoirs comprises an oil.

Aspect 10. The system of any one of aspects 1-9, wherein the mixer is a static mixer.

Aspect 11. The system of any one of aspects 1-10, wherein the flow reactor is further configured to control environmental conditions of the channel.

Aspect 12. The system of any one of aspects 1-11, wherein the flow reactor is further configured to control the temperature of the channel.

Aspect 13. The system of any one of aspects 1-12, wherein the system further comprises a filtration device configured to prevent the formation of bubbles in the fluids within the system.

Aspect 14. A method comprising: mixing together at least two fluids, thereby forming a segmented flow comprising a plurality of droplets; flowing the segmented flow into a reactor; controlling a temperature of the reactor; measuring at least one target property of nanoparticles in individual droplets in the segmented flow as the plurality of droplets pass through the reactor; and adjusting formation of droplets added to the segmented flow based upon the measured at least one target property of the nanoparticles.

Aspect 15. The method of aspect 14, wherein the at least one target property is selected from nanoparticle radius, nanoparticle size distribution, absorption spectra, photoluminescence characteristics, dispersity status, dynamic viscosity, electrical conductivity, small angle X-ray scattering (SAXS) intensity (Int), crystallinity, and a combination thereof.

Aspect 16. The method of aspect 14 or aspect 15, wherein a rate of delivery of the two fluids, a volume of delivery of the two fluids, or a combination thereof is adjusted based on the measured at least one target property.

Aspect 17. The method of any one of aspects 14-16, wherein the at least two fluids are sequentially mixed via a rotary valve.

Aspect 18. The method of any one of aspects 14-17, wherein the segmented flow comprises the plurality of droplets separated by oil segments.

Aspect 19. The method of any one of aspects 14-18, wherein formation of the droplets is dynamically adjusted to within a defined limit of the at least one target property.

Aspect 20. The method of aspect 19, wherein the dynamic adjustment is in response to machine learning analysis of the measured at least one target property.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### E. Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

i. Fluidics Platform with In-Situ X-ray Scattering for Real-Time Autonomous Synthesis and Optimization of Colloidal Nanoparticles

Conventionally, nanoparticle synthesis has relied heavily on empirical knowledge and human intuition, with limited understanding of underlying reaction mechanisms. This approach is inefficient and hinders the targeted discovery of novel nanoparticles, particularly when exploring new systems without prior knowledge. This challenge is compounded by the high sensitivity of nanoparticle formation to synthetic conditions: small changes in reaction environments can yield dramatically different properties. Moreover, the common practice of incrementally modifying existing protocols restricts innovation and comprehensive parameter space exploration, ultimately impeding mechanistic understanding.

Real-time, continuous optimization through the synergistic integration of automation and machine learning (ML) offers an avenue for accelerating the colloidal synthesis of nanoparticles. In recent years, several AI-guided synthesis platforms have emerged, with two main approaches: robot-assisted and fluidics systems. However, these platforms face several fundamental limitations that restrict their effectiveness in materials discovery and optimization. Robotic platforms typically reply on in-situ optical characterization tools such as UV-visible (UV-Vis) or photoluminescence spectroscopy. This dependence on optical techniques not only limits material scope but, due to mobility constraints and space requirements, also makes integration with more sophisticated analytical techniques like synchrotron-based X-ray characterization challenging. Meanwhile, fluidics-based platforms offer greater portability and versatility, as demonstrated in their successful self-driven synthesis of metal nanoparticles and quantum dots using both optical and X-ray techniques. However, current approaches face multiple challenges: they often employ sequential protocols that limit experimental throughput, and they typically separate synthesis from characterization, necessitating sample extraction or transfer for analysis. These limitations not only risk altering products before characterization but also create delayed feedback loops that compromise optimization efficiency and restrict parameter space exploration.

Herein is discussed a self-driven fluidics platform for on-the-fly autonomous synthesis of colloidal nanoparticles that seamlessly integrates automated fluidics, in-line characterization, real-time analysis, and artificial intelligence (AI)-driven active learning. The system incorporates three improvements. First, its modular and mobile design enables direct integration with synchrotron-based SAXS/WAXS, providing comprehensive morphological and structural characterization capabilities beyond traditional optical methods. Second, real-time materials characterization and data analysis are fully integrated into the synthesis process, eliminating the need for sample extraction or post-processing steps. Third, the segmented droplet approach enables parallel reactions, with multiple droplets carrying out different syntheses simultaneously while preventing cross-contamination.

The synthesis of gold nanoparticles was selected to demonstrate the platform's capability to efficiently explore vast synthesis spaces while revealing fundamental insights into nanoparticle formation mechanisms. Additionally, ML is used to investigate the correlations between the synthesis parameters and the resulting nanoparticle properties, providing deeper chemical insights into the mechanisms of nanoparticle formation. For example, past studies have established that the molar ratio of sodium citrate to gold chloride plays a significant role in determining the size of gold nanoparticles, but these studies are primarily limited to a narrow range of ratios, typically between 1:1 and 1:10. The present fluidic platform rapidly and efficiently explores a much broader range of ratios, from approximately 0.27 to 480, while additionally varying other parameters such as pH. After only ˜150 experiments, uniform nanoparticles were synthesized with a target size in a self-driven fashion. This work showcases the successful implementation of an on-the-fly autonomous synthesis of gold nanoparticles, demonstrating a strategy for accelerating nanomaterials discovery and optimization using a self-driven fluidic platform. This approach is general and establishes a general framework applicable to a broad range of colloidal systems.

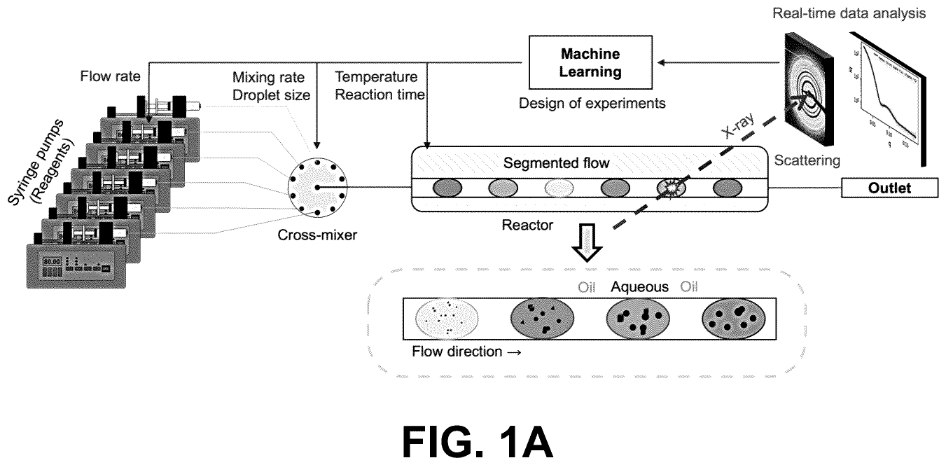

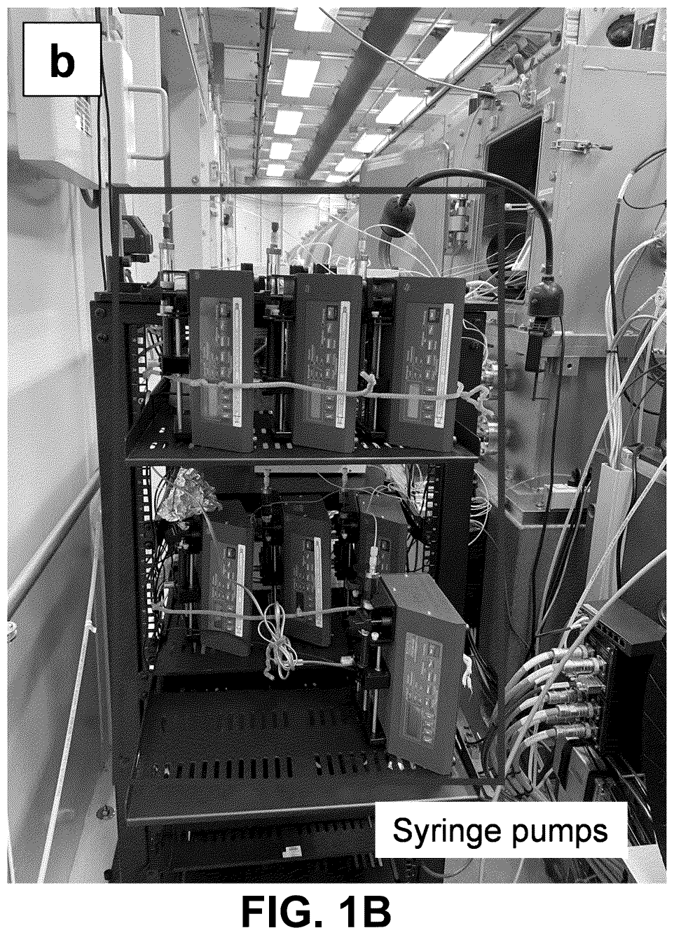

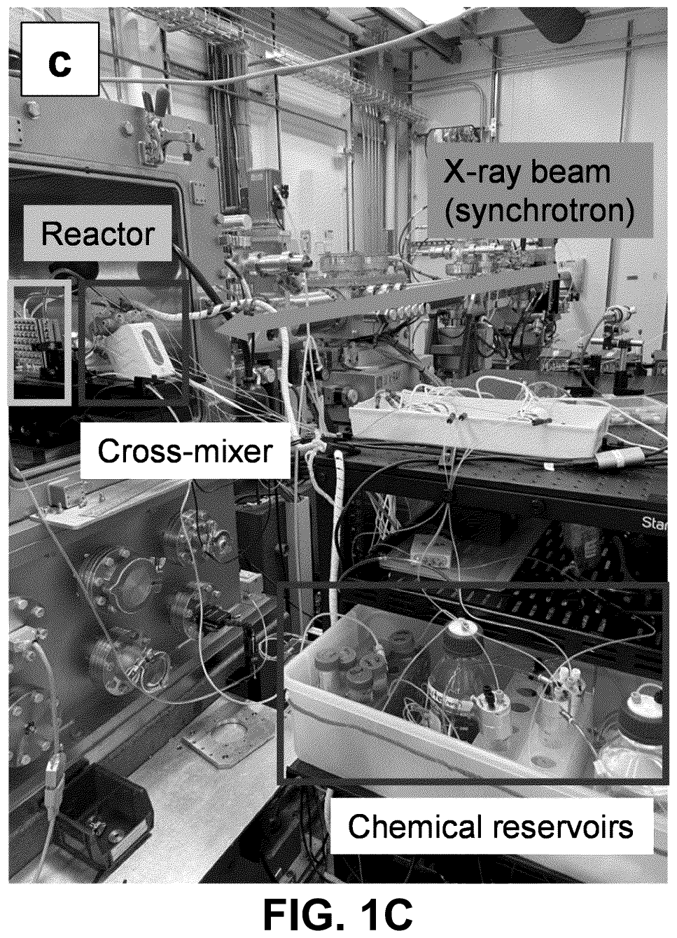

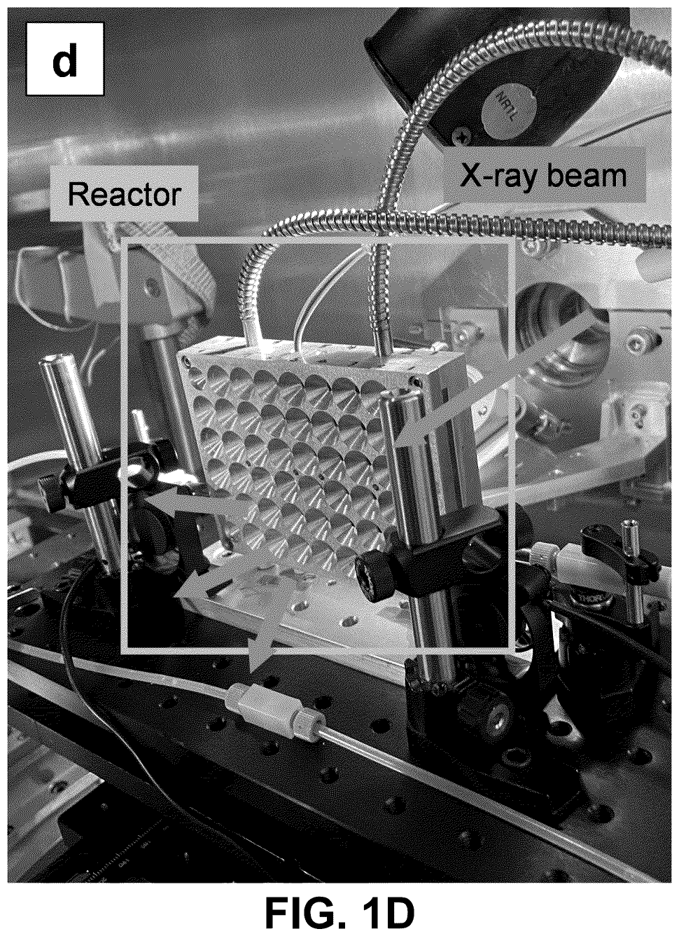

Workflow of the self-driven fluidics platform for “on-the-fly” autonomous synthesis of colloidal nanoparticles. A workflow diagram of the self-driven fluidic platform is depicted in FIG. 1A, designed to enable high-throughput and autonomous close-loop synthesis of colloidal nanoparticles. The inset in the dashed rectangle illustrates the growth process of nanoparticles in individual droplet microreactor. The platform operates through five integrated steps: 1) automated droplet generation informed by ML; 2) chemical reactions in a flow reactor; 3) in-line characterizations; 4) real-time data analysis; and 5) AI-driven decision-making for proposing the next experiments. The automated fluidic hardware precisely dispenses and mixes chemical reagents based on suggested recipes and conditions, combining them with a carrier oil phase to form isolated reaction droplets. These droplets can be continuously generated and flow through the system, creating a steady stream of micro-reactors. As the droplets move downstream, they enter an in-house-built temperature-controllable reactor equipped with 54 observation windows, enabling real-time characterization through various analytical techniques, including SAXS/WAXS. The collected data undergoes immediate analysis and feeds into the ML model, which can optimize synthesis parameters to achieve desired objectives. This closed-loop process ensures each subsequent experiment balances exploration and exploitation, accelerating the discovery and optimization of target nanomaterials.

To validate this autonomous synthesis approach, the Turkevich method was used for gold nanoparticles synthesis as the model system. As shown in FIGS. 1B and 1C, a modular flow system was developed incorporating multiple syringe pumps, fluidic connections, a cross-mixer, and a high-temperature flow reactor, all controlled through a centralized computer interface using custom Python scripts. The system's modular and mobile design enables seamless integration with advanced characterization techniques. FIG. 1B shows the automated reagents injection system with precision syringe pumps (e.g., <1 μL precision). FIG. 1C highlights chemical reservoirs and cross-mixer combining selection valves (preventing cross-contamination) and static PTFE helix mixer for efficient solution mixing. FIG. 1D shows the temperature-controlled reactor hosting 54 X-ray windows allowing simultaneous in-situ SAXS/WAXS measurements for real-time monitoring and analysis, enabling continuous synthesis optimization. For this example, SAXS/WAXS was used to provide real-time analysis of both morphology and crystallinity of synthesized nanoparticles, enabling precise control over the synthesis process.

One feature of the disclosed system is its ability to conduct high-throughput synthesis, using a steady and continuous flow, while maintaining precise control and monitoring of individual reactions. This capability, however, presents a challenge: accurately matching characterization data with specific chemical recipes and reaction conditions for each droplet. After it is created, each droplet must move through the reactor for some amount of time before being characterized. At any point, the reactor can have well over 20 droplets moving through it. An “off-by-one” error in correctly pairing droplets between creation and characterization could misassign data, leading to inaccurate steps in the ML model optimization. Such errors compromise the integrity of the entire dataset, as the ML model relies heavily on accurate input-output relationships to refine synthesis parameters effectively.

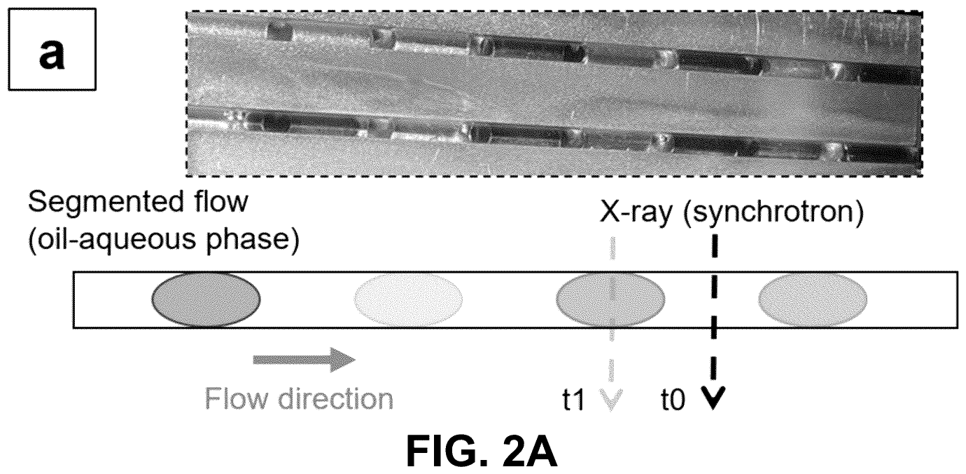

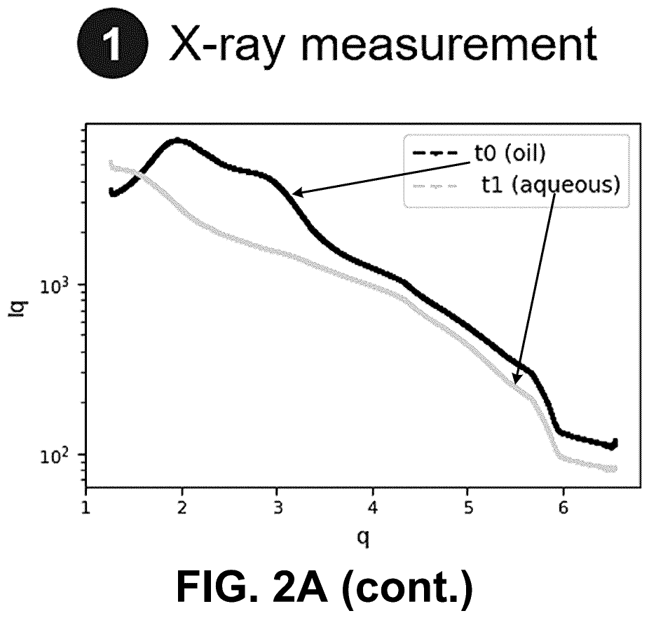

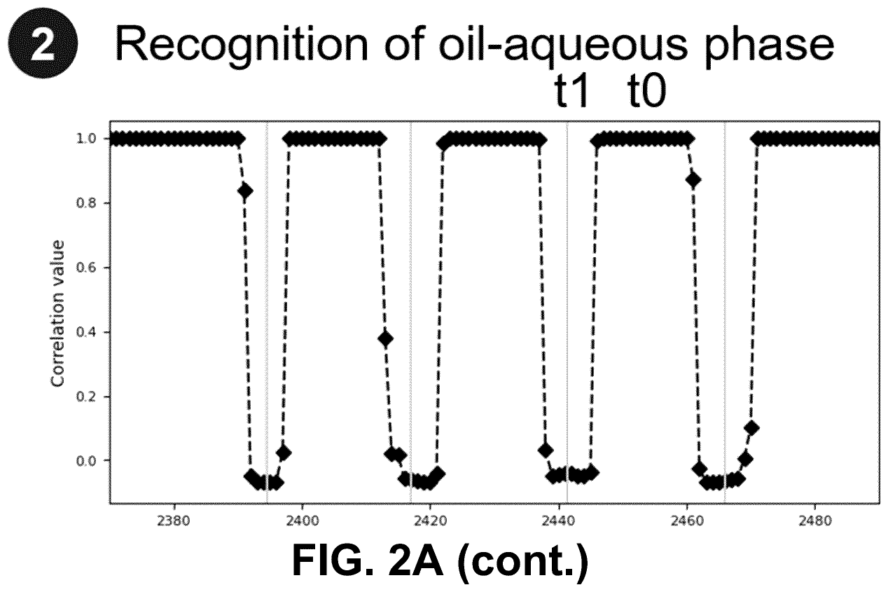

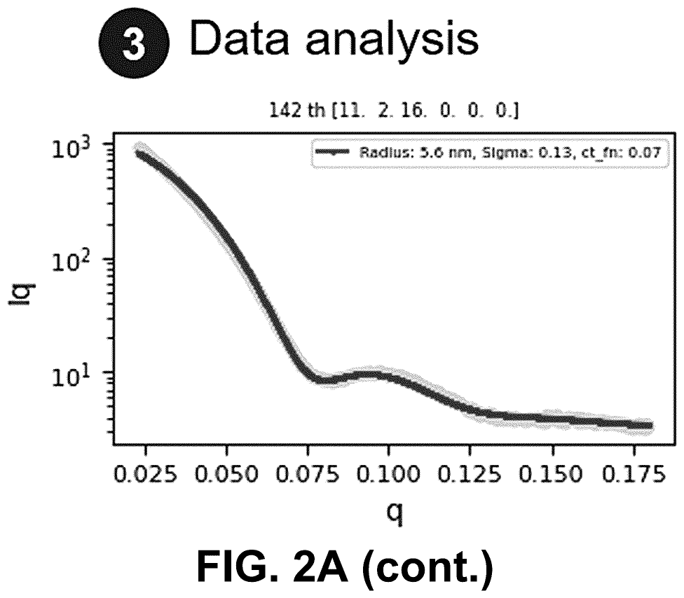

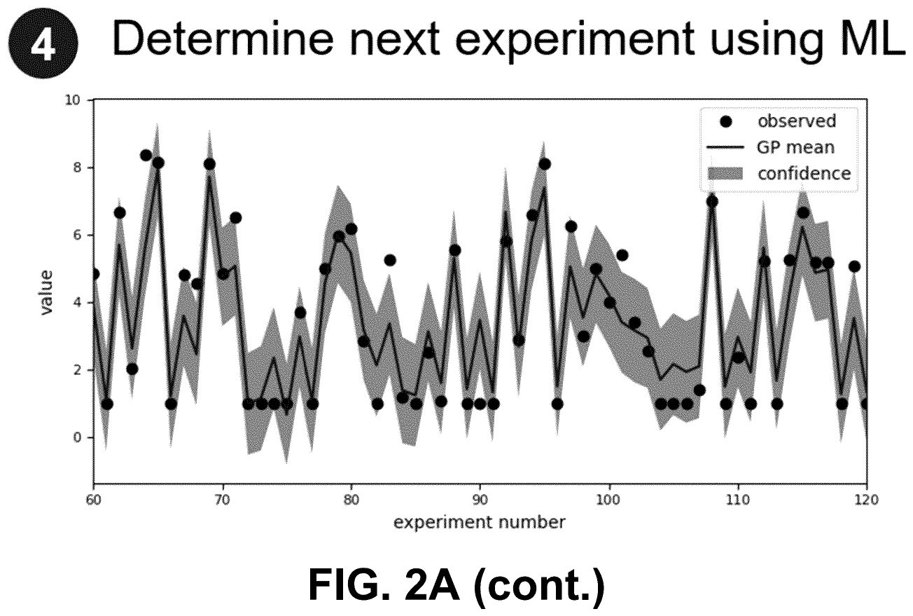

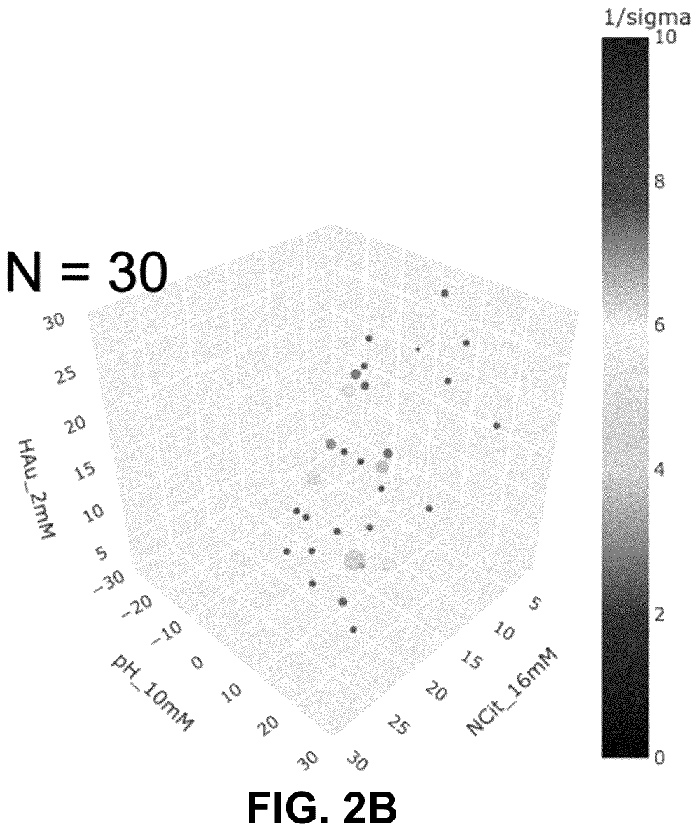

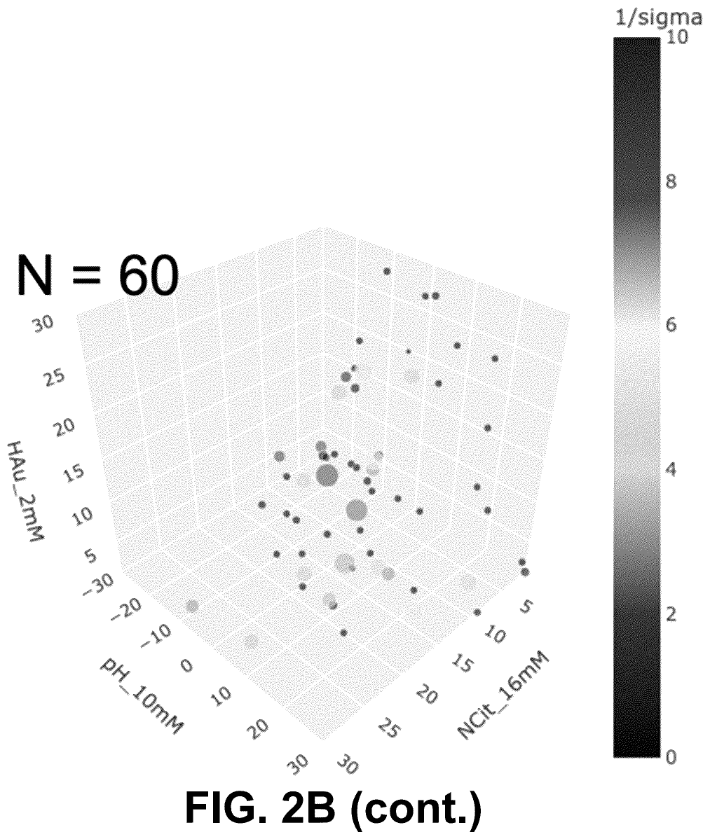

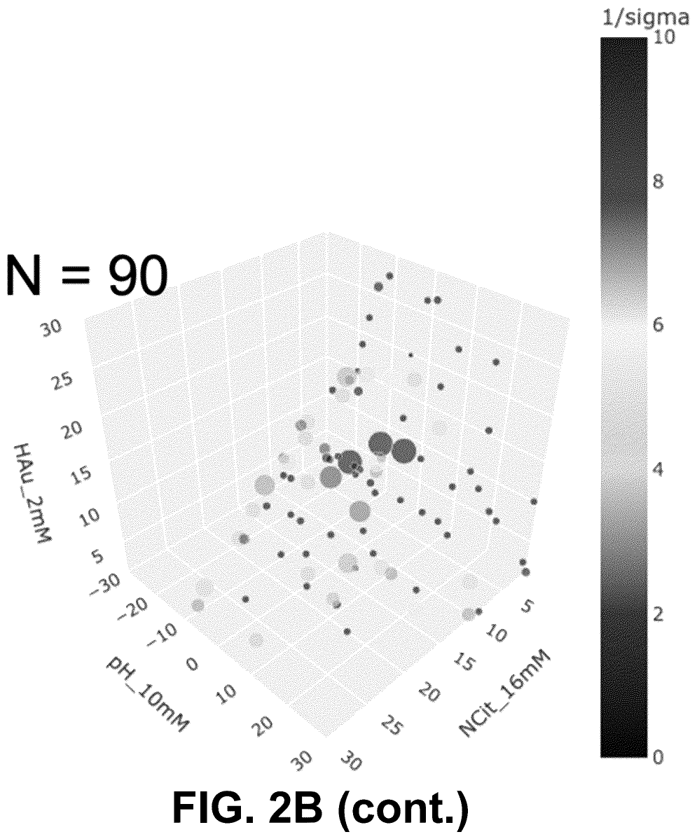

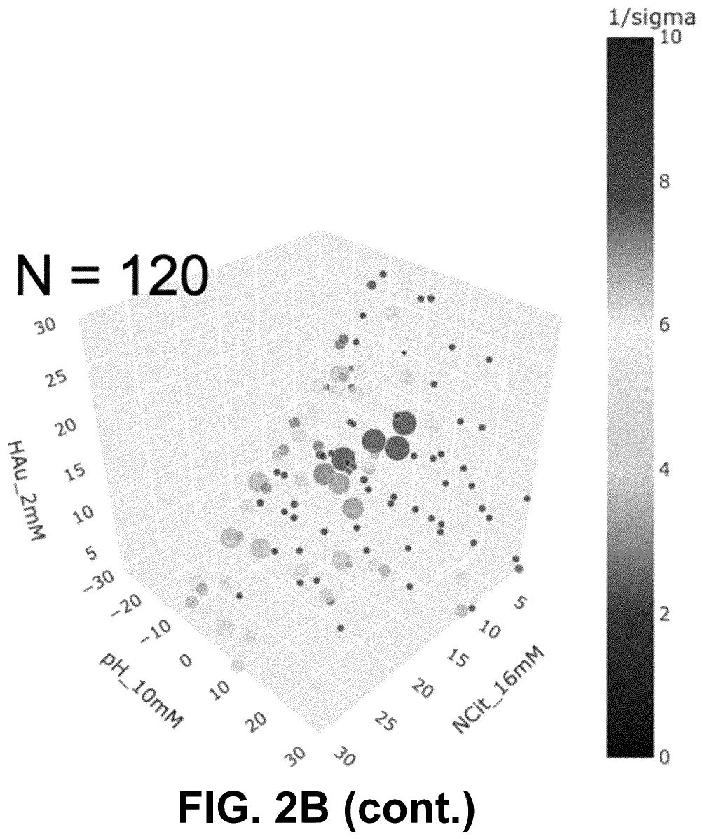

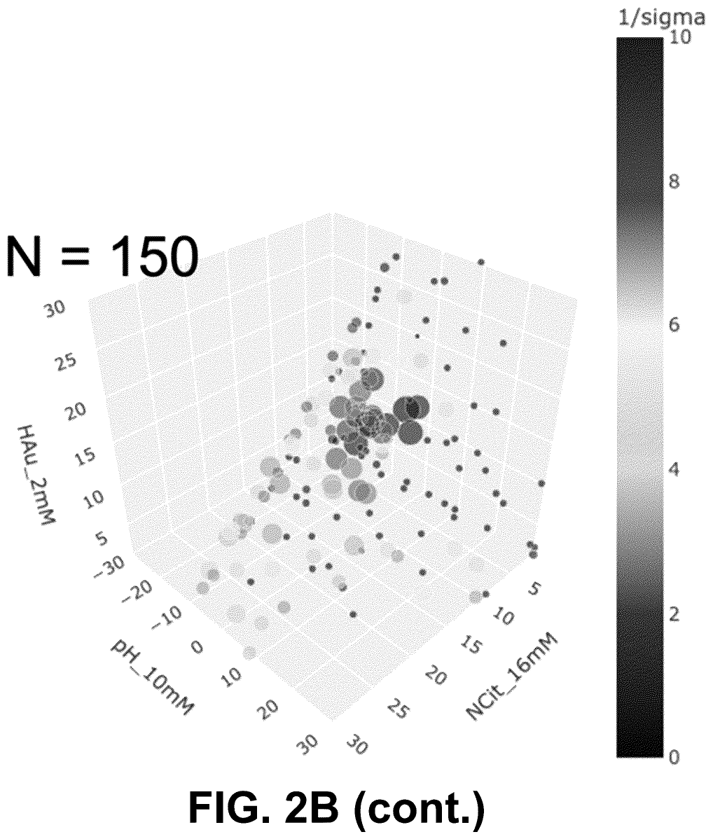

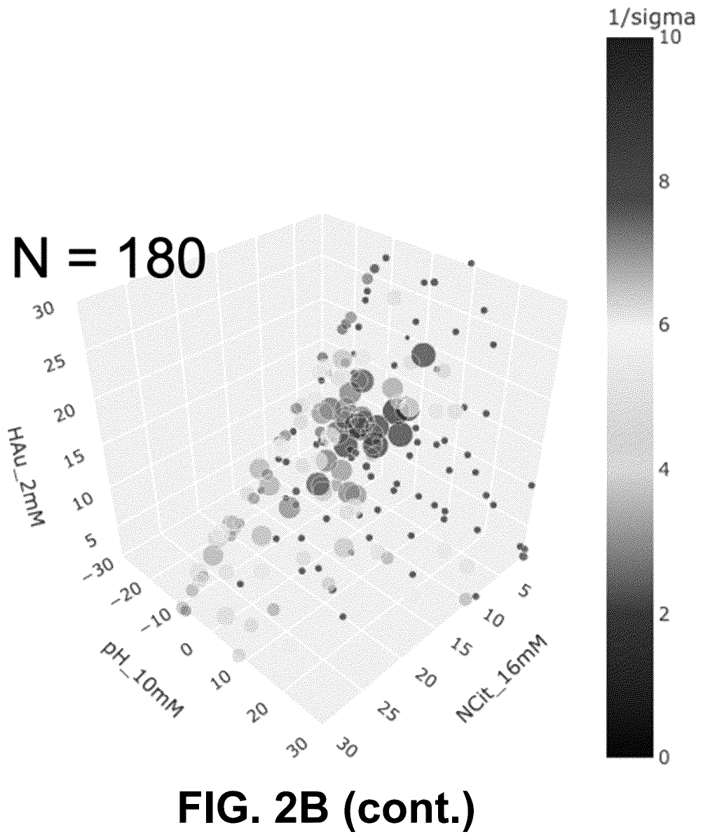

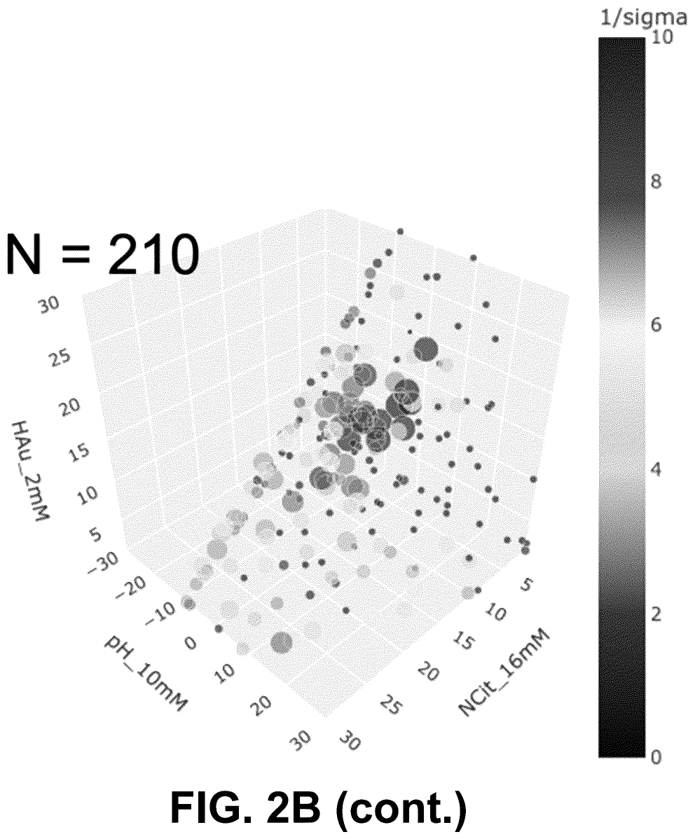

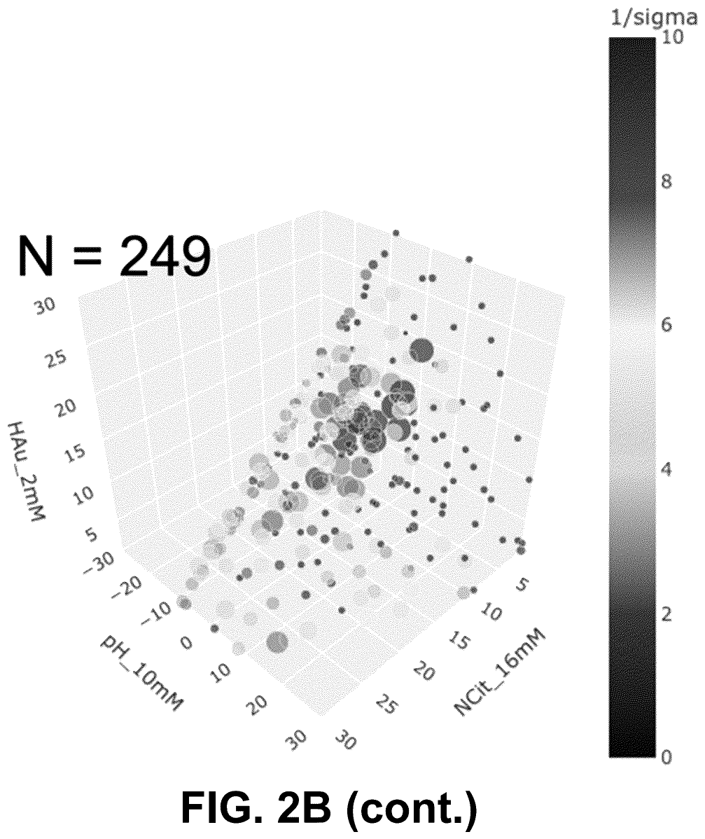

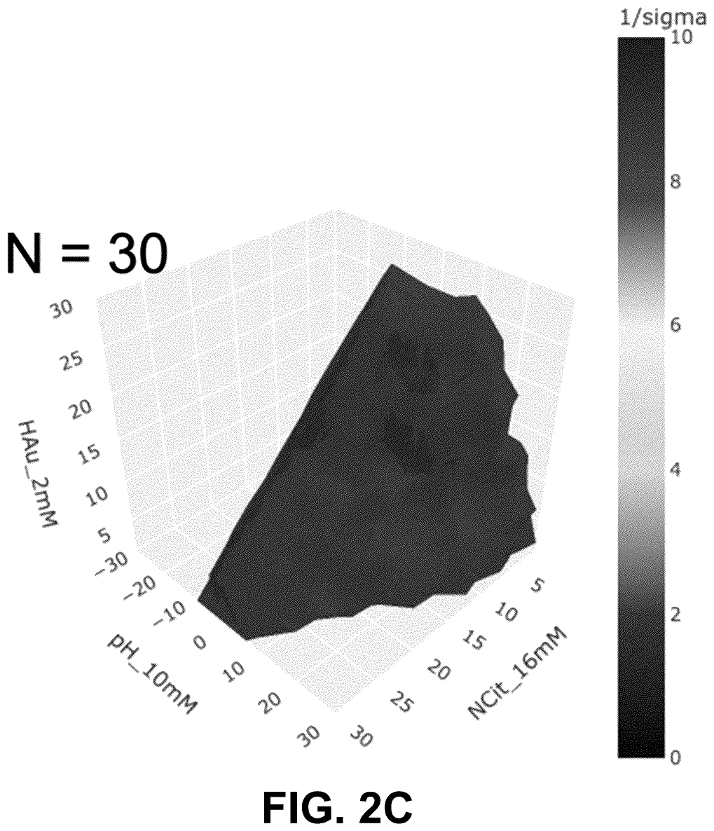

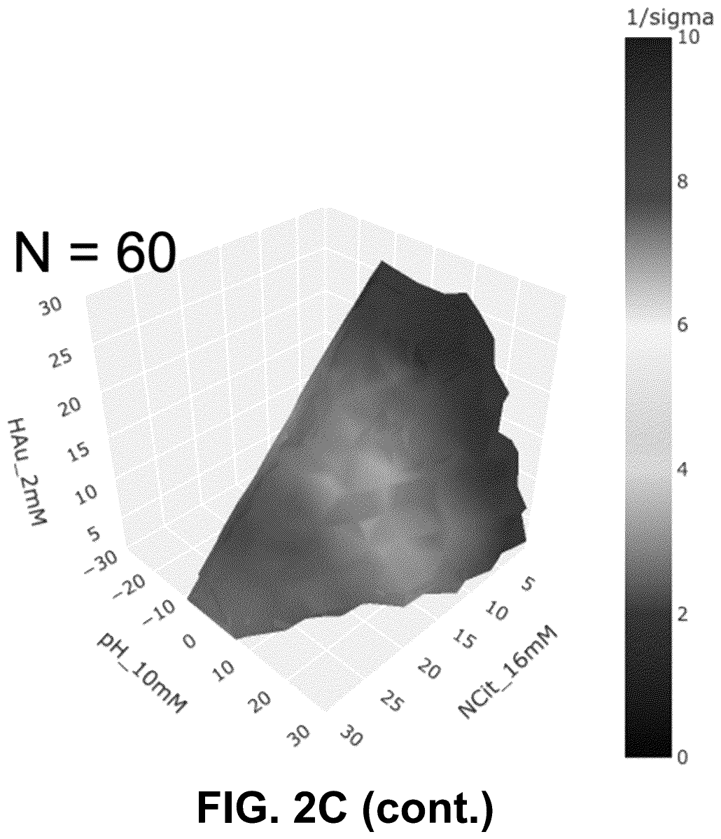

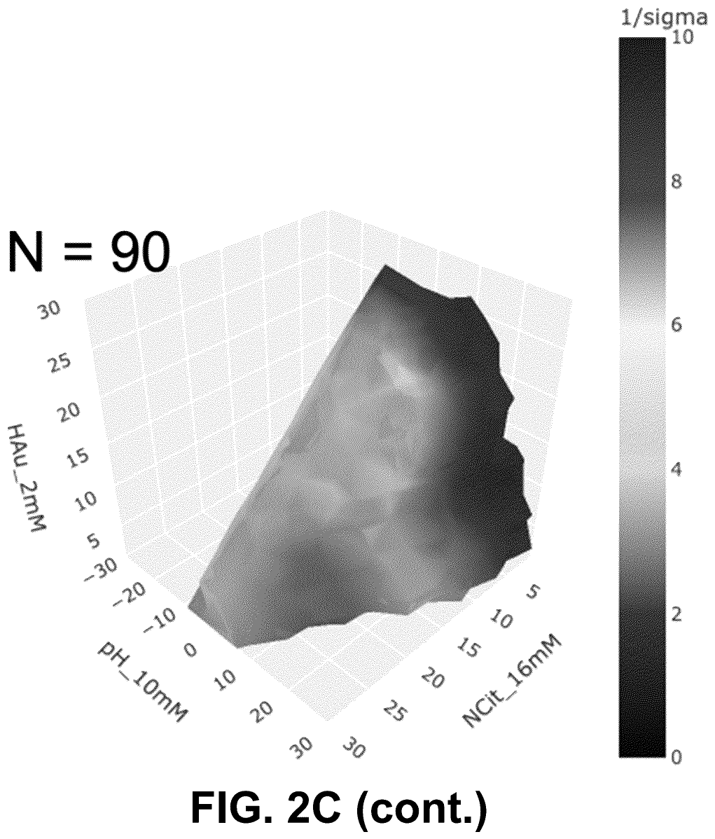

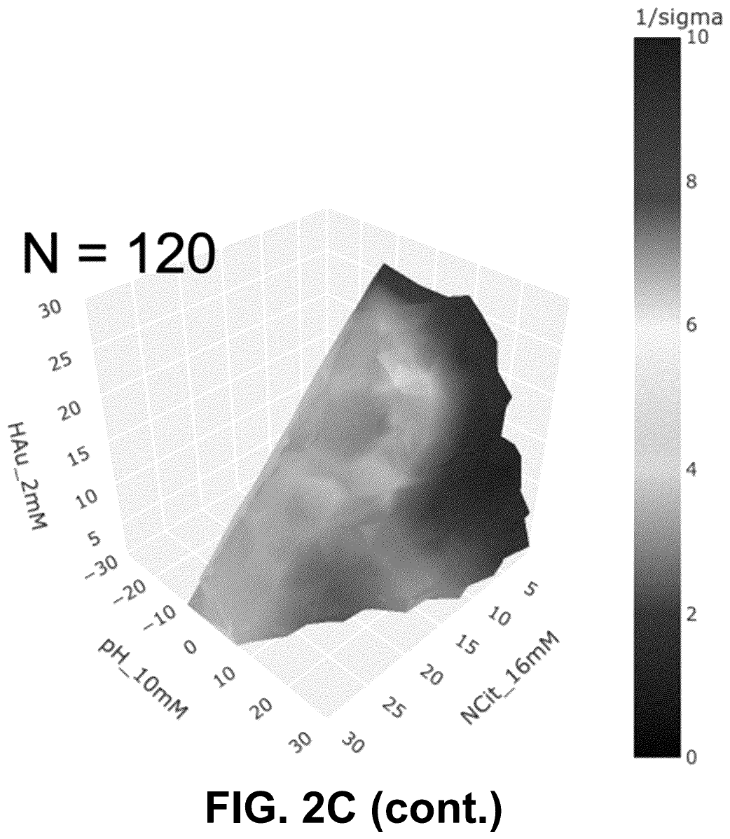

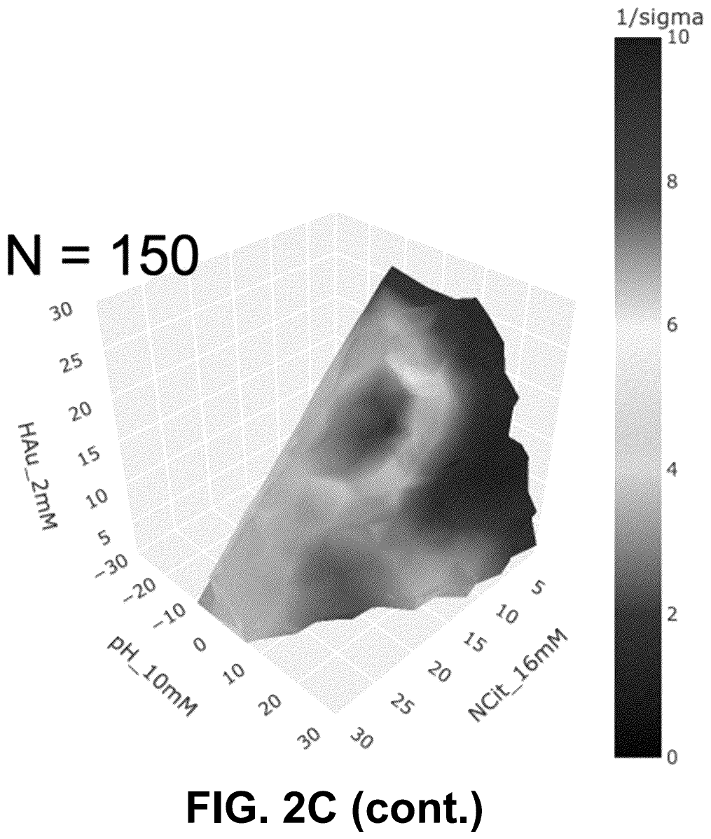

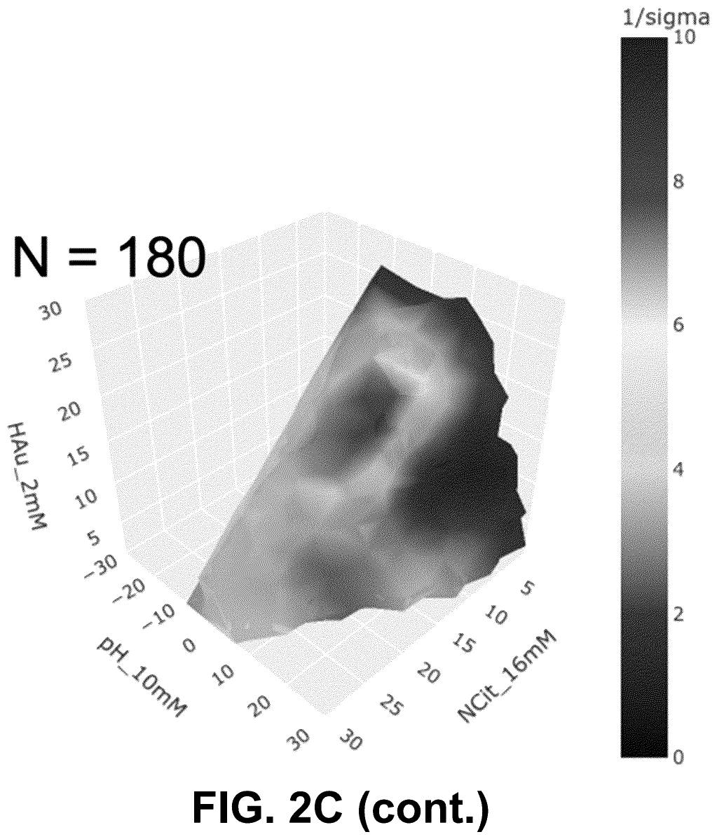

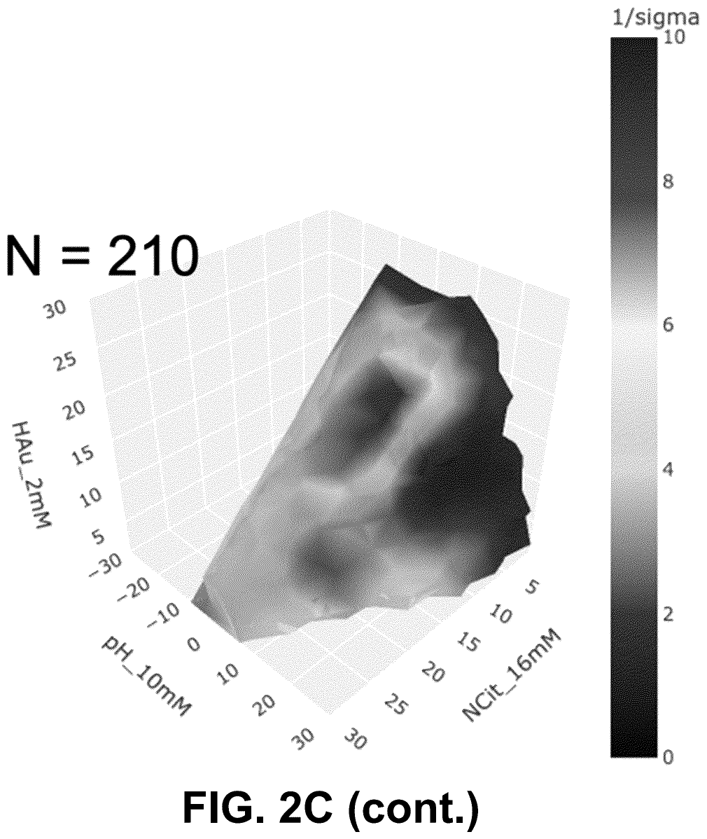

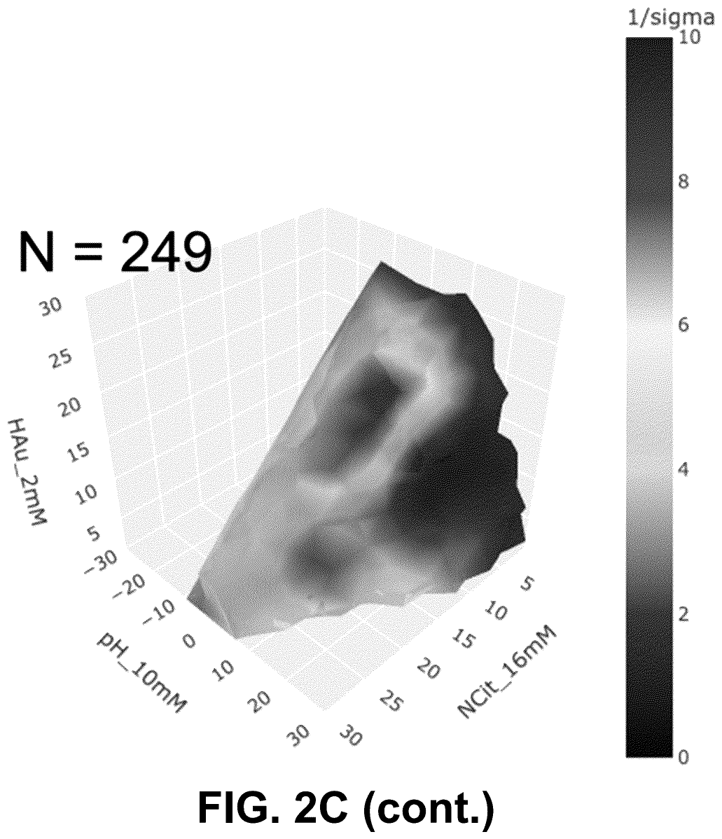

This challenge was solved by developing a real-time correlation analysis method that leverages distinctive features in the WAXS data. The oil phase exhibits a characteristic scattering feature within the wave vector transfer (q) range from 1 to 3 Å⁻¹, which is distinct from the aqueous reaction phase. By performing pairwise correlation with a reference oil pattern (see insert 1 (in-situ X-ray measurements demonstrating distinct WAXS features between oil phase (t₀) and aqueous droplet (t₁) in q-range 1-3 Å⁻¹) and insert 2 (real-time phase recognition via correlation analysis of WAXS profile against reference oil profile, enabling binary identification) of FIG. 2A; details below), oil segments (correlation score ˜1) can be reliably distinguished from aqueous phases (correlation score ˜0). This distinction enables precise tracking of droplets as they move through the reactor, allowing for to accurate pairing of each synthesis condition with its corresponding characterization data. By resolving this potential identification problem, the dataset remains consistent and reliable, which is important for the ML optimization process.

The real-time analysis pipeline processes experimental SAXS data by assuming a spherical form factor model to extract size (radius), and size distribution. The results of this fitting procedure are fed directly to the ML module (insert 3 (automated droplet data selection and SAXS analysis using spherical form factor models to extract nanoparticle properties (size, r, and distribution, c) during continuous synthesis) of FIG. 2A). The system employs Gaussian Process Machine Learning (GPML) to map the relationship between reaction conditions (reagent volumes as input) and resulting nanoparticle properties (size and distribution as output). Bayesian Optimization (BO) then determines optimal parameters for subsequent experiments based on the fitted GP model, closing the loop (insert 4 (GPML model development updated with each droplet data, with Bayesian Optimization (B=100) predicting subsequent experimental parameters to achieve target objectives) of FIG. 2A). This integrated approach enables continuous optimization until desired materials properties are achieved.

Experimental Run 1: Autonomous synthesis of monodisperse nanoparticle. The initial experiment (“Run 1”) was designed to explore the synthesis parameter space toward single-objective optimization: minimizing nanoparticle size distribution(s). To balance exploration and exploitation, a GPML model was employed with the Upper Confidence Bound (UCB) acquisition function (B=100, which weights the GP standard deviation 10 times more than the mean), using 1/σ as the optimization target within the accessible synthesis parameter space. The experiments began with 27 droplets, corresponding to the number of droplets spanning the tubing from the point where chemical reagents were mixed at room temperature to the X-ray probing position through the high-temperature reactor. Those droplets were generated using randomly selected parameters from three stock solutions: 10 mM Na Citrate (NCit), a pH controller (either 10 mM HCl or NaOH), and 2 mM HAuCl₄(HAu). Synthesis parameters were constrained within practical bounds: NCit and HAu volumes between 1 μL and 30 μL, pH adjustment (HCl or NaOH) from 0 μL to 30 μL, maintaining total volume at 40 μL with buffer solution. At a typical flow rate of 80 L/min, each droplet generated approximately 30 frames of SAXS and WAXS data with 1 frame/see data collections rate.

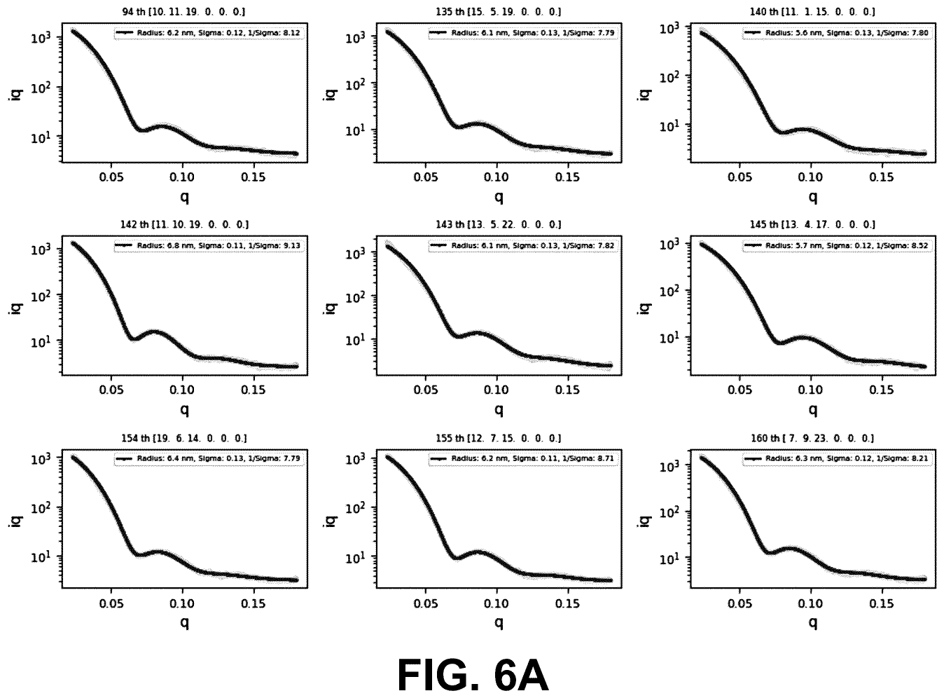

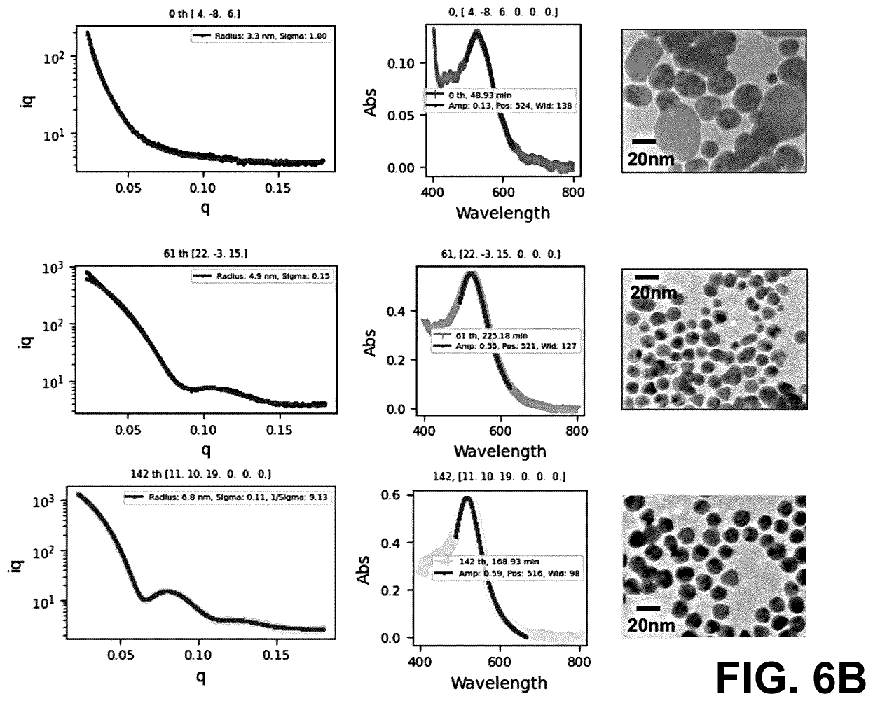

FIG. 2B illustrates the progression of autonomous exploration in 3D synthesis parameter space (reagent volumes in μL) across 30, 60, 90, 120, 150, 180, 210, and 249 experiments (N), with marker size inversely proportional to size distribution (o). The evolution of this autonomous optimization is visualized in the top-left panel of FIG. 2B, where the initial 30 recipes (including 27 random recipes) show broad distribution across the 3-dimensional synthesis parameter space. For visualization purposes, HCl and NaOH volumes are represented as negative and positive values respectively. After the random initialization stage, the self-driven system began performing experiments according to GPML-suggested recipes. FIG. 2B shows the observed 1/σ values as a function of the number of performed experiments (with marker color and size representing 1/σ value), indicating the gradual and efficient mapping of the feasible synthesis space. While continuing to explore the synthesis parameter space (exploration), the 1/σ value was also optimized (exploitation). From 61˜90 experiments, 1/σ values larger than 6 began to be observed, and as the autonomous experiment proceeded, even higher 1/σ values continued to appear (some of which are shown in FIG. 6A).

FIG. 2C illustrates how the GPML model's predictive capability evolved with the increasing training data. FIG. 2C shows the evolution of GPML predictions through active learning, demonstrating progressive refinement of parameter-property relationships and increasing model accuracy with expanding experimental dataset. Early predictions (30 or 60 experiments) show limited differentiation of 1/σ across parameter space (as shown in the top left two panels), reflecting insufficient training data. However, beyond 90 experiments, clear trends emerge in predicted 1/σ values across different domains in the synthesis space. By 150 experiments, the prediction map exhibits refined patterns, demonstrating the model's growing “understanding” of the parameter-property relationship. FIG. 2C shows GPML predictions of 1/σ value within the entire feasible synthesis space.

Except in the case of pure exploration, the primary objective of BO is to find the global maximum of the objective function, not to create an accurate surrogate model over the entire space. Despite this, strong agreement between the experimental data, and the predicted 1/σ values from GPML model was observed. This similarity highlights the effective performance of the GPML model in guiding the optimization process and reflects the balance between exploration and exploitation chosen in the chosen acquisition function, even though perfect accuracy across the entire space is not expected.

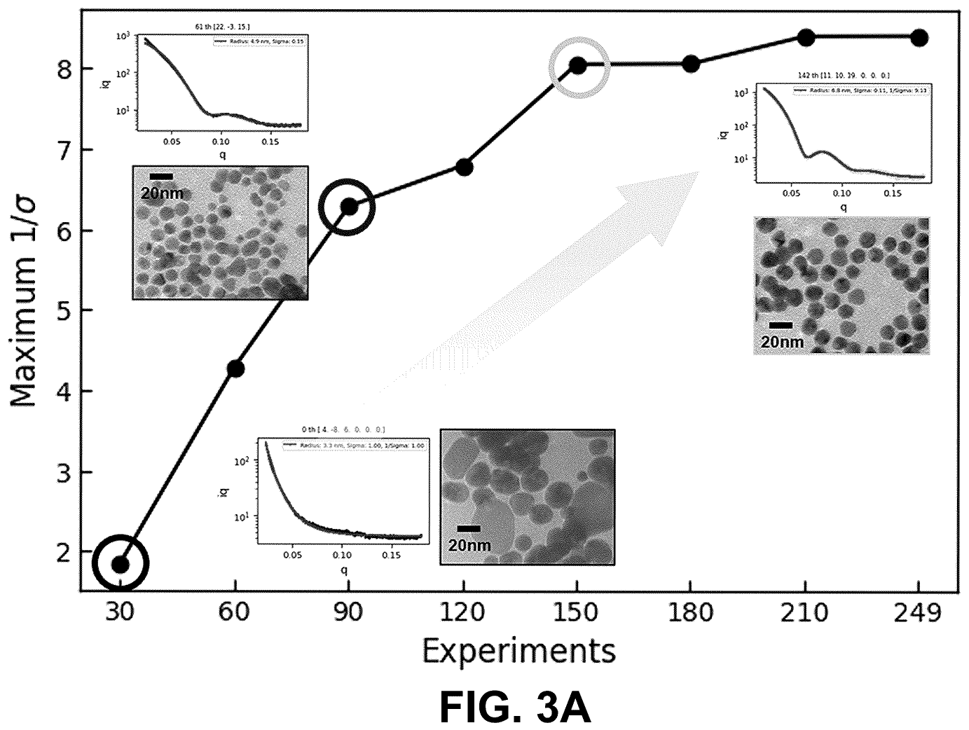

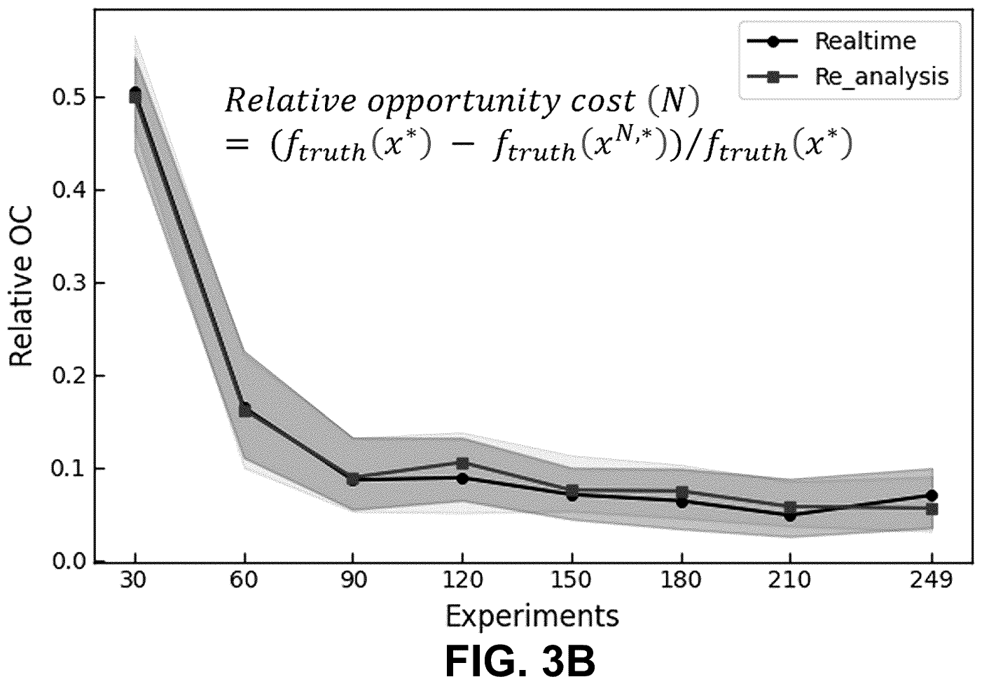

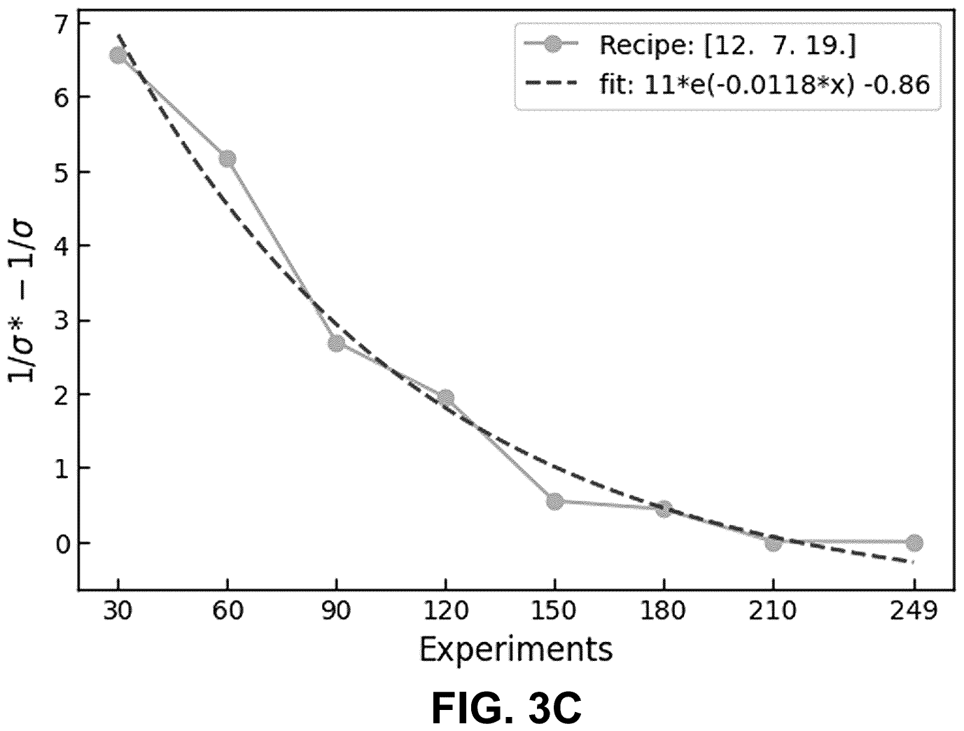

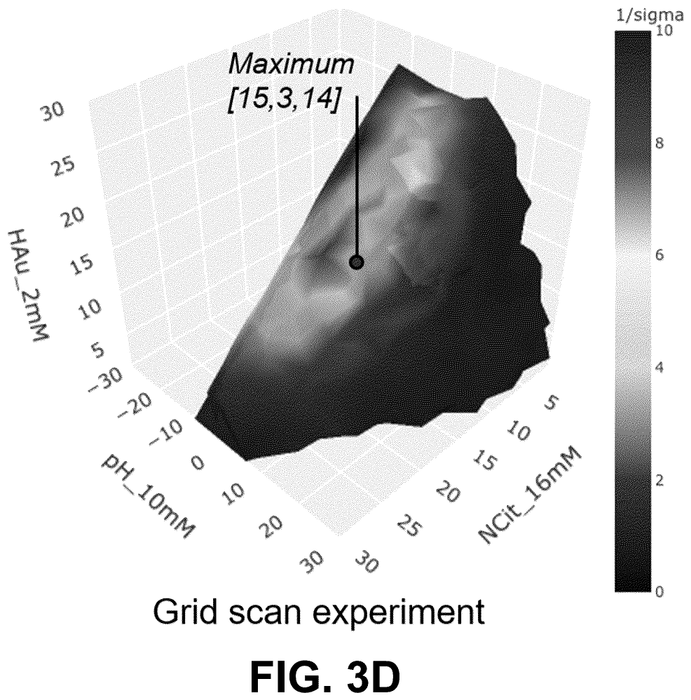

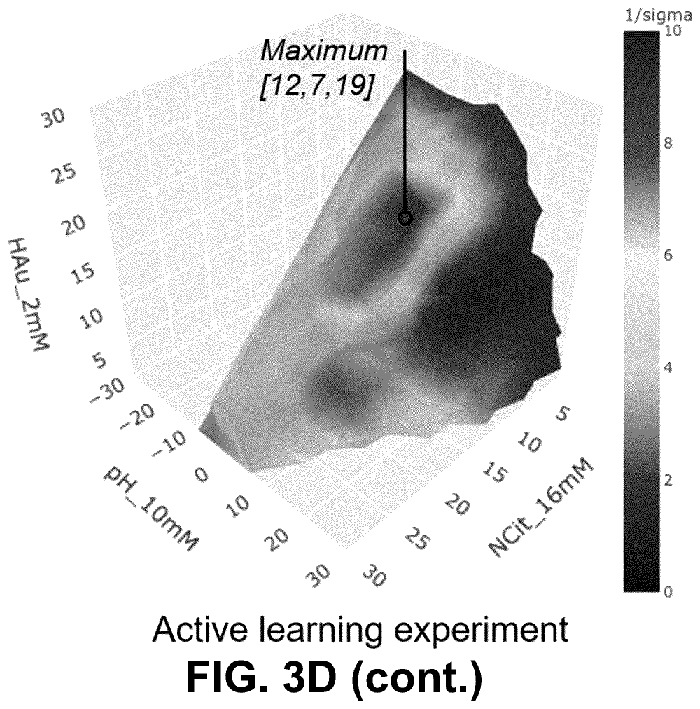

To address the questions of how quickly and effectively the GPML model learns, maximum observed 1/σ value was analyzed as a function of training data size. As shown in FIG. 3A, the prediction of optimal 1/σ value increases significantly from ˜2 to 6 as the training dataset expands from 30 to 90 data points. However, with datasets beyond 150 points, only marginal increases were observed, with the largest feasible value reaching ˜9. This progression demonstrates that around 90 data points are needed to begin effective optimization, with further refinement achieved through 150 active learning guided experiments. Notably, this efficient optimization covers a vast parameter space of approximately 19 k feasible experimental conditions (determined by the experimental boundary conditions described in the Methods section), highlighting the power of active learning in accelerating material discovery.

The effectiveness of this optimization is directly evidenced by the SAXS profiles at key stages. FIG. 3A illustrates maximum predicted 1/s values from GPML models as a function of training dataset size (N=30 to 249). Insets show representative in-situ SAXS profiles and corresponding ex-situ TEM validations at key optimization stages: initial random selection (uncontrolled polydispersity), intermediate optimization (60 experiments, r˜4.9 nm, σ˜0.15), and optimized synthesis (150 experiments, r˜6.8 nm, σ˜0.11). The initial randomly selected recipes produced nanoparticles with no distinguishable SAXS features, indicating the formation of nanoparticles with high size polydispersity (bottom left plot). By experiment 60, less polydisperse gold nanoparticles emerged, showing clear spherical form factor features with radius ˜4.9 nm and σ˜0.15 nm (top left plot). The 150th experiment achieved high uniformity, producing nanoparticles with radius ˜6.8 nm and σ˜0.11 nm (top right plot), comparable to commercial standards. These in-situ SAXS results were validated through ex-situ transmission electron microscopy (TEM) measurements. For TEM analysis, gold nanoparticles were re-synthesized using identical recipes, collected, and deposited on TEM grids. The TEM images, shown alongside corresponding SAXS profiles, confirm both consistency of nanoparticle properties in radius and size distribution and high reproducibility of the fluidic platform. Additional UV-vis characterization (FIG. 6B) further supports these findings.

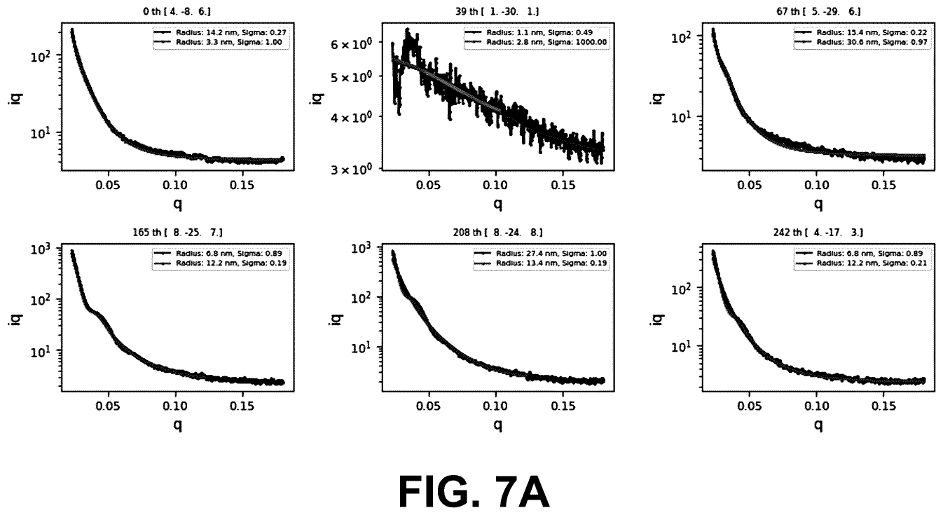

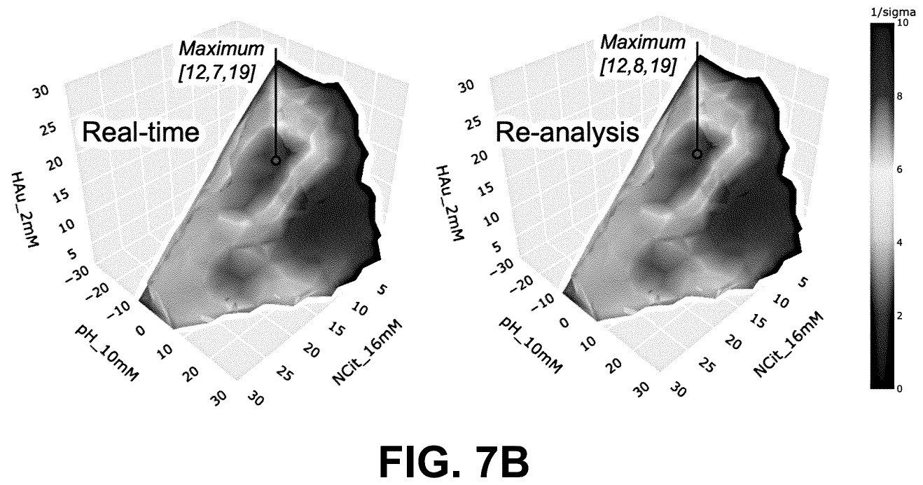

Relative opportunity cost (ROC) analysis was used for quantitative assessment of optimization performance and was defined as the relative difference in expectation between true best input and the predicted best input at a given experimental number N, using the following equation:

$$ROC ( N ) = \vert \frac{( {f}_{truth} ( {x}^{*} ) - {f}_{truth} ( {x}^{N , *} ) )}{{f}_{truth} ( {x}^{*} )} \vert$$

where x* is the true best input, and fₜᵣᵤₜₕ(x*) represents the true maximum value of objective function over the entire feasible space. Since it is infeasible to experimentally evaluate the entire synthetic parameter space (˜19 k possible conditions), x* and fₜᵣᵤₜₕ(x*) were derived using the final GPML model trained with all available experimental data. x^{N,*} is the input corresponding to the maximum of the GPML model at a given experiment Nand fₜᵣᵤₜₕ(x^{N,*}) is the corresponding objective function value. FIG. 3B shows the ROC as a function of the number of experiments performed. FIG. 3B illustrates an example of the learning curve analysis through ROC, demonstrating model convergence with a first curve showing real-time analysis results, and a second curve representing post-experiment and re-analyzed data with manually optimized fitting parameters and ranges As the GPML model is trained iteratively with more experimental data, the optimal value at the predicted best input, fₜᵣᵤₜₕ(x^{N,*}), begins to converge toward the true maximum, fₜᵣᵤₜₕ(x*), thereby minimizing the ROC. This convergence indicates an improvement in the GPML model's ability to identify the optimal experimental conditions. The ROC curve shows rapid initial improvement followed by convergence after 90 experiments, at which point it plateaus, indicating that GPML model's performance has optimized and reached its maximum effectiveness. Additionally, it is evident that the real-time automated curve-fitting of SAXS data is highly reliable and does not adversely affect GPML performance, given the similar features observed in the learning curve in FIG. 3B and the similar 3d maps of GPML predictions shown in FIG. 7B, which utilized re-analyzed the SAXS data with manually tweaking the fitting parameters and fitting range. The final discovered optimal reaction parameter from GPML model is 12μ of NCit, 7 μL of NaOH, and 19 μL of HAu.

FIG. 3C shows the difference between the 1/σ values at the final optimal recipe, comparing prediction from the final GPML model with those at each experimental stage. FIG. 3C illustrates an example of the evolution of GPML predictions at the discovered optimal conditions (NCit: 12 μL, NaOH: 7 μL, HAuCl4: 19 μL), showing exponential improvement in prediction accuracy with increasing experiments. The performance of GPML prediction at the final optimal experimental condition improves progressively as active learning continues, as indicated by the downward trend in the curve. The exponential decay pattern in this curve suggests that the difference between predicted and true optimal values decreases exponentially with increasing experiments, demonstrating rapid initial learning followed by refined optimalization. This behavior represents efficient convergence of the active learning process, with progressively diminishing differences between predicted and true optimal values as the modal approaches the true optimal condition.

To validate the approach against traditional methods, a comparative grid scan experiment (265 points) was conducted within parameters ranges typical of literature studies with narrow pH variations. While grid scan provided exhaustive coverage within its confined space, the resulting GPML struggled to predict beyond these boundaries, with its optimal recipe (NCit: 15 μL, NaOH: 3 μL, HAu: 14 μl) remaining within conventional limits. FIG. 3D illustrates compressive analysis between grid scan (265 experiments within confined NCit:HAu 1-10 ratio space) and active learning approaches (249 experiments), with optimal conditions marked with a dot and black outline, demonstrating superior exploration of vast synthesis space through active learning. In contrast, the active learning approach, despite using fewer experiments (249 points), achieving superior results by efficiently exploring and optimizing across a vastly larger parameter space, as shown in FIG. 3D (more details provided below). Remarkably, the platform completes these experiments, including synthesis, characterization, analysis, and optimization, in approximately ˜20 hours with no human intervention beyond initial reagent loading, demonstrating the power of autonomous experimentation for rapid synthesis of target materials.

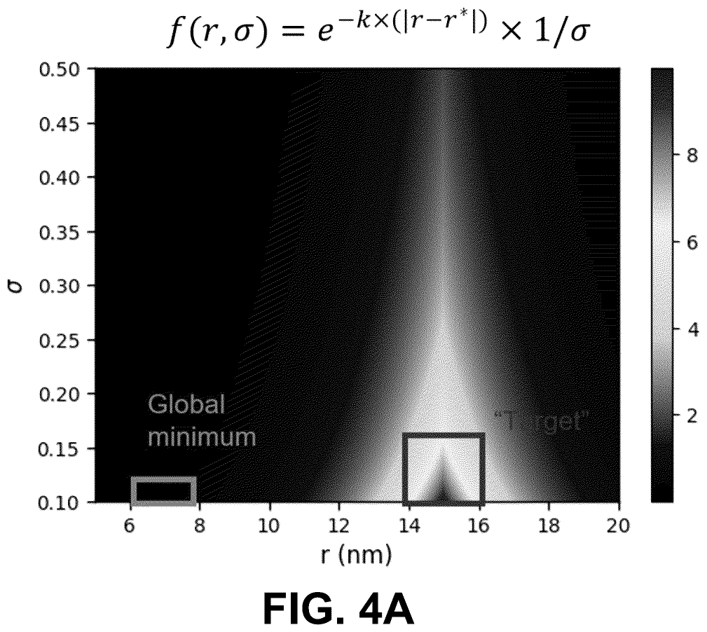

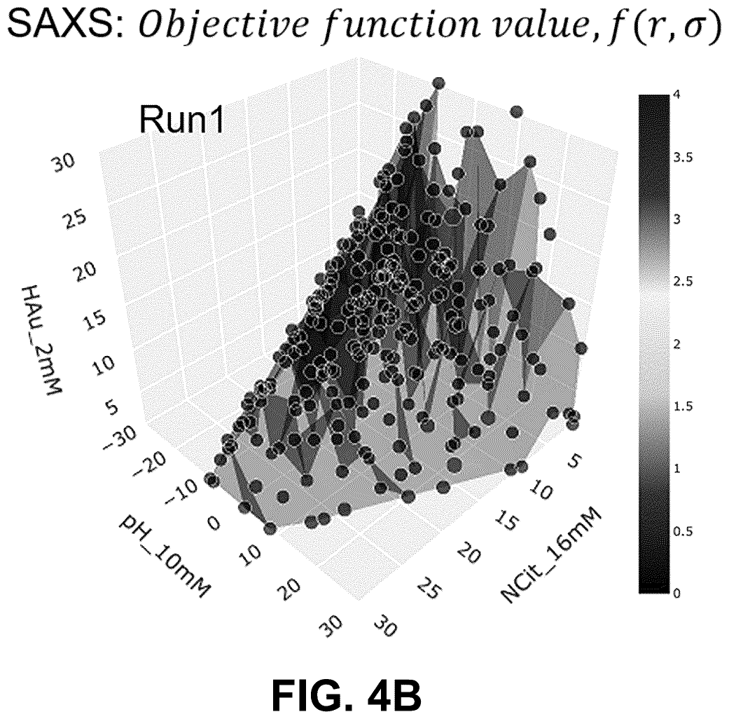

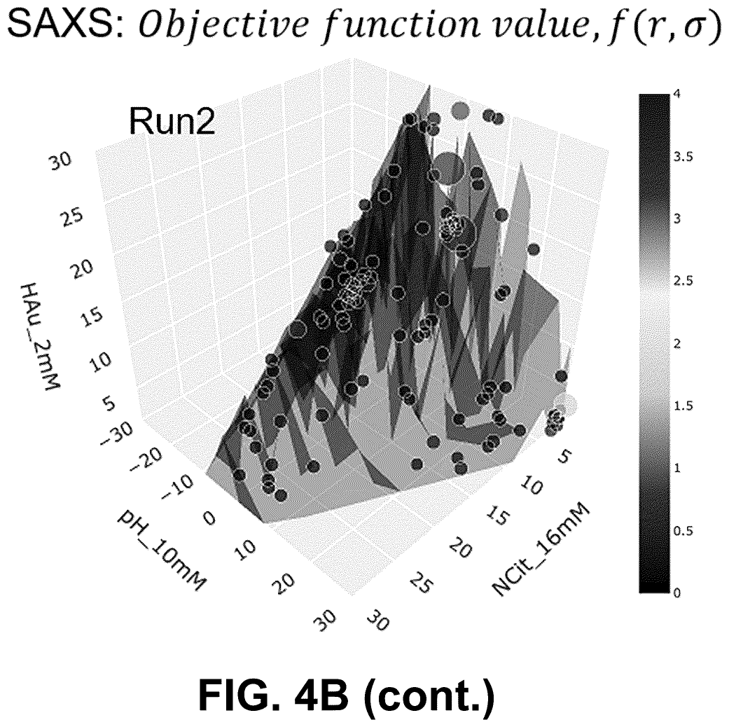

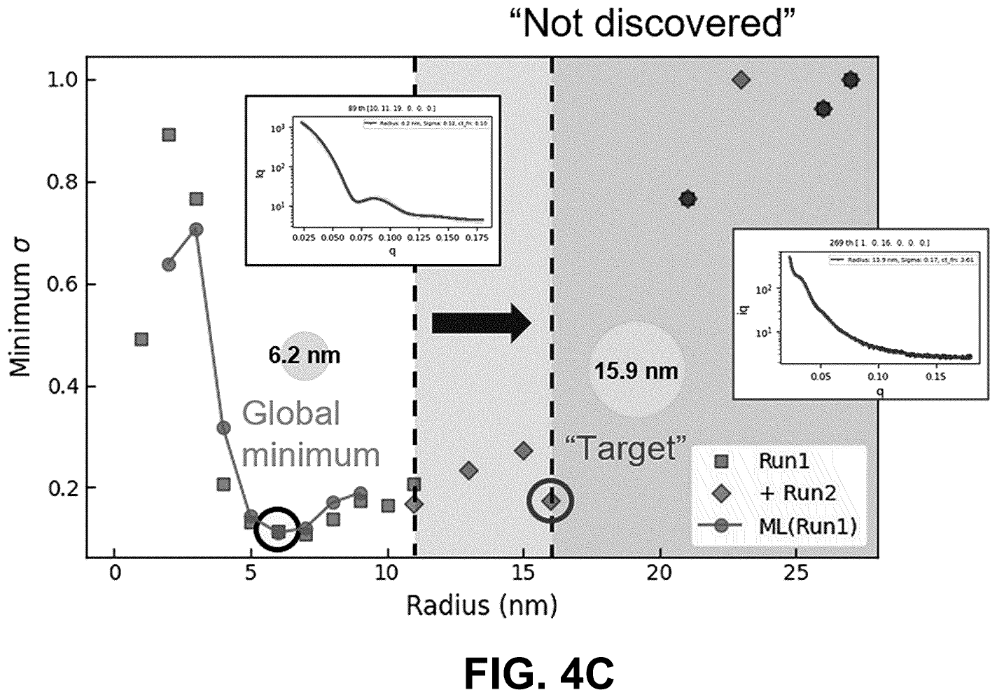

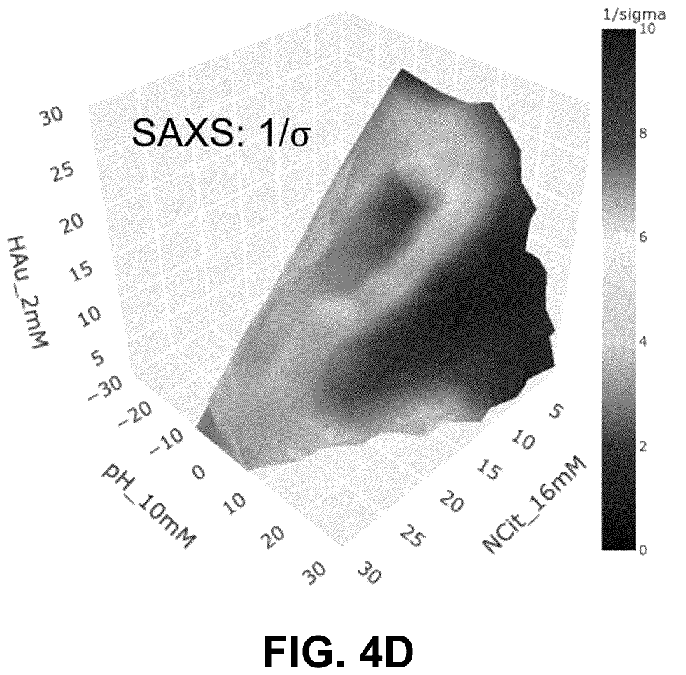

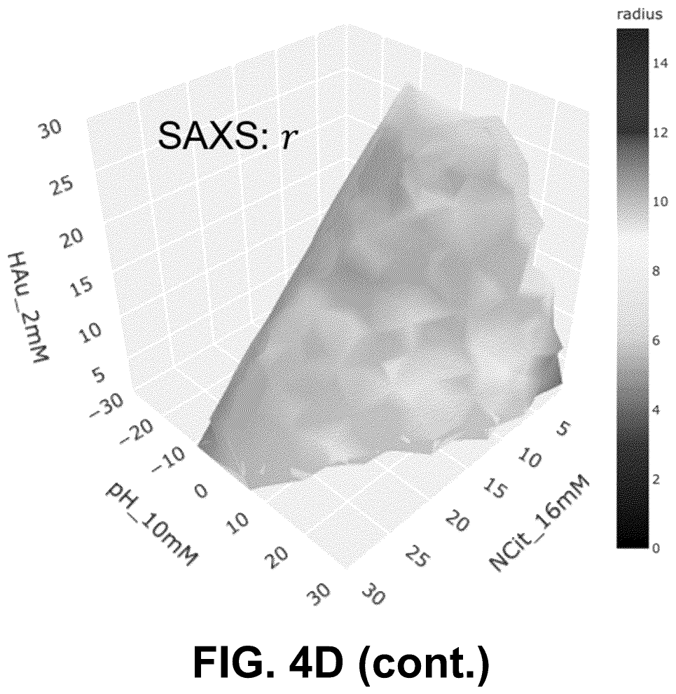

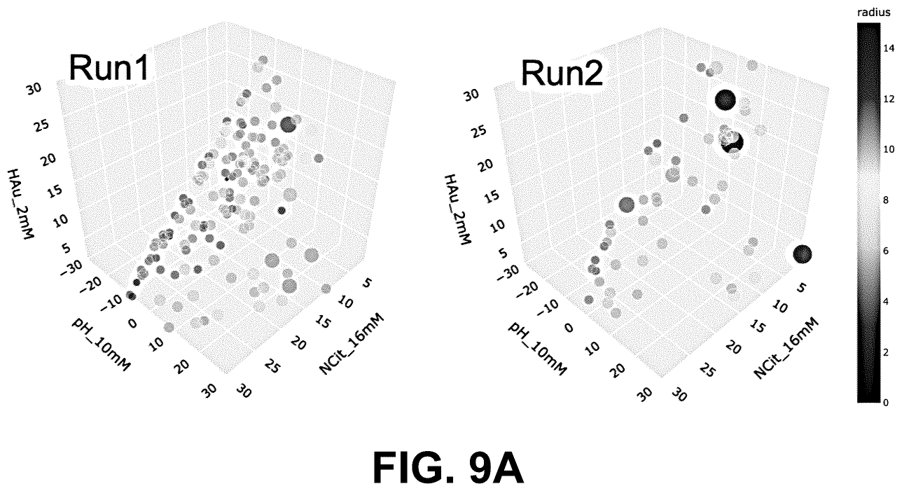

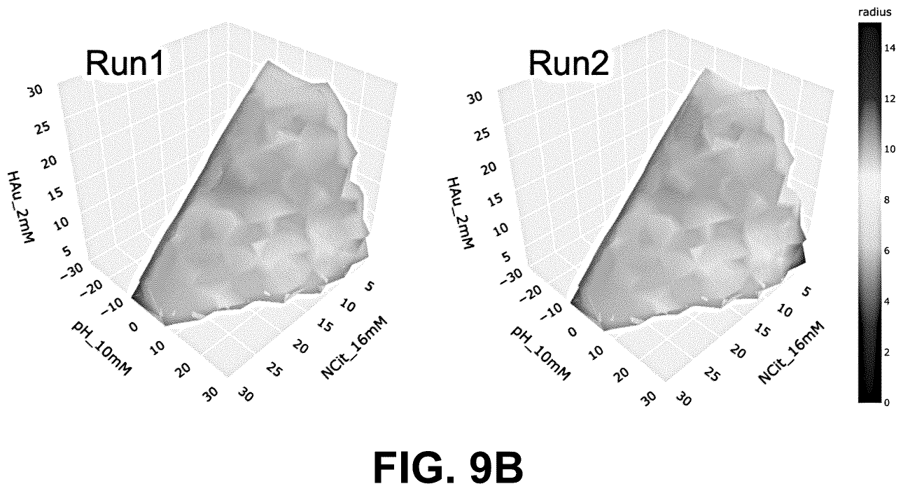

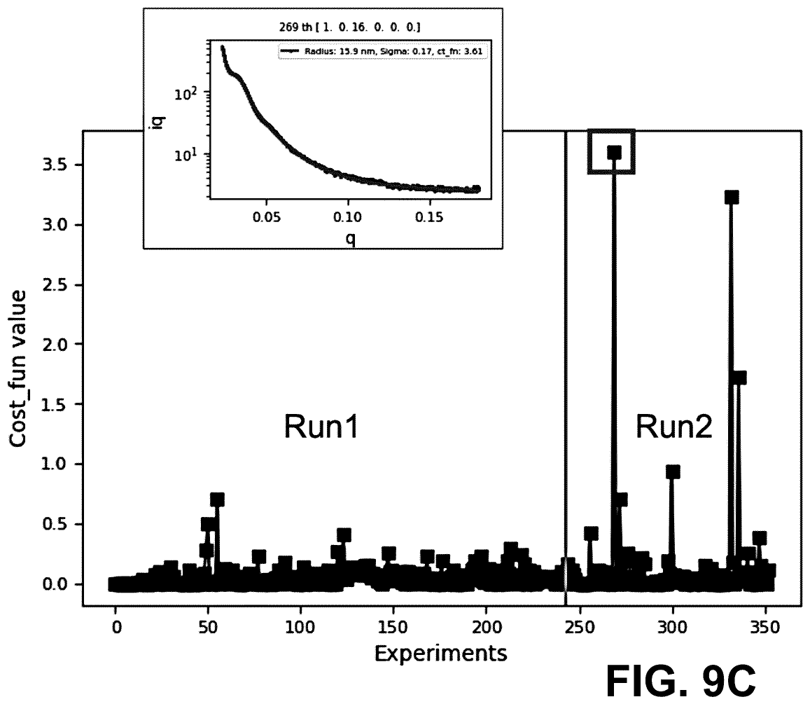

Experimental Run 2: Autonomous synthesis of monodispersed nanoparticles with targeted size. Building upon the successful optimization of the size distribution in Run 1, the approach was extended to simultaneously control both particle size and distribution through a single objective function. For Run 2, the following objective function was defined that combines these two properties:

$$f ( r , σ ) = {e}^{- k \vert r - {r}^{*} \vert} / σ ,$$

where k is a scale factor (set to 0.5), r is the observed nanoparticle radius from SAXS analysis, r* is the target radius (set to 15 nm), and σ is the observed size distribution of nanoparticles from SAXS analysis. As shown in FIG. 4A, this function is maximized when particles approach both the target size and minimal size distribution, enabling effective optimization toward both desired properties. A target radius of 15 nm was selected, well beyond the maximum radius (11 nm) achieved in Run 1 (detailed in FIG. 9), to demonstrate the platform's ability to access previously unexplored synthetic conditions. FIG. 4B is a mapping of objective function values across synthesis parameter space during Run 1 (left, 1/σ optimization) and Run 2 (right, combined size-distribution optimization). The relatively low values of the objective function calculated using the existing Run 1 data (FIG. 4B, left panel) confirmed that the previous experiments in Run 1 had not accessed this region of parameter space.

FIG. 4C shows the systematic discovery of target synthesis conditions, with the shaded region highlighting newly accessed radius range (>11 nm) achieved through custom objective function optimization. In-situ SAXS data confirms the successful synthesis at optimal conditions (r˜15.9 nm, σ˜0.17). The relationship between observed radii and their corresponding minimum σ values (squares and circles) is shown, with the central, gray-shaded area representing radii larger than 11 nm, which had not been observed (“not discovered”) in Run 1. The GPML model predictions from Run 1 show excellent agreement with experimental observations, correctly identifying the global minimum of σ at a radius of 6-7 nm. A representative SAXS profile from this optimal region (shown as inset) confirms particles with radius ˜6.2 nm and σ˜0.11.

Using the objective function to guide the GPML model, an additional 113 autonomous experiments were conducted with active learning, maintaining the same UCB acquisition function with B=100 as Run 1. The new results (shown in FIG. 4B right panel) reveal successful exploration of previously unvisited regions of the synthesis space, with the search pattern clearly deviating from Run 1, reflecting the updated objective. Notably, both larger radius (>11 nm) and objective function values exceeded 1, neither of which appear in Run 1 (detailed in FIG. 9). As illustrated in FIG. 4C, the exploration extended to radius up to ˜16 nm, with the highest objective function value (3.61) achieving using 1 μL NCit and 16 μL HAu, producing particles with radius ˜15.9 nm and s ˜0.17 nm, closely matching the target specifications.

These results demonstrate that the autonomous platform can effectively optimize multiple properties through carefully designed single objective functions, providing a powerful approach for targeted nanoparticle synthesis. The platform successfully navigated the synthesis space to discover conditions yielding larger particles while maintaining relatively narrow size distributions, accessing parameter regions well beyond those explored in conventional protocols.

Understanding the relationship between reaction conditions and nanoparticle properties. The autonomous platform not only enables rapid synthesis of target nanoparticles but also facilitates comprehensive exploration of synthesis-property relationships through in-situ SAXS/WAXS measurements. FIG. 4D shows the final GPML predictions for radius and size distribution across the synthesis parameter space, trained on the complete dataset from both Run 1 and Run 2, including comprehensive 3D GPML prediction for 1/σ (left) and radius (right), trained on combined datasets (362 experiments) from both Run 1 and Run 2. Beyond its role in droplet recognition, WAXS characterization provided insights into particle crystallinity, determined by the absence or presence of the (111) diffraction peak at q˜2.68 Å⁻¹, characteristic of face-centered cubic (fcc) structure for gold materials with lattice parameter ˜4.08 Å.

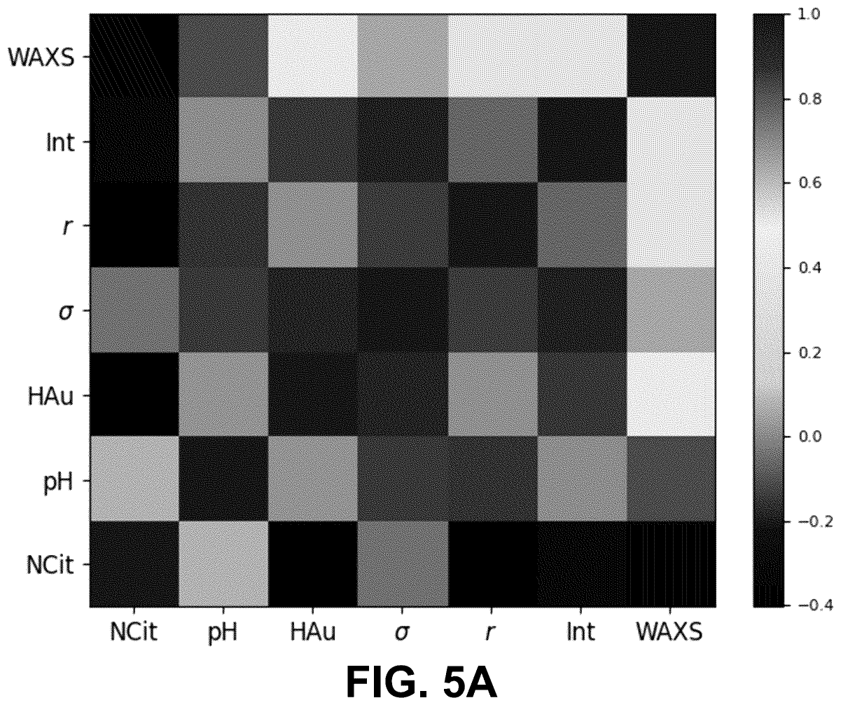

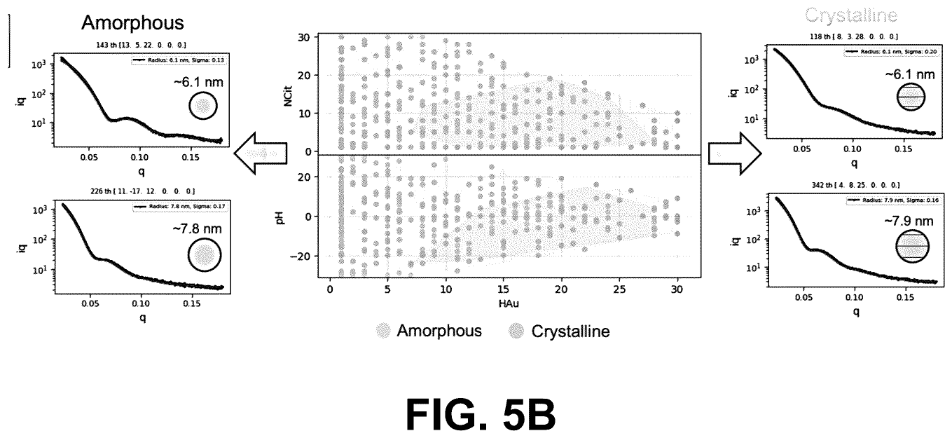

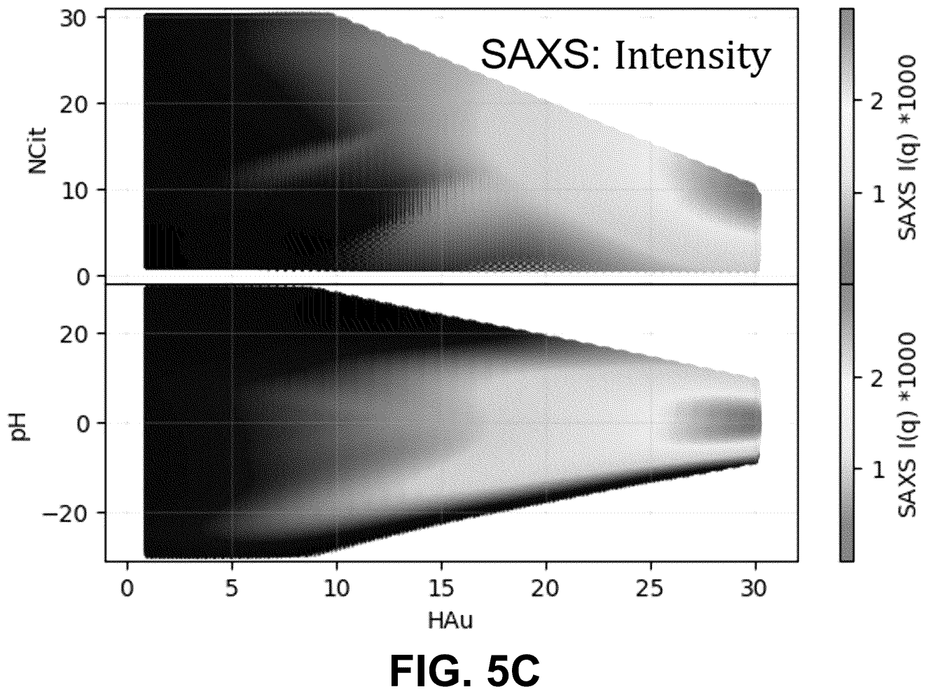

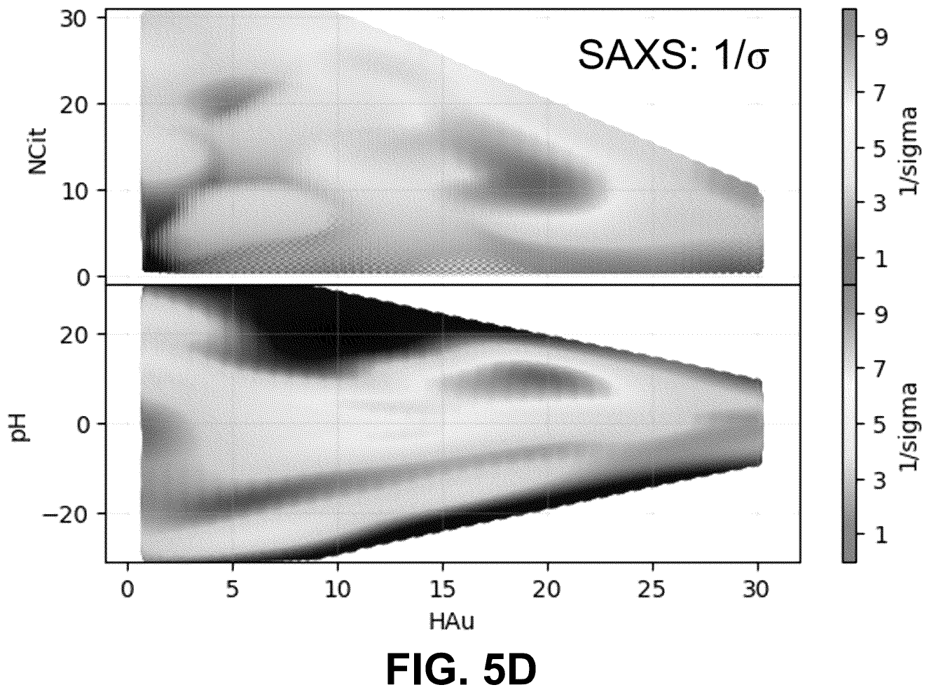

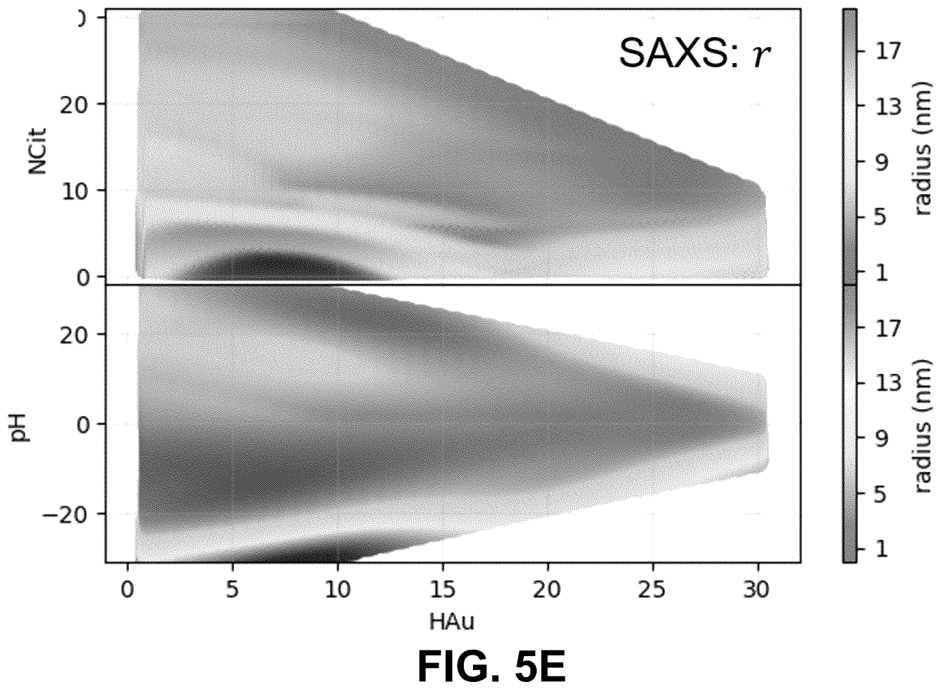

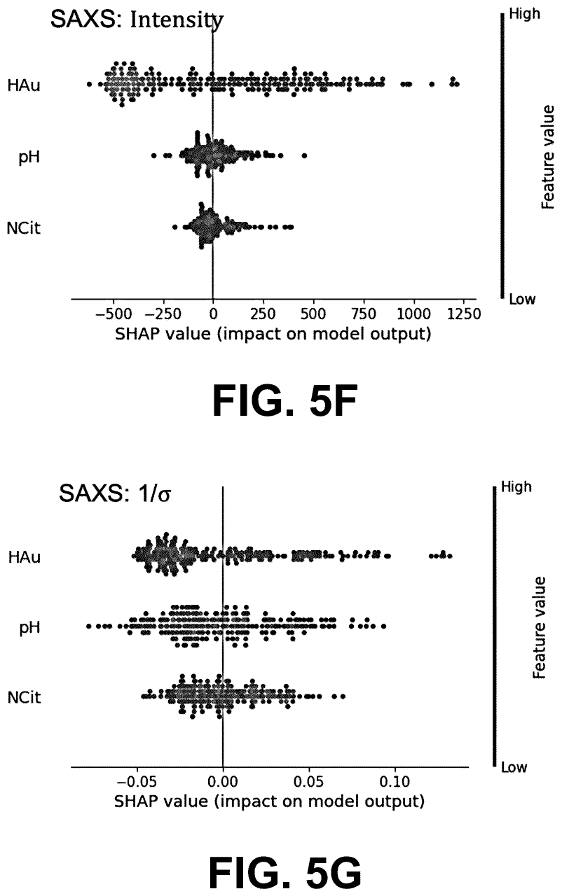

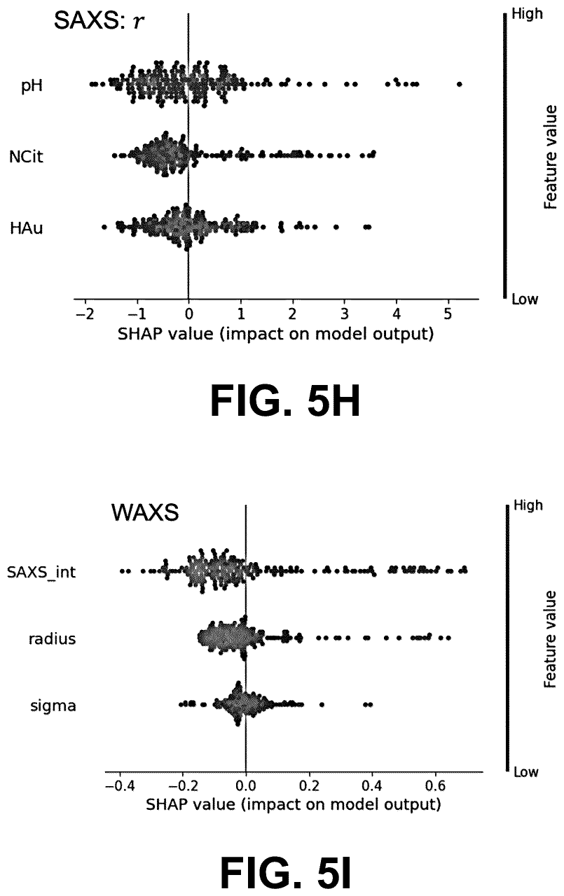

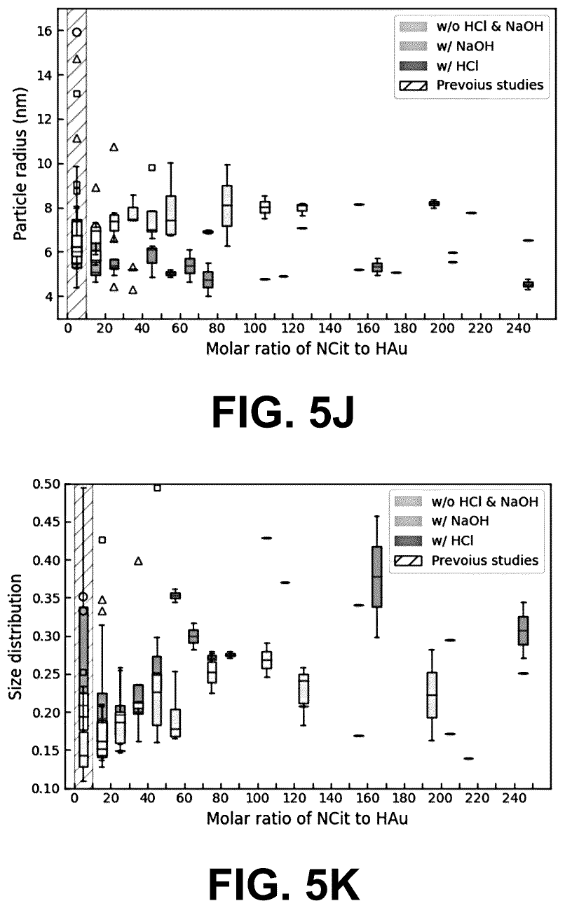

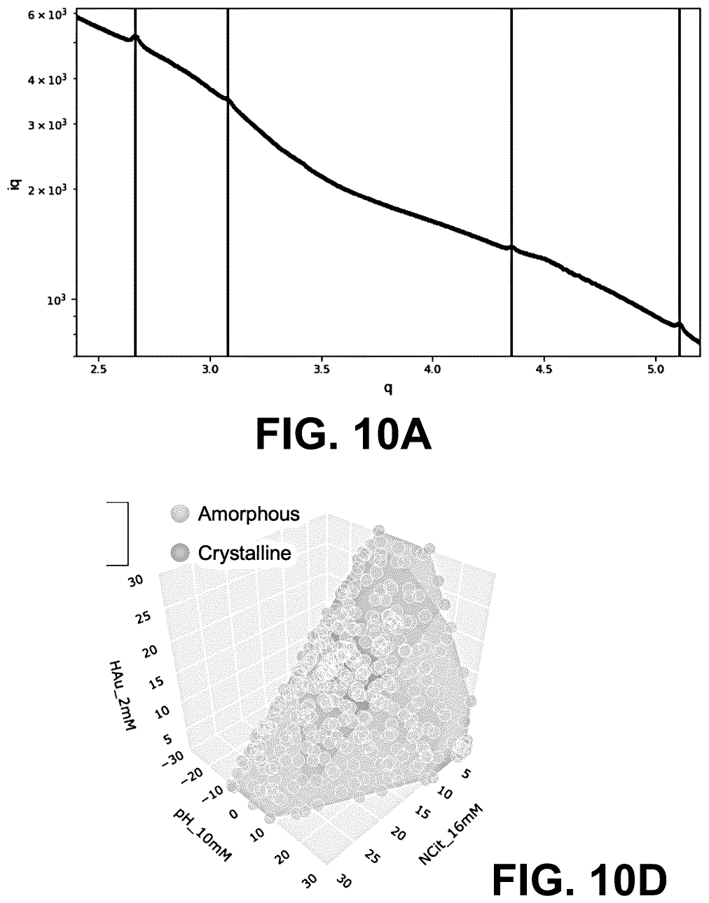

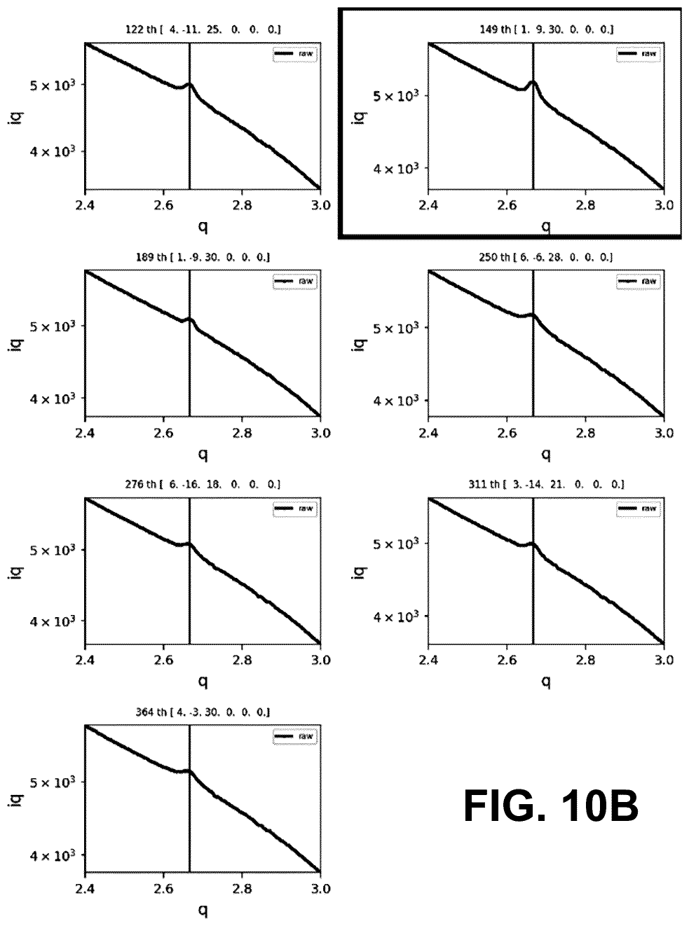

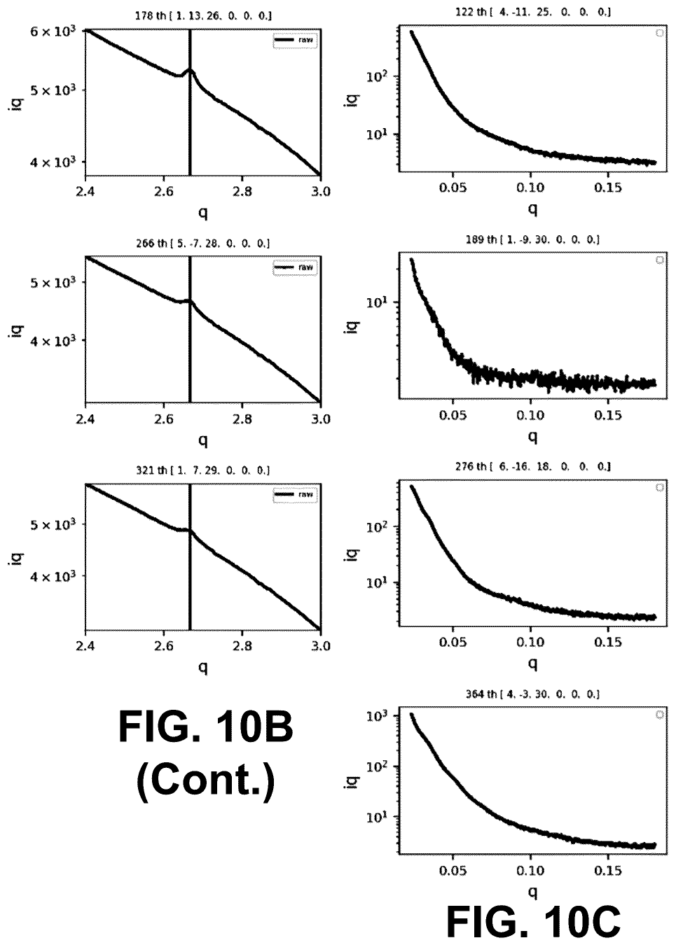

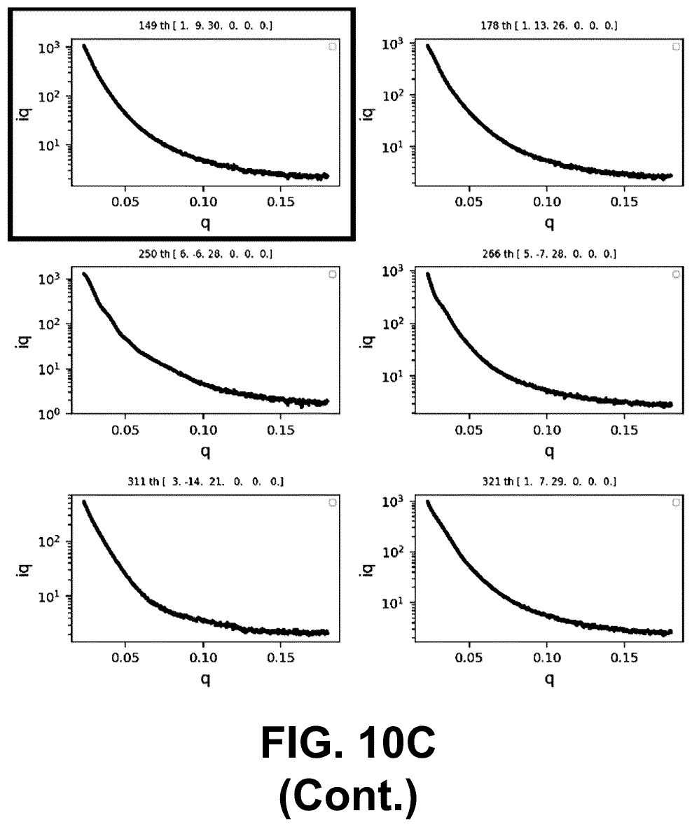

FIG. 5A shows an example of a 2D correlation map quantifying relationships between synthesis parameters (chemical reagents) and nanoparticle properties from SAXS/WAXS measurements. Parameters include size distribution(s), radius (r), maximum of SAXS intensity (Int), and crystallinity (WAXS, binary: 0=amorphous, 1=crystalline). FIG. 5B shows crystallinity distribution mapped across reagent volumes, with representative SAXS profiles demonstrating independence between crystallinity and morphological properties. The relationship between synthesis conditions and crystallinity is plotted in FIG. 5B, showing crystallinity of the as-synthesized nanoparticles against the three reagent volumes. While some overlap exists between crystalline and amorphous regions, the gold chloride (HAu) volume shows notably stronger correlation with crystallinity compared to pH or sodium citrate (NCit) effects. Interestingly, SAXS/WAXS analyses reveal no direct correlation between nanoparticle morphology (size/distribution) and crystallinity (amorphous or crystalline). As shown in FIG. 5B, the inset SAXS profiles demonstrate that particles with similar sizes and distributions can exhibit different crystalline structures depending on synthetic conditions. Conversely, some highly polydisperse nanoparticles show strong crystallinity, evidenced by clear fcc diffraction peaks (detailed in FIGS. 10A-10D).

To quantitatively assess these relationships, a Pearson correlation coefficients (PCC) analysis was used, as displayed in FIG. 5A. These coefficients, ranging from −1 to 1, measure linear relationships between variables, with values close to +1 indicating strong positive/negative correlations and values near 0 suggesting weak or no relationship. The maximum SAXS intensity (“Int” in FIG. 5A) shows a strong positive correlation with HAu volume, consistent with increased particle formation at higher precursor concentrations (reaction conditions: 10 minutes, 100° C.). Crystallinity of nanoparticles (labeled “WAXS”) exhibits only a moderate correlation with HAu volume, indicating that while precursor concentrations influence crystal formation, other factors also play significant roles, as shown in 2D plot in FIG. 5B.

Notably, nanoparticle radius and size distributions show no clear correlation with individual reagent volumes, indicating complex, non-linear dependencies on synthesis parameters. FIGS. 5C-5E shows 2D maps of the GPML predictions for maximum SAXS intensity, 1/σ, and radius as a function of reagent volumes (corresponding observations in FIGS. 10A-10C). While the SAXS intensity map confirms strong correlation with HAu volume, the 1/s predictions reveal optimal monodispersity within specific parameter ranges (NCit: 9˜15 μL, NaOH: 5˜12 μL, and HAu: 15˜23 μL). Radius predictions indicate larger particle form at high HCl volumes. These mappings demonstrate intricate, non-linear relationships between reagent volumes and morphological properties, further supported by complex dependencies shown in FIG. 10D, which shows no clear trend for the 1/s values against reagent volumes.

To deconvolute these relationships, the SHAP approach was used to quantify how each reagent volume contributes to the various outcomes (SAXS intensity, size distribution(s), radius, and crystallinity), enabling global understanding of the primary features driving observed results. FIGS. 5F-5I illustrate examples of SHAP analysis quantifying individual and collective reagent contributions to (f) maximum SAXS intensity, (g) size distribution, and (h) radius of the as-synthesized nanoparticles, and (i) SHAP analysis of SAXS-WAXS relationships revealing hierarchical predictors of crystallinity. SHAP analysis of maximum SAXS intensity confirms HAu volume as the dominant factor, showing strong positive contribution at higher HAu concentrations (FIG. 5F). For size distribution(s), the SHAP analysis reveals a hierarchical influence: HAu>pH>NCit (FIG. 5G), though relatively small SHAP values reinforce the non-linear nature of these effects. Radius determination shows different ordering of importance: pH>NCit>HAu, with low pH and NCit volumes contributing negatively to particle radius (FIG. 5H). SHAP analysis of SAXS and WAXS (FIG. 5I) identifies maximum SAXS intensity as the primary predictor of crystallinity, followed by radius and size distribution.

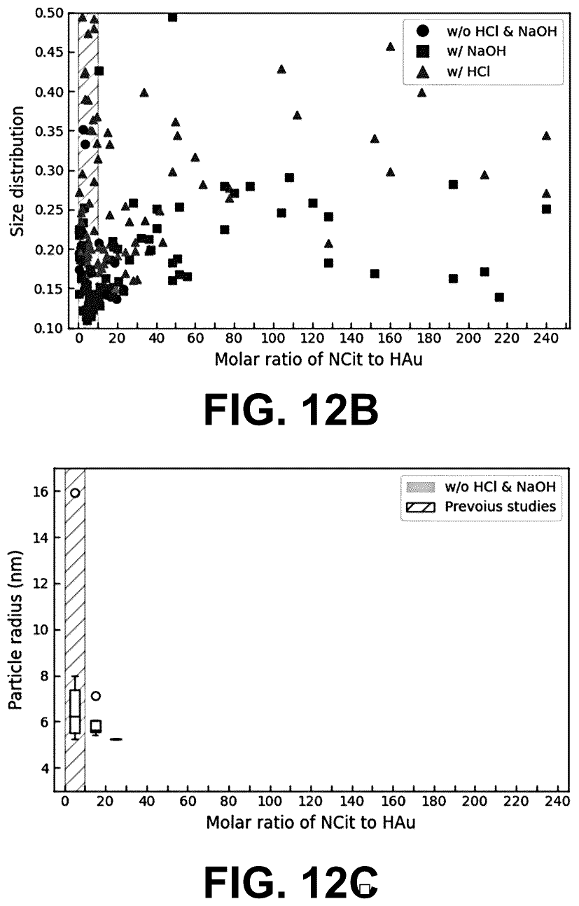

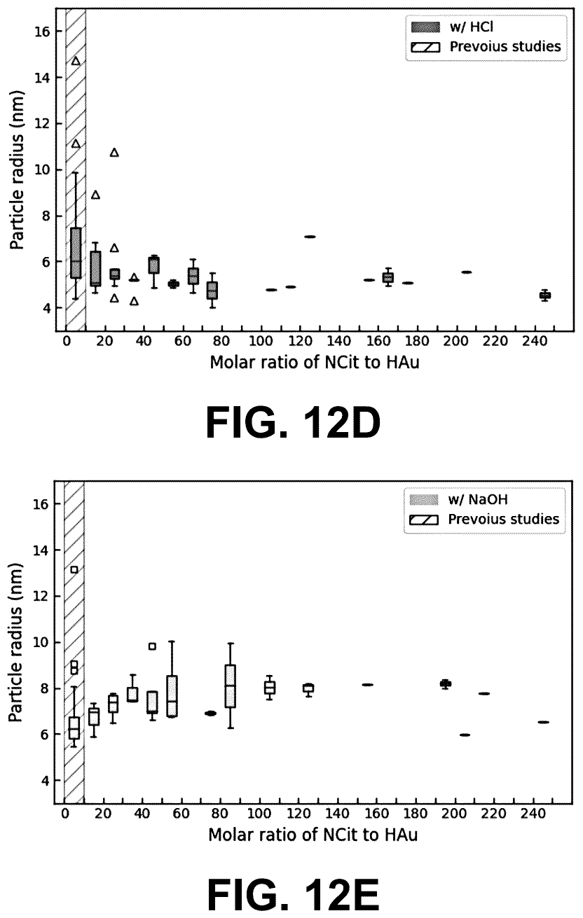

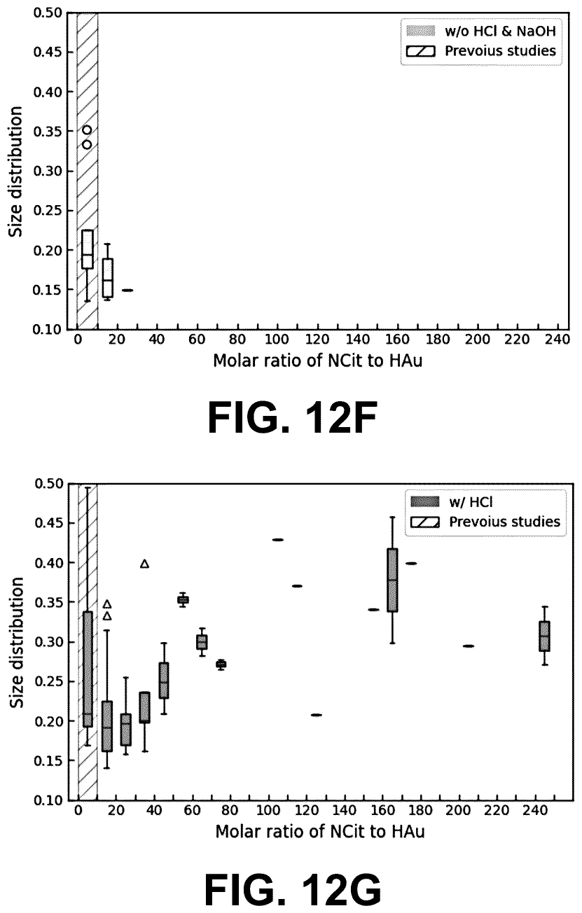

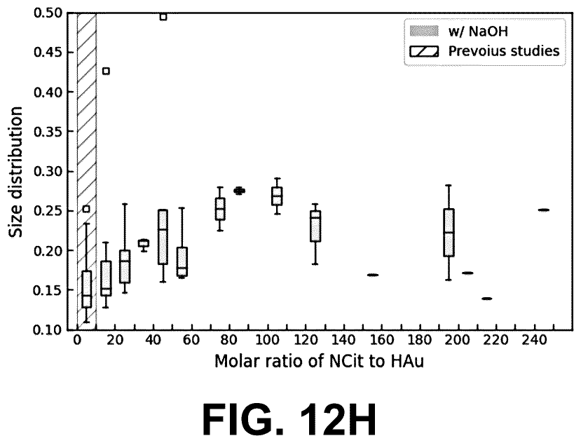

The combination of PCC and SHAP analyses reveals the complex interplay between chemical recipes and nanoparticle properties. Although the Turkevich method has been studied for almost half a century, most work has been limited to narrow synthesis spaces (NCit:HAu ratios in 1-10) with minimal pH investigation, reflecting the current synthesis paradigms heavily reliant on existing protocols. In contrast, the disclosed platform effectively mapped a vastly larger space with NCit:HAu from 0.27 to 480 while simultaneously varying pH using very limited experimental iterations. FIGS. 5J and 5K illustrate examples of comprehensive size and distribution analysis against NCit:HAu molar ratios under systematic pH variations, with hatched regions indicating traditional synthesis space limitations (ratios 1-10). Box plots demonstrate unprecedented parameter space coverage (ratios 0.27˜480) achieved through autonomous optimization. As shown in FIGS. 5J and 5K, the exploration covered molar ratio from 0 to 240 across both runs, though many optimal conditions clustered below 60. This range significantly exceeds previous studies, which are represented by the hatched region in the figures (FIG. 5J). While small nanoparticles with radii <10 nm formed across a broad range of molar ratios, larger nanoparticles >10 nm only emerged within a small molar ratio of 0˜10. Similarly, high monodispersity with σ<0.15 was primarily generated within NCit:HAu ratios of 0˜20, with increased polydispersity at higher molar ratio. Furthermore, the analysis also reveals that NaOH addition generally promotes larger particle sizes with improved size distribution (detailed in FIG. 12).

Conclusions. In this example, an AI-guided fluidics platform equipped with in-situ X-ray scattering was investigated, enabling on-the-fly autonomous synthesis of colloidal nanoparticles. This platform integrates direct in-situ characterization of as-synthesized products via SAXS/WAXS measurements, thereby eliminating the need for sample extraction and mitigating the risks associated with ex-situ processes that can alter nanoproducts before characterization. Using gold nanoparticles as a proof-of-concept, the production of monodisperse nanoparticles was optimized from a set of approximately 19 k possibilities in just 150 experiments over 10 hours, and extended the approach to explore new synthetic regimes, enabling simultaneous control of both size and distribution. This balance of exploration and optimization allows for a systematic investigation of a wide range of parameters, including NCit:HAu ratios from 0.27 to 480 and large pH variations, generating high-quality datasets that enhance understanding of synthesis mechanisms and aid in refining computational and theoretical models. Through comprehensive PCC and SHAP analyses, complex, non-linear relationships between synthesis parameters and nanoparticle properties are revealed. The modular design and adaptability of the disclosed platform suggest its potential for broad applications across various solution-based chemical synthesis systems, potentially accelerating the discovery and optimization of advanced materials.

Materials. Sodium citrate (NCit), hydrogen chloride (HCl), sodium hydroxide (NaOH), tween20, chloroauric acid (HAu), and silicone oil were purchased from Sigma Aldrich. Stock solutions, including 16 mM NCit, 2 mM HAu, 10 mM HCl, 10 mM NaOH, 0.01 wt % tween20 in deionized (DI) water, and silicone oil, were prepared and transferred to 10 mL of gas-tight glass syringes (Hamilton Inc) for automated nanoparticle synthesis.

Fluidic platform. The fluidic platform enables high-throughput nanoparticle synthesis with in-situ SAXS/WAXS characterization. As shown in FIGS. 1B-1D, the system comprises: (i) syringe pumps (New Era Systems and KEM pumps) with gas-tight glass syringes, (ii) solution filtration system preventing bubble formation, (iii) selection valves (M-Switch; Fluigent Inc) and static mixer (PTFE helixes) for reagent selection without cross-contamination and mixing, (iv) customized flow reactor (˜120×90 mm) with temperature control up to 350° C., (v) temperature controller (Lakeshore), and (iv) back pressure system (Fluigent EZ-gas Pump) preventing bubbles expansion at high temperature. Polytetrafluoroethylene (PTFE) tubing (⅛″ OD, 1/16″ ID) forms main flow path, with Kapton tube (0.110″ OD, 0.105″ ID) in the flow reactor for X-ray measurements. The Kapton tubing received hydrophobic treatment by rain-X to ensure stable aqueous-in-oil droplets formation and smooth droplet movement. All the hardware, including syringe pumps, cross-mixers, and a temperature controller, were fully controlled by custom Python scripts.

Methods-Automated nanoparticle synthesis & characterization. Reagent solutions (NCit, tween in DI water, HCl, NaOH, and HAu) were precisely injected using automated syringes with precise controlled volumes (precision <1 μL) and flow rate at 80 μL/min through selection valves into the main flow loop, then undergoing well-mixing by static mixer. Subsequent oil injections created segmented flow (oil-in-aqueous phases) for high-throughput, parallel synthesis. Synthesis parameters were constrained to minimum 1 mL NCit/HAu, variable HCl/NaOH, 1 μL step size, 40 μL total volume (balanced with 0.01% tween20), and 60 μL oil spacing. Reaction conditions were maintained at 100° C., with as-synthesized products being probed at ˜10 minutes. In-situ SAXS/WAXS (beamline details provided below) provided real-time size/distribution information, feeding ML models that suggested subsequent conditions to enable on-the-fly close-loop process.

For ex-situ analysis, samples from 10 identical droplets were collected. About 300 μL of nanoparticle suspensions were used for UV-Vis (Lambda 35) measurements, and 2-3 μL were deposited and dried on Cu grid for TEM (JEOL 1400).

Machine learning (ML). A Gaussian-process (GP) model was used to map synthesis-property relationships, with Bayesian optimization (BO) guiding subsequent experiments. The Upper Confidence Bound (UCB) acquisition function was used:

$${a}_{U C B} ( x ) = μ ( x ) + {β}^{1 / 2} σ ( x )$$

where μ(x) and σ(x) represent the GP mean and standard deviation at point x, respectively. β=100 was set in BO to achieve balanced exploration and exploitation, as this provides a naturally conservative strategy that prioritizes finding points with high uncertainty while maintaining exploitation potential. The model implementation used open-source Python libraries GPyTorch and BoTorch, incorporating customized penalty functions and workflow designs specific to the autonomous synthesis. Three reagent volumes of NCit, pH (HCl as negative or NaOH as positive values), and HAu were used as input parameters and the characterization outcome (1/σ) or objective-function value) was used as the output parameters. During autonomous operations, the system optimized the acquisition function at each experimental step using the current GP fit, with the function's maximum determining subsequent experimental conditions.

Synchrotron Beamline Setup for Self-Driven Fluidic Platform. The in-situ SAXS and WAXS were conducted at the SMI (12-ID) and CMS (11-BM) beamlines at the National Synchrotron Light Source II (NSLS II), Brookhaven National Laboratory (BNL). At the SMI beamline, SAXS data were collected using a beam energy of 16.1 keV and beam size of 200×30 um with a Pilatus 1M area detector (Dectris, Switzerland). The detector, consisting of 0.172 mm square pixels in a 981×1043 array, was placed five meters downstream from the sample position. WAXS data were collected with a PILATUS3 900 KW detector (Dectris, Switzerland), featuring 0.172 mm square pixels in a 1475×619 array. To enable simultaneous collection of SAXS and WAXS, the WAXS detector, mounted on an arc, was rotated 15 degrees relative to the incident beam direction with a sample-to-detector distance being 275 mm.

At the CMS beamline, SAXS data were collected using a beam energy of 13.5 keV and beam size of 200×200 μm with a Pilatus 2M area detector (Dectris, Switzerland). The detector, comprising of 0.172 mm square pixels in a 1475×1679 array, was positioned five meters downstream from the sample. WAXS data were collected with a customized L-shaped Pilatus 800K area detector (Dectris, Switzerland), which comprises 0.172 mm square pixels in a 1043×981 array, placed ˜0.260 meters downstream from the sample position. The L-shaped 800K detector allows the beam to pass through, thus enabling the simultaneous collection of SAXS and WAXS without needing to offset the WAXS detector. Scattering patterns from each detector angle were stitched together using custom-developed software. Typical exposure times were 1 second at the SMI beamline and 15 seconds at the CMS beamline. The 2D SAXS and WAXS patterns, collected continuously during synthesis, were reduced to 1D scattering intensity, I(q), through real-time circular averaging. Here, q represents the wave vector transfer, q=(4π/λ) sin(θ), where λ=0.77 Å is the X-ray wavelength and 2θ is the scattering angle. Scattering angles were calibrated using silver behenate as the standard.

Hardware Implementation. FIGS. 1B-1D demonstrate the installation and integration of the self-driven fluidic platform. Chemical reagents, including sodium citrate (NCit, 10 mM), hydrogen chloride (HCl, 10 mM), sodium hydroxide (NaOH, 10 mM), chloroauric acid (HAuCl₄, 2 mM), along with buffer solution (tween-20, 0.01 wt % in water) and silicone oil, were loaded into gas-tight glass syringes and mounted on precision syringe pumps (New Era Systems and KEM Pumps) (FIG. 1B). The entire flow system is housed within a modular rack that includes multiple syringe pumps, a filtration system, selection valves (M-Switch; Fluigent Inc) and static mixer (PTFE helixes). It also features a customized flow reactor (˜120×90 mm) with temperature control capable of reading 350° C., managed by a Lakeshore temperature controller, and a back pressure system (Fluigent EZ-gas Pump), all controlled through a centralized computer interface using customized Python scripts. This modular design enables mobility and flexible integration with synchrotron-based X-ray scattering characterizations. As shown in FIG. 1C, the high-temperature reactor and cross-mixer components are positioned inside the X-ray chamber for in-line SAXS/WAXS characterizations at the SMI 12-ID beamline. The reactor, constructed from two sandwiched aluminum plates, includes zig-zag flow channels that accommodate Kapton or glass tubing and features holes designed to hold cartridge rods for heating and RTD for thermal feedback. The reactor is also designed with a 9×6 array of holes that serves as X-ray windows for in-situ and real-time characterization during synthesis.

Pairwise Correlation Analysis. A correlation function was developed to analyze time-resolved WAXS data, based on the ‘pandas. DataFrame.corrwith’ method. This function calculates the Pearson correlation coefficient between two one-dimensional arrays. The correlation was computed using the formula:

$$Correlation value = \frac{\sum ( ( {a}_{i} - {μ}_{a} ) \times ( {b}_{i} - {μ}_{b} ) )}{( n - 1 ) \times {σ}_{a} \times {σ}_{b}}$$

where μₐ and μ_{b} are the means, and σₐ and σ_{b} are the standard deviations of the respective arrays. This method enables reliable differentiation between oil and aqueous phases in time-resolved WAXS data based on their distinct WAXS features, thereby providing robust phase identification.

Representative SAXS Data from Run1 and Their Ex-Situ Characterization Results. FIG. 6A shows representative SAXS data where the 1/σ values exceed 7, indicating the successful optimization towards the desired nanoparticle properties of narrow size distribution. In FIG. 6A, SAXS intensity plots having 1/σ value larger than 7 during the experimental run 1. The experiment index, recipe (reaction conditions), and its analyzed nanoparticle properties (size and size distribution) are described in each panel. Markers and curves indicate the observed SAXS data and its corresponding fitted curves using spherical form factor models by nonlinear least-squares minimization methods provided by LMFIT Python package, respectively. Each panel in this figure provides details on the specific experimental index, reaction conditions (recipe), and the analyzed nanoparticle characteristics, including size and size distribution. In the analysis, LMFIT was utilized to perform nonlinear curve fitting on the SAXS data acquired during the autonomous nanoparticle synthesis. The fitted curves (represented by the lines in FIG. 6A) closely match the observed data (markers), providing reliable estimates of key parameters such as nanoparticle size and its distribution. FIG. 6B shows both in-situ and ex-situ characterizations for three representative experiments. Representative SAXS intensity plots from the autonomous 1/σ value discovery and optimization, and their corresponding ex-situ characterizations using TEM and UV, vis measurements The ex-situ characterizations, including UV-vis spectroscopy and TEM, were conducted to corroborate the findings from in-situ SAXS measurements. For these ex-situ characterizations, the gold nanoparticles were re-synthesized using the same fluidic platform with identical recipes. These TEM results demonstrated that the nanoparticle properties (i.e., radius and size distribution) observed ex-situ closely match those obtained from in-situ SAXS analysis, indicating high consistency and reproducibility. Furthermore, the UV-vis spectra show that nanoparticle samples with lower size distribution exhibited narrower absorption peaks, further corroborating the SAXS and TEM analyses.

Reliability of Real-time SAXS Data Analysis. Out of a total of 249 experimental datasets (Run1), 19 datasets were identified as inaccurately analyzed and subsequently re-analyzed. FIG. 7A shows some examples of both incorrect and corrected fitting data using the LMFIT curve-fitting technique. FIG. 7A illustrates examples of representative SAXS intensity plots for real-time poor curve-fitting data. The profiles represent observed data, poorly-fitted and well-fitted (corrected) curves, respectively. The top three panels depict instances of “false positive” cases, where data analysis produced high 1/σ values when, in fact they are not (i.e., situations where either no or highly polydisperse nanoparticles were present, but the fitted data incorrectly yielded low polydispersity value). The bottom three panels show instances of “false negative” cases, where data analysis derives low 1/σ values when, in fact they are not (i.e., situations where low polydisperse nanoparticles were present, but the fitted data incorrectly yielded high polydispersity value). After re-analyzing these 19 inaccurately analyzed datasets (post-analysis data), the GPML model was re-trained, with its performance illustrated in FIG. 7B, showing a comparison of GPML predictions for 1/σ values in the synthetic parameter space, using real-time analyzed data versus re-analyzed data (i.e., analyzed post-experiment). Given the similar features observed in the learning curve of FIG. 3B and the similar 3D maps of GPML predictions shown in FIG. 7B, it is evident that the real-time SAXS data curve-fitting is highly reliable and does not adversely affect GPML performance.

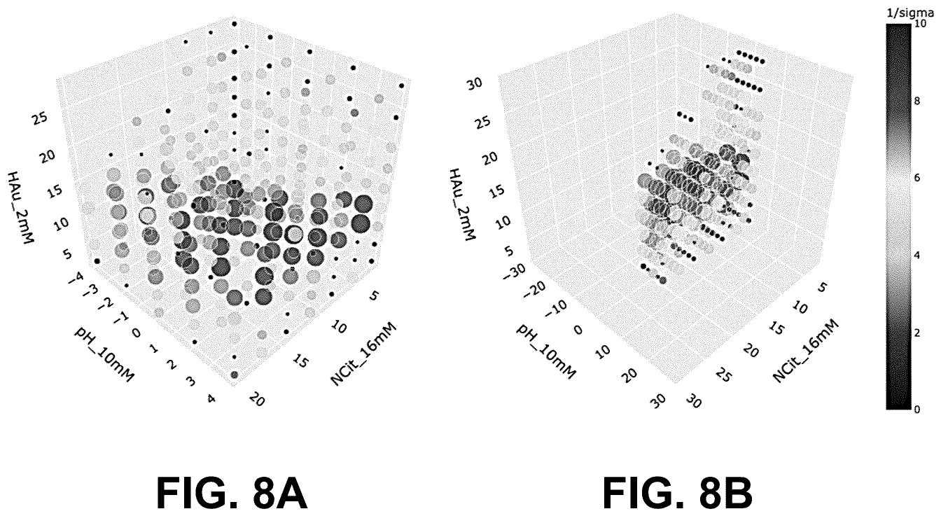

Grid Scan Experiment. To further evaluate the efficiency and effectiveness of the AI-driven autonomous synthesis approach, the approach was compared against a traditional grid scan synthetic experiment conducted within a confined synthetic space, which has narrow pH variations similar to those reported in past studies. For the limited parameter ranges, the boundary conditions for pH variation of HCl or NaOH were set between 0 μL to 4 μL. As shown in FIGS. 8A and 8B, 265 experiments were carried out within this restricted synthetic parameter range. FIGS. 8A and 8B illustrate a comparison of GPML predictions for 1/σ values in the synthetic parameter space, using real-time analyzed data versus re-analyzed data (i.e., analyzed post-experiment). While grid scan experiment can offer exhaustive coverage within a confined synthetic space, it is not an effective approach for exploring and understanding a vast synthetic area. The GPML model trained on the grid scan data predicted an optimal recipe of sodium citrate 15 μL, sodium hydroxide 3 μL, and gold chloride 14 μL, which lies within the restricted boundaries of the synthetic parameters (shown in FIG. 3D). This result demonstrates the model's limited understanding of the entire synthetic space and its inability to generalize beyond the constrained experimental conditions.

3D Mesh Construction of Cost-Fun Values. In FIG. 4B, a 3D mesh plot is utilized to articulate the intricate relationships within the dataset, represented through axes labeled NCit, pH, and HAu. The color of each mesh vertex is encoded according to the ‘cost-fun’ values from the experimental data, utilizing a ‘Jet’ color scale to visually differentiate data magnitudes from low to high. The mesh's transparency is deliberately moderated to an opacity of 0.3, enhancing the visibility of overlapping data points without sacrificing detail, facilitated further by setting alphahull to −10 for a detailed depiction of data topology. The color intensity is normalized between 0 and 15 to enable subtle differences across the synthetic parameters. This methodological approach elevates the overall interpretability of complex datasets in multi-dimensional space.

Evaluation of Radius and Cost-Func During Both Run1 and Run2. FIGS. 9A and 9B show the progression of nanoparticle radius discovery in the synthetic space across two autonomous synthesis experiments (Run 1 and Run 2). FIG. 9A illustrates the observed nanoparticle radius in the synthetic space with a low size distribution (σ<0.5) collected from Run 1 and Run 2 and FIG. 9B illustrates the corresponding GPML model predictions of nanoparticle radius in the synthetic parameter space. In Run 2, the cost function value was used as feedback (output) to the GPML model, whereas the 1/σ value was used in Run1. In FIG. 9A, the observed radii for nanoparticles with low size distribution (σ<0.5) are mapped across the synthetic space. The nanoparticle radii discovered in Run 1 reached a maximum of approximately 11 nm, while Run 2 extended the discovered radius range to 16 nm. This shows a clear expansion of the synthetic space as the objective shifts to multi-objective optimization. FIG. 9B presents the corresponding GPML model predictions of nanoparticle radius. The model demonstrates a more refined mapping pattern for larger radii in Run 2. This improved prediction is attributed to the change in feedback for the GPML model with active learning. In Run 1, the feedback was the inverse of the size distribution (1/σ), whereas, in Run 2, a customized cost function was used. The cost function not only considers the size distribution but also prioritizes the proximity to a target radius (15 nm), which allowed the model to discover new optimal conditions.

FIG. 9C shows the cost function values against the number of experiments performed. FIG. 9C illustrates observed cost function values plotted against the number of performed experiments. The small box highlights the optimal (“best”) observation, and its corresponding SAXS intensity plot is inset, indicating that the discovered optimal nanoparticle radius closely matches the target radius, accompanied by a low size distribution. A notable increase in the cost function values is observed after switching to the multi-objective optimization in Run 2, with higher cost-fun values emerging in the synthetic space. The small box frame highlights the experiment yielding the highest cost function value, with corresponding SAXS data confirming that the observed nanoparticle radius (˜15.9 nm) and size distribution (˜0.17) closely match the target radius and desired low polydispersity. This demonstrates the capability of autonomous multi-objective optimization in efficiently navigating a vast synthetic space to achieve desired nanoparticle properties.

In-situ WAXS Characterization. During the autonomous synthesis experiments, in-situ SAXS and WAXS measurements were performed in real-time, simultaneously. In real-time, the WAXS data were mostly used to identify oil- and aqueous-phase by a correlation analysis method. The WAXS data was also used to investigate the crystalline structure of the synthesized gold nanoparticles based on the absence or presence of primary peak in q˜2.68 A⁻¹, which indicates the (111) diffraction peak of face-centered cubic (fcc) structure, with a gold lattice parameter of ˜4.08 A. FIG. 10A shows a representative WAXS pattern for a crystalline gold nanoparticle exhibiting a crystalline structure, where the distinct higher order diffraction peaks correspond to a face-centered cubic (fcc) structure. The vertical black lines correspond to the higher order diffraction peaks of the fcc crystal structure, with the gold lattice parameter ˜4.08 A FIGS. 10B and 10C represent several examples of in-situ WAXS and SAXS data for synthesized nanoparticles that exhibit crystalline properties but have a high degree of polydispersity. The boxed data in both figures indicate the specific dataset used to generate the WAXS pattern shown in (a). In FIG. 10D, the spatial distribution of crystalline and amorphous gold nanoparticles across the synthetic parameter space is visualized, providing insights into the experimental synthetic parameters that lead to crystalline formation. The gray and yellow markers denote amorphous and crystalline nanoparticles, respectively.

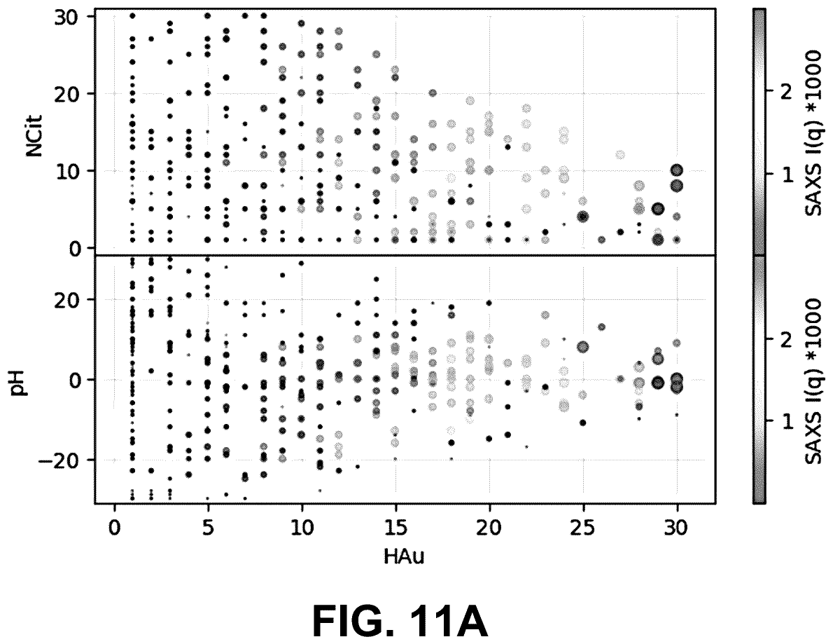

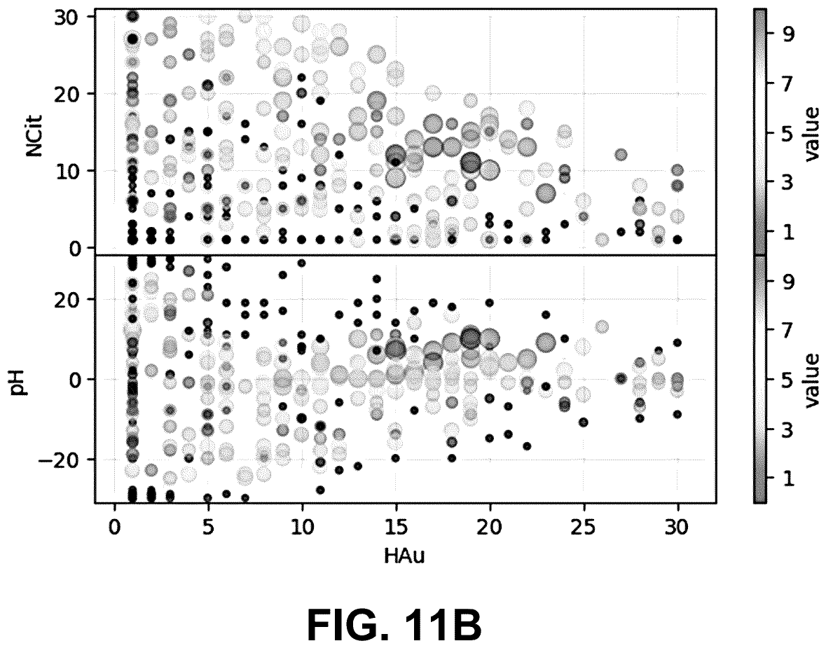

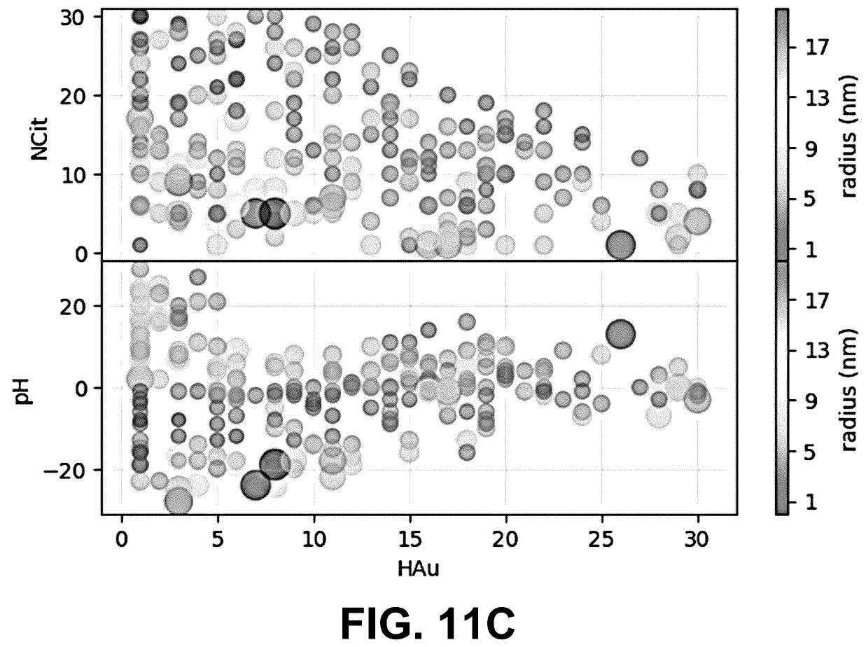

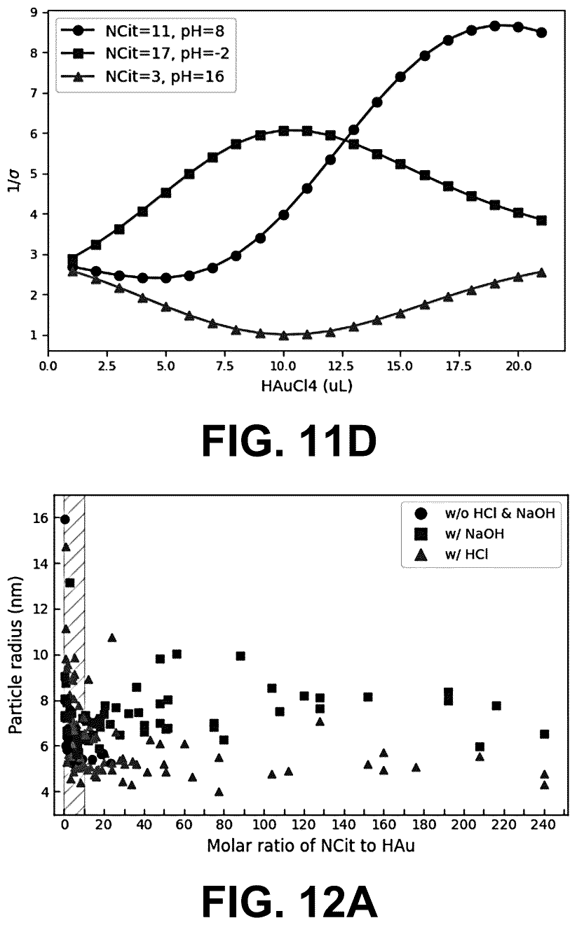

2D Map of Nanoparticle Properties Against Reagent Volumes. FIGS. 11A-11C show 2D maps of the observations from 365 in-situ SAXS characterizations of (a) maximum intensity of SAXS, (b) 1/σ, and (c) radius of nanoparticles in the three reagents volume space. The 2D map of the maximum SAXS intensity indicates a strong correlation with the volume of HAuCl₄, consistent with the Pearson correlation analysis, as described in the main manuscript. On the other hand, relatively higher values of 1/σ were observed within a specific range of reagent volumes (NCit: 9˜15 μL, NaOH: 5˜12 μL, and HAu: 15˜23 μL), suggesting that certain combinations of these reagents lead to more monodispersed nanoparticle formation. Large nanoparticle radii were observed when the volume of HCl was high, and the volume of NCit was low. These experimental observations align well with the corresponding GPML model predictions shown in FIG. 5, highlighting the non-linear relationship between reagent volumes and nanoparticle morphology of size and size distribution. FIG. 11D illustrates predictions of 1/σ value against the volume of HAuCl₄ at the specific NCit and pH volumes. The complexity of these interactions is further evidenced in FIG. 11D, which shows no clear trend for the 1/σ values as a function of three reagent volumes. Three representative examples show differing trends for 1/σ as a function of the volume of HAuCl₄ at the different combinations of NCit and pH variation.

Relationship Between Nanoparticle Properties and Molar Ratios of NCit to Hau. FIGS. 12A-12H show 2D scatter plot and box plots for the nanoparticle radius and size distribution as a function of molar ratio of sodium citrate (NCit) to gold chloride (HAu) under different pH variations, based on datasets from two autonomous experimental runs (Run 1 and Run 2). The scatter plots in FIGS. 12A and 12B, depict the trends in nanoparticle size and size distribution across a range of molar ratios. To provide a better visualization and more detailed representation of the variability of nanoparticle properties across the molar ratio ranges, box plots (FIGS. 10J-10K and 12C-12H) were created from these scatter plots. The box plots for nanoparticle size (a, c-e) and size distribution (b,f-h) as functions of the molar ratio of sodium citrate (NCit) to gold chloride (HAu) under different pH conditions (b,f: without pH variations, c,g: with HCl, d,f: with NaOH). The hatched region marks data from previously reported studies, indicating a narrow and confined exploration across a vast synthetic parameter space. These box plots visually capture the central tendency (median), spread (interquartile range), and potential outliers for each molar ratio bin (grouped in intervals of 10).

ii. Fluidics Platform for Sequential Growth and Mixing

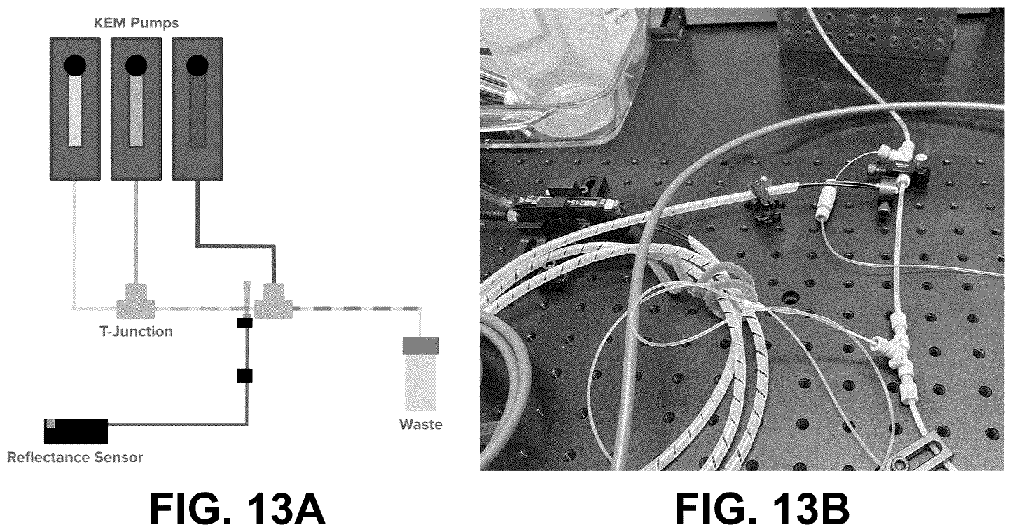

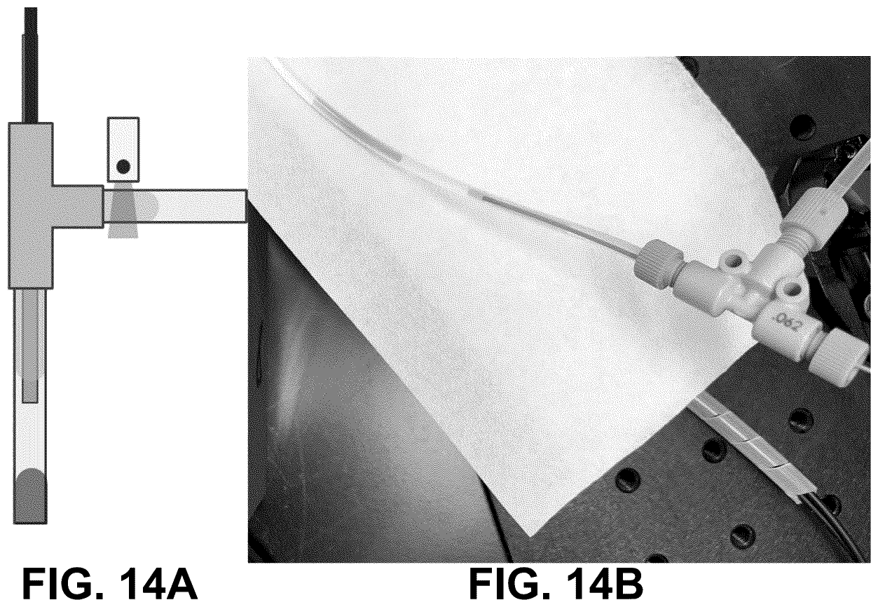

Enabling Multiple-Step Synthesis by Automated Sequential Injection. A system and method have been developed comprising an optical-sensor triggered injection apparatus that automatically introduces sequential chemical reagents to pre-formed droplets on-demand. The working principle and corresponding optical image of said system are illustrated by the sequential injection of red dye to pre-formed blue dye droplets in oil, as shown in FIGS. 13A-13B. The optical sensor control and injection triggering are implemented via custom-developed Python scripts. The system's key feature comprises strategic integration of the optical sensor into the flow system for precise droplet detection at the injector position. The sensor is positioned in immediate proximity to the T-junction of the injector and maintained flush against the main line tubing. Said sensor emits red light (λ=660 nm) and quantitatively measures the intensity of light reflected by the channel. The blue dye and silicone oil phases are distinctly differentiated due to their characteristic absorption properties at this wavelength. Sensor-computer communication is established via an IO-link master module, wherein sensor values trigger injection events. TCP protocols enable sensor reading requests and data transfer to the computer. The sensor executes millisecond-resolution measurements to detect droplet passage. Upon initial droplet detection, the detection time is recorded. Following complete droplet passage past the sensor, the end time is recorded, wherein the time differential is utilized to calculate droplet volume. Said measured volume is compared to the expected volume, and upon correlation, the injection procedure is initiated. The procedure utilizes the calculated droplet volume and sensor-to-injector distance to determine the requisite time delay for droplet arrival at the injection point. Following said delay, injection is triggered without pump interruption. The system operates as designed with the integrated sensor and droplet generation procedure, as further depicted in FIGS. 14A-14B. The T-junction configuration comprises a first input connected to blue dye through large diameter tubing, and a second input connected to small diameter tubing carrying red dye, wherein said small diameter tubing extends through the T-junction and is positioned within larger diameter outlet tubing. The optical sensor triggers red dye injection to form a purple droplet when the blue dye droplet volume is approximately fifty percent past the small tubing outlet.

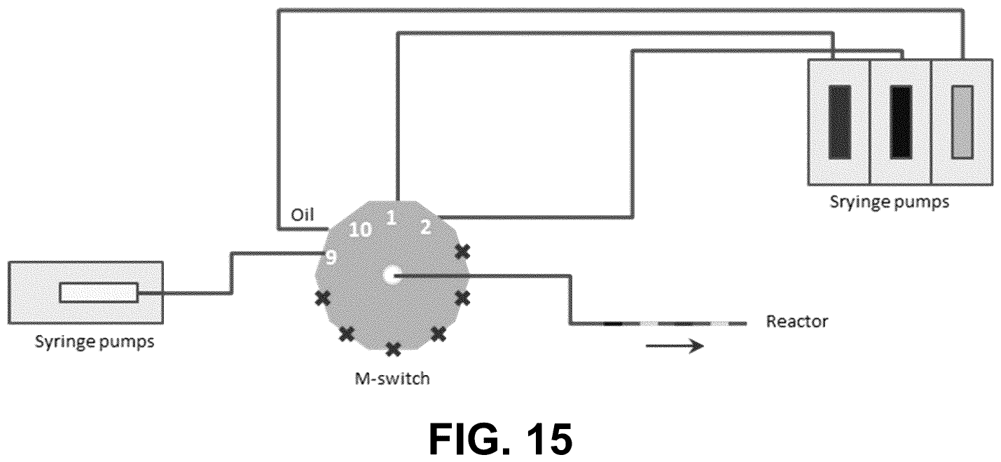

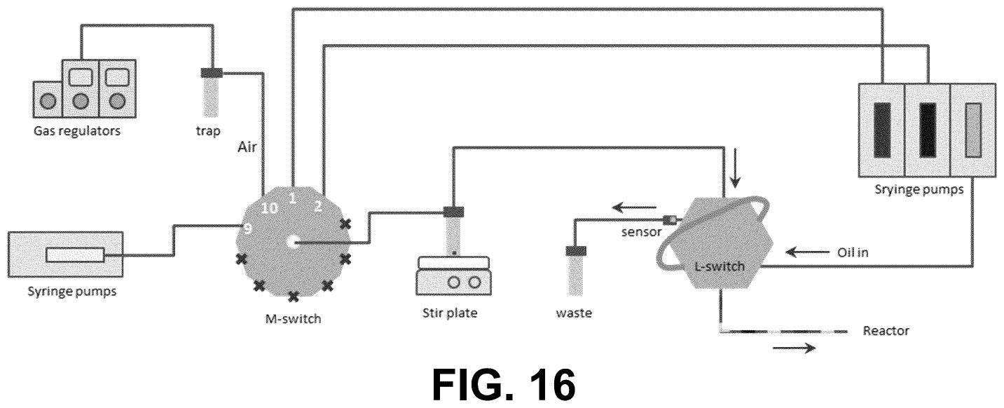

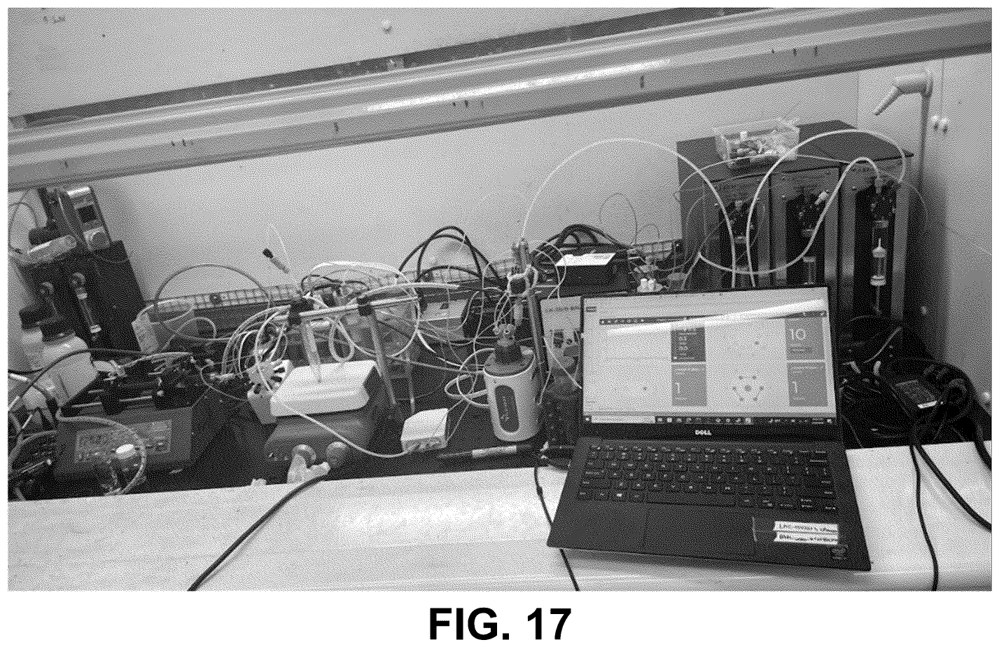

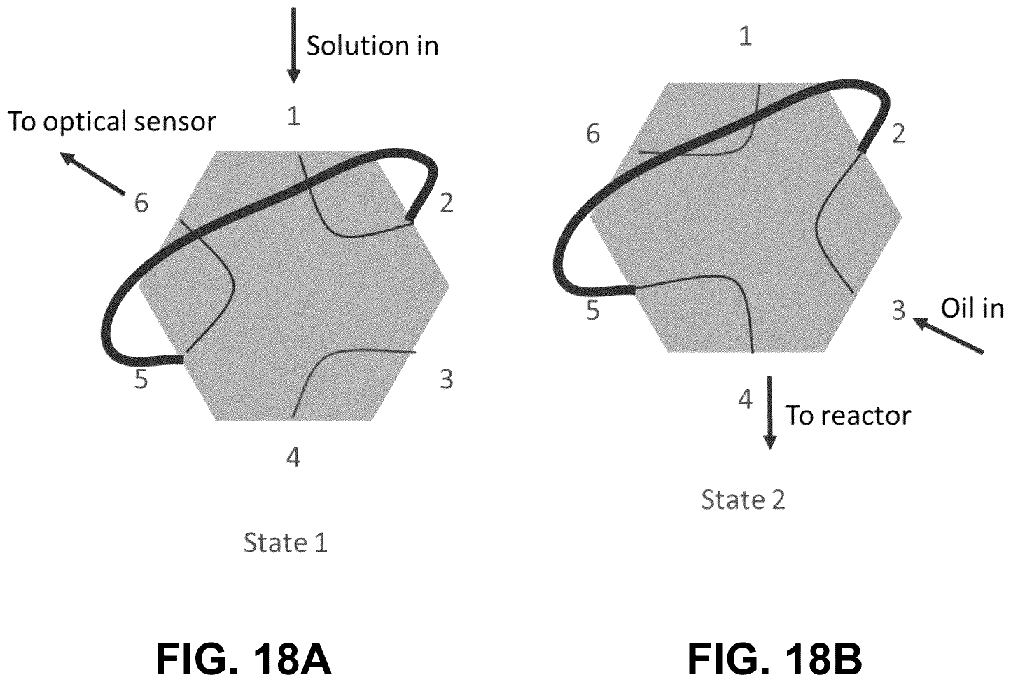

Enabling Solution Well-Mixing in Droplets. While the design shown in FIG. 15 effectively mixes low viscosity solutions, it cannot achieve homogeneous mixing for viscous solutions. Well-mixing is essential for successful, controlled, and reproducible synthesis in droplet-based high-throughput flow systems. A generally applicable method has been developed for achieving uniform homogeneous mixing of diverse solution types in microliter-size droplets. The workflow, schematically illustrated in FIG. 16 with the setup shown in FIG. 17, incorporates: syringe pumps for solution injection to the M-Switch; a gas regulator for air injection to the M-Switch; an M-Switch comprising rotary valves for selective solution or air passage to a closed container; a closed container with magnetic bar on a stir plate; an L-Switch (a two-position, six-port device) enabling selective injection of mixed solution to the reactor in state 2 or to a waste container through an optical sensor in state 1, as shown in FIGS. 18A-18B; and an optical sensor for solution detection and L-Switch state control from state 1 to 2, enabling solution flow to the reactor. The working procedure is demonstrated using red dye, water, and blue dye to form sequential droplets in oil, comprising: 1) M-Switch positioning to position 1; 2) injection of 20 μl (exemplary volume) red dye; 3) M-Switch repositioning to position 9; 4) injection of 20 μl (exemplary volume) water; 5) M-Switch repositioning to position 10; 6) gas regulator activation at 100 mbar (exemplary pressure) to transfer solutions to the closed container; 7) gas pressure deactivation; 8) magnetic stirring initiation for 2 minutes (exemplary duration); 9) L-Switch positioning to state 1; 10) optical sensor-triggered L-Switch state change to state 2 upon solution detection, enabling downstream reactor access; and 11) oil injection into the L-Switch for solution transfer to the reactor. Steps 1-11 enable formation of a single mixed droplet, with procedure repetition enabling formation of multiple homogeneously mixed solution droplets. All procedures are automated through custom-developed Python scripts.

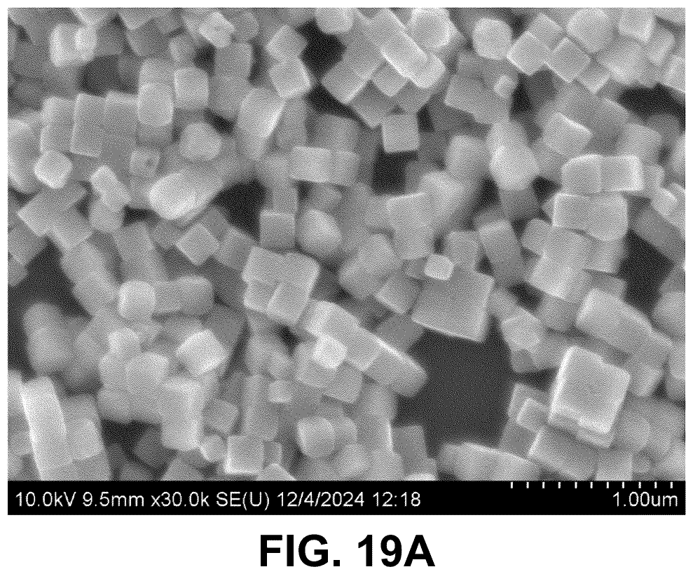

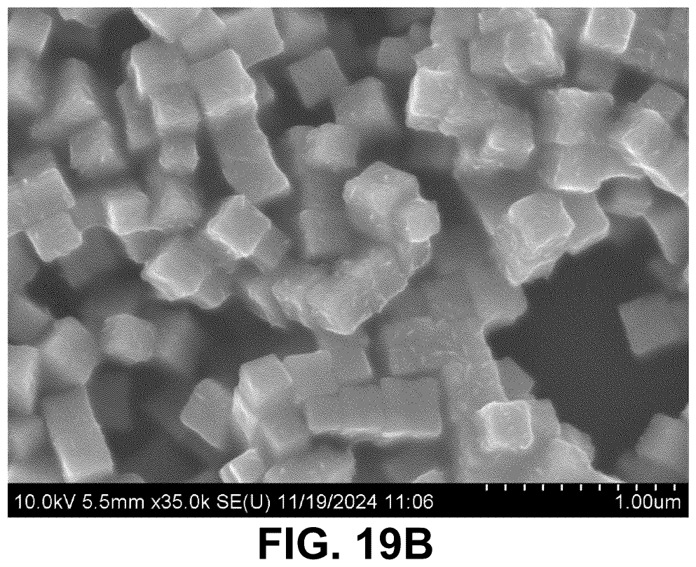

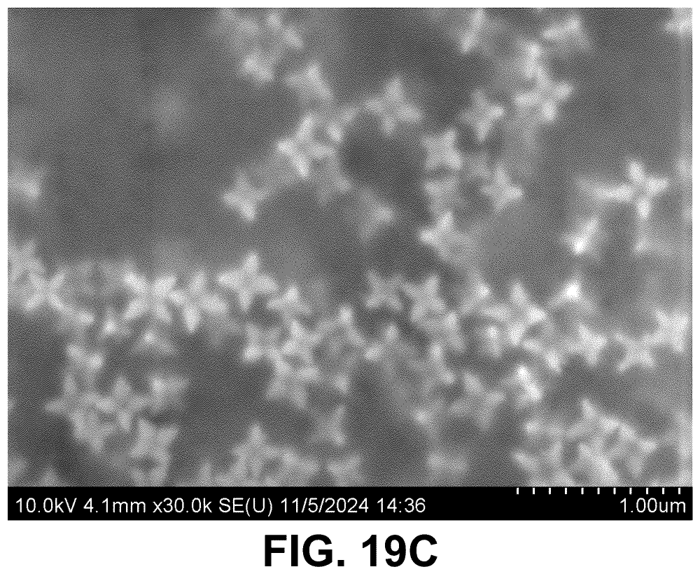

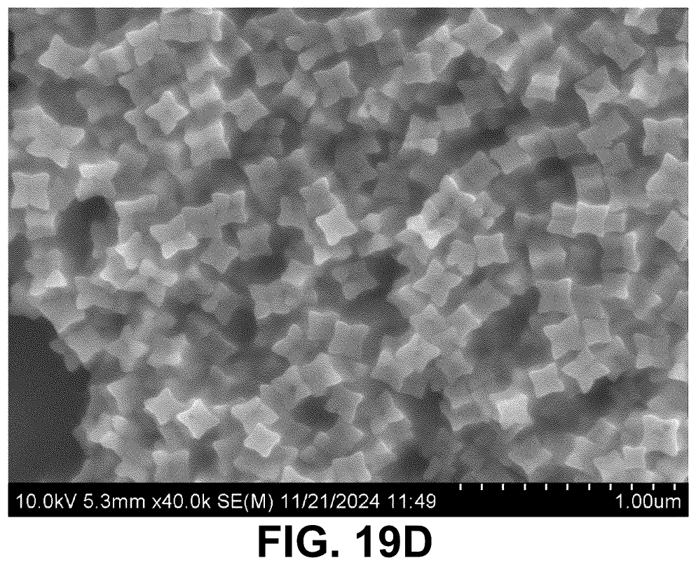

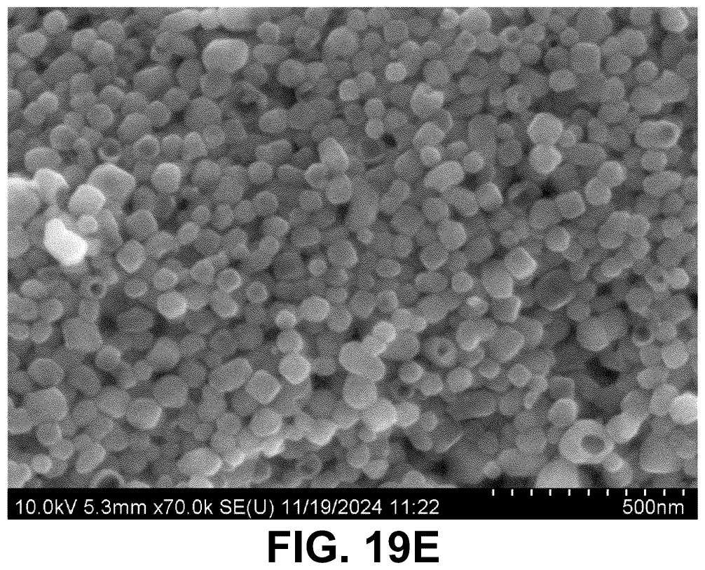

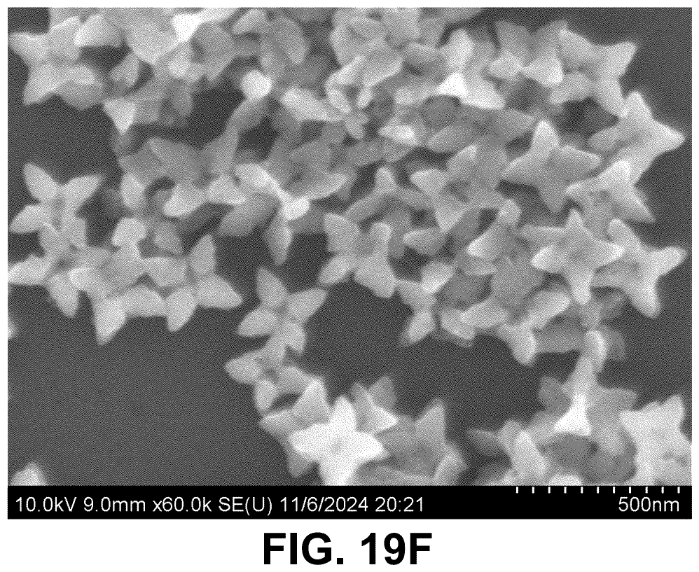

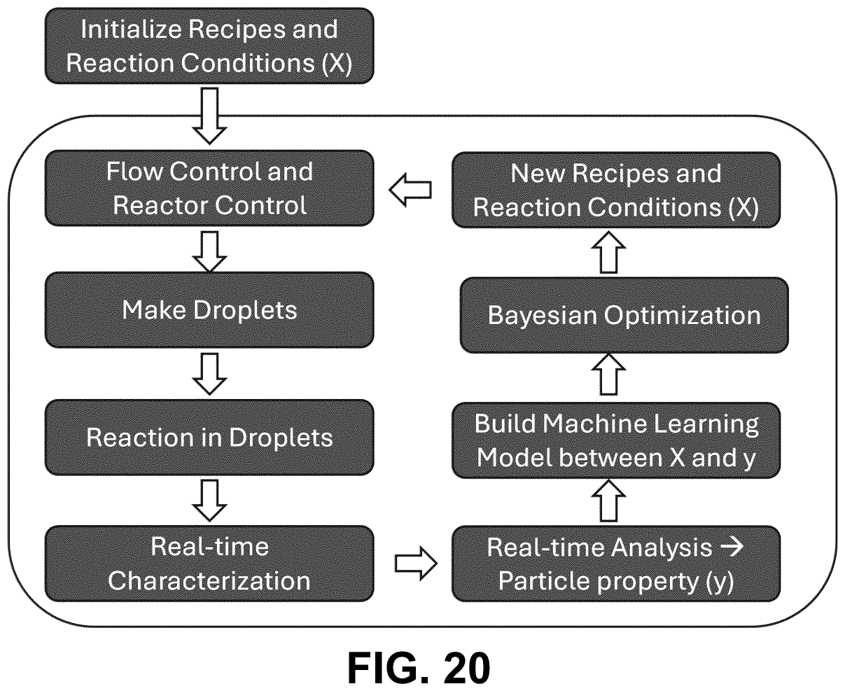

This mixing capability enables room-temperature synthesis of shape-controlled CuO nanoparticles with highly uniform size and shape characteristics using CuCl2, NaOH, and ascorbic acid. Example products shown in FIGS. 19A-19F include cubes with smooth surface, cubes with rough surface, nano-stars, concave-shaped cubes, porous shells, and multiple-pods nanostructure. All products demonstrate high reproducibility. The reaction proceeds immediately upon chemical mixing and exhibits high sensitivity to mixing sequential order, rate, and homogeneity. The successful and reproducible synthesis validates the efficacy of the mixing method, particularly for such kinetically sensitive reactions. An overview of the workflow and autonomous closed-loop synthesis is shown in FIG. 20.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system for nanoparticle synthesis, comprising:
a self-driven fluidics platform comprising:
a chemical handling module comprising:
a plurality of chemical reservoirs, each chemical reservoir configured to hold a fluid; and
a mixer, comprising a plurality of injector ports and at least one ejector port, each chemical reservoir in fluidic communication with at least one injector port of the mixer, the mixer configured to mix at least two fluids entering the mixer from the injector ports, thereby forming an initial mixture, and deliver the initial mixture through the ejector port as part of a segmented flow; and
a reactor module configured to control environmental conditions during synthesis of a nanoparticle, comprising:
a flow reactor in fluidic communication with the mixer through the ejector port, the flow reactor comprising a channel configured to allow the segmented flow to move through the flow reactor via the channel, the flow reactor comprising at least one observation window configured to enable real-time characterization of nanoparticles in individual droplets in the segmented flow through the flow reactor.

2. The system of claim 1, further comprising an in-line characterization module comprising an analytical instrument configured to obtain characterization data of the nanoparticles in the individual droplets in the segmented flow while the segmented flow moves through the channel of the flow reactor.

3. The system of claim 2, wherein the analytical instrument comprises a radiation emitter and a signal detector.

4. The system of claim 2, wherein the analytical instrument is configured to deliver radiation through the at least one observation window and detect a radiation signal emitted from at least one individual droplet.

5. The system of claim 2, further comprising a control module comprising processing circuitry configured to at least:
receive an analyte measurement from the analytical instrument; and at least one of:
adjust a rate of delivery of the fluid of at least one chemical reservoir; or
adjust a volume of delivery of the fluid of at least one chemical reservoir.

6. The system of claim 5, wherein the control module dynamically adjusts operation of the chemical handling module or the reactor module during synthesis of the nanoparticle.

7. The system of claim 6, wherein the dynamic adjustment is in response to machine learning analysis of the real-time characterization data.

8. The system of claim 1, wherein each of the plurality of chemical reservoirs comprises a syringe pump.

9. The system of claim 1, wherein at least one of the plurality of chemical reservoirs comprises an oil.

10. The system of claim 1, wherein the mixer is a static mixer.

11. The system of claim 1, wherein the flow reactor is further configured to control environmental conditions of the channel.

12. The system of claim 11, wherein the flow reactor is further configured to control the temperature of the channel.

13. The system of claim 1, wherein the system further comprises a filtration device configured to prevent the formation of bubbles in the fluids within the system.

14. A method comprising:
mixing together at least two fluids, thereby forming a segmented flow comprising a plurality of droplets;
flowing the segmented flow into a reactor;
controlling a temperature of the reactor;
measuring at least one target property of nanoparticles in individual droplets in the segmented flow as the plurality of droplets pass through the reactor; and
adjusting formation of droplets added to the segmented flow based upon the measured at least one target property of the nanoparticles.

15. The method of claim 14, wherein the at least one target property is selected from nanoparticle radius, nanoparticle size distribution, absorption spectra, photoluminescence characteristics, dispersity status, dynamic viscosity, electrical conductivity, small angle X-ray scattering (SAXS) intensity (Int), crystallinity, and a combination thereof.

16. The method of claim 14, wherein a rate of delivery of the two fluids, a volume of delivery of the two fluids, or a combination thereof is adjusted based on the measured at least one target property.

17. The method of claim 14, wherein the at least two fluids are sequentially mixed via a rotary valve.

18. The method of claim 14, wherein the segmented flow comprises the plurality of droplets separated by oil segments.

19. The method of claim 14, wherein formation of the droplets is dynamically adjusted to within a defined limit of the at least one target property.

20. The method of claim 19, wherein the dynamic adjustment is in response to machine learning analysis of the measured at least one target property.
